SEQUENCE LISTING (6 sequences)

SEQ ID NO: 1 - protein, 269 aa, Thermomyces lanuginosus [sequence omitted]

SEQ ID NO: 2 - protein, 269 aa, Thermomyces lanuginosus
  REGION 1..269: note = Variant of Thermomyces lanuginosus lipase
DVSADLLNQFKLFAQYSAAAYCGRNNDAPAGTNITCSANACPLVEAADATFLYSFENSGVGDVTGFLAVDNTNKLIVLSFRGSRSIENWITNLNFDLVDINDICSGCRGHDGFTSSWRSVADTLRQAVDDAVAAHPDYKVVVTGHSLGGALATLAGADLRNNGYDVDLYTYGAPRVGNRAFAEFITVQTGGTLYRVTHTNDVVPRLPPRQFGYSHPSPEYWIKSGTLVPVRRRDIVKIEGIDATGGNNQNNTPDIPAHLWYFGLIGTCI

SEQ ID NO: 3 - protein, 262 aa, Absidia sp.
  REGION 1..262: note = lipase
STQDYRIASEAEIKAHTFYTALSANAYCRTVIPGGRWSCPHCGVASNLQITKTFSTLITDTNVLVAVGEKEKTIYVVFRGTSSIRNAIADIVFVPVNYPPVNGAKVHKGFLDSYNEVQDKLVAEVKAQLDRHPGYKIVVTGHSLGGATAVLSALDLYHHGHANIEIYTQGQPRIGTPAFANYVIGTKIPYQRLVHERDIVPHLPPGAFGFLHAGEEFWIMKDSSLRVCPNGIETDNCSNSIVPFTSVIDHLSYLDMNTGLCL

SEQ ID NO: 4 - protein, 262 aa, Absidia sp.
  REGION 1..262: note = Variant of Absidia lipase
STQDYRIASEAEIKAHTFYTALSANAYCRTVIPGGRWSCPHCGVASNLQITKTFSTLITDTNVLVAVGEKEKTIYVVFRGTSSIRNAIADIVFVPVNYPPRNGAKVHKGFLDSYNEVQDKLVAEVKAQLDAHPGYKIVVTGHSLGGATAVLAALDLYHHGHANIEIYTQGQPRIGNPAFANYVIGTKIPYQRLVHERDIVPHLPPSAFGFLHAGEEFWIMKDRSLRVCPNGIETDNCSNSIVPFTSFIDHLSYLGMNTGLCL

SEQ ID NO: 5 - protein, 269 aa, Thermomyces lanuginosus
  REGION 1..269: note = Variant of Thermomyces lanuginosus lipase
EVSQDLFNQFNLFAQYSAAAYCGKNNDALAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVLVTRNDIVKIEGIDATGGNNQPNIPDIPAHLWYFGLIGTCL

SEQ ID NO: 6 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDAGREMLQIHMIGNSMRTDDFRIEGISNFESDVTLFG

(19) United States
(12) Patent Application Publication
(10) Pub. No.: US 2025/0129310 A1
(43) Pub. Date: Apr. 24, 2025

(54) COMPOSITION COMPRISING A LIPASE AND A BOOSTER

(71) Applicant: Novozymes A/S, Bagsvaerd (DK)

(72) Inventors: Lone Baunsgaard, Helsingoer (DK); Kim Borch, Birkeroed (DK); Wenwen Tao, Beijing (CN)

(73) Assignee: Novozymes A/S, Bagsvaerd (DK)

(21) Appl. No.: 18/720,981

(22) PCT Filed: Dec. 16, 2022
(86) PCT No.: PCT/CN2022/139604

§ 371 Date: Jun. 17, 2024

(30) Foreign Application Priority Data
Dec. 21, 2021 (WO) PCT/CN2021/140002

(51) Int. Cl. C11D 3/386; C11D 3/30; C11D 3/37

(52) U.S. Cl. CPC C11D 3/38627; C11D 3/30; C11D 3/3723; C12Y 301/01003

(57) ABSTRACT

The present invention relates to detergent compositions comprising (a) a surfactant or a surfactant or surfactant system; (b) a lipase; and (c) one or more boosters selected from the group of: i) alkoxylated polyethyleneimine; ii) alkoxylated polyetheramine; iii) guanidine hydrochloride; and iv) rhamnolipid. The invention also relates to methods for cleaning or washing of laundry comprising contacting the laundry with a detergent composition of the invention. Finally, the invention also relates to an enzyme product comprising (a) a lipase; and (b) one or more boosters.

### REFERENCE TO A SEQUENCE LISTING

This application contains a Sequence Listing in computer readable form, which is incorporated herein by reference.

### BACKGROUND OF THE INVENTION

### Field of the Invention

The present invention relates to detergent compositions for removal of fat from laundry during cleaning or washing of laundry. The invention also relates to methods of cleaning or washing laundry. Finally, the invention also relates to enzyme products suitable for use in, e.g., detergent compositions of the invention.

### Description of the Related Art

Detergent compositions for laundry cleaning or washing comprising enzymes are well-known. Although the detailed ingredient lists for detergent compositions vary considerably across geographies, the main detergency mechanisms are similar. Soils and stains are typically removed by mechanical action assisted by enzymes, surfactants, and other ingredients. Historically, proteases were the first to be used extensively in laundering. Today, lipases, alpha-amylases, mannanases, and cellulases have been introduced to increase the effectiveness, especially for household laundering at lower temperatures.

Lipases break down fats into fatty acids that are solubilized in the surfactants.

WO 2006/113314 concerns a liquid laundry detergent composition comprising (a) from about 5 to about 20000 LU/g of a first wash lipase which is a polypeptide having an amino acid sequence which has at least 90% identity with the wild-type lipase derived from Humicola lanuginosa strain DSM 4109 and compared to said wild-type lipase, comprises a substitution of an electrically neutral or negatively charged amino acid within 15 Å of E1 or Q249 with a positively charged amino acid; and may further comprise: (I) a peptide addition at the C-terminal; (II) a peptide addition at the N-terminal; (III) meets the following limitations: i) comprises a negatively charged amino acid in position E210 of said wild-type lipase; ii) comprises a negatively charged amino acid in the region corresponding to positions 90-101 of said wild-type lipase; and iii) comprises a neutral or negatively charged amino acid at a position corresponding to N94 of said wild-type lipase; and/or iv) has a negative charge or neutral charge in the region corresponding to positions 90-101 of said wild-type lipase; and (IV) mixture thereof; (b) from about 0.01 wt % to about 10 wt % by weight of the composition of a modified polyethyleneimine polymer wherein the modified polyethyleneimine polymer comprises a polyethyleneimine backbone of about 300 to about 10000 weight average molecular weight; the modification of the polyethyleneimine backbone is: (1) one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification, wherein the terminal alkoxy moiety of the alkoxylation modification is capped with hydrogen, a C1-C4 alkyl or mixtures thereof; (2) a substitution of one C1-C4 alkyl moiety and one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification wherein the terminal alkoxy moiety is capped with hydrogen, a C1-C4 alkyl or mixtures thereof; or (3) a combination thereof; and (c) the balance of the composition comprising a liquid carrier.

There is still a need for detergent compositions with improved fat removing performance during cleaning or washing.

### SUMMARY OF THE INVENTION

The present invention relates to detergent compositions comprising:
(a) a surfactant or a surfactant system;
(b) a lipase; and
(c) one or more boosters selected from the group of:
   i) alkoxylated polyethyleneimine, in particular ethoxylater and propoxylated polyethyleneimine;
   ii) alkoxylated polyetheramine, in particular ethoxylated and propoxylated polyetheramine;
   iii) guanidine hydrochloride; and
   iv) rhamnolipid.

The detergent composition of the invention may besides a surfactant or a surfactant system, lipase and booster further comprise one or more components selected from the group of builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments.

In a preferred embodiment a detergent composition of the invention comprises one or more of the lipases shown in any one of SEQ ID NOs: 1, 2, 3, 4, 5 or 6 or variants thereof or analogues thereof.

In an embodiment the detergent composition of the invention comprises a commercial lipase product selected from the group of Lipolase™, Lipex™; Lipolex™, Lipoclean™, Lipex Evity 100L, Lipex Evity 105T, Lipex Evity 200L (from Novozymes), Lumafast (originally from Genencor), Preferenz L100 (Danisco US Inc.), and Lipomax (originally from Gist-Brocades).

When cleaning or washing, in particular laundry, using a composition of the invention, the fat removal under wash is enhanced/improved compared to when no booster(s) is (are) present. The fat removal under wash is at least 5%, at least 10%, at least 15%, at least 20%, at least 30%, at least 40%, at least 50%, preferably at least 55%, more preferably at least 60%, even more preferably 65%, especially at least 70% of the stain when using the test described in Examples 1-3 or 4, respectively.

Typically, the fat removal % is lower when the detergent does not comprise in particular LAS compared to when the detergent comprises in particular LAS.

In one embodiment, the fat removal under wash is at least 30%, at least 40%, at least 50%, at least 55%, more preferably at least 60%, even more preferably at least 65%, especially at least 70%, such as between 30 and 70%, such as between 40% and 70%, such as between 50% and 70%, such as between 60% and 70%, such as between 30% and 60%, such as between 40% and 60%, such as 50% and 60%, such as 30% and 50%, such as 40% and 50%, of the fat stain when using the test described in Examples 1-3 (i.e., detergent comprising LAS).

In another embodiment, the fat removal under wash is at least 5%, at least 10%, at least 15%, at least 20%, at least 30%, at least 40%, at least 50%, such as between 5 and 50%, such as between 5% and 40%, such as between 5% and 30%, such as between 5% and 20%, such as between 5% and 10% of the fat stain when using the test described in Example 4 (i.e., detergent without LAS).

The invention also relates to methods for cleaning or washing of laundry comprising contacting laundry with a composition of the invention.

“Laundry” includes in context of the invention in particular textiles, clothes, linen or the like. In particular, the laundry may be soiled so that washing, or cleaning is needed to remove lipid stains, such as lard, fats, oils or the like. Lipids include glycerides (e.g., triglycerides), phospholipids, glycolipids, and fatty acids.

A washing or cleaning method of the invention is typically carried out in a laundry washing machine, e.g., top loader or front loader but may also be performed in other ways such as manually.

According to the method of the invention, lipase is dosed at a concentration of 0.01-5 mg enzyme protein (EP)/L wash water.

In an embodiment, lipase is dosed at a concentration of 0.001-5 ppm, in particular 0.01-10 ppm.

In an embodiment, alkoxylated polyethyleneimine and/or alkoxylated polyetheramine is dosed at a concentration of 0.001-100 ppm, in particular 0.01-50 ppm.

In an embodiment, guanidine hydrochloride is dosed at a concentration of 0.001-100 mM/L wash water, such as around 0.01-05 mM/L wash water.

In an embodiment, wherein the ratio between lipase and booster is between 1:50 and 1:1, such as between 1:40 and 1:2, such as between 1:30 and 1:3.

In an embodiment, two or three boosters are combined. In a preferable embodiment, ethoxylated and propoxylated polyethyleneimine is combined with guanidine hydrochloride.

### Definitions

Lipase: The terms “lipase”, “lipase enzyme”, “lipolytic enzyme”, “lipid esterase”, “lipolytic polypeptide”, and “lipolytic protein” refers to an enzyme in class EC3.1.1 as defined by Enzyme Nomenclature. It may have lipase activity (triacylglycerol lipase, EC3.1.1.3), cutinase activity (EC3.1.1.74), sterol esterase activity (EC3.1.1.13) and/or wax-ester hydrolase activity (EC3.1.1.50). For purposes of the present invention lipase activity (i.e. the hydrolytic activity of the lipase) may be determined with a pNP assay using substrates with various chain length as described in the “Materials & Methods”-section.

Booster(s): In context of the present invention, a “booster” refers to a compound which enhances the performance of a lipase compared to when the lipase is used alone, i.e., without the booster present at the same performance test conditions. The performance may, according to the present invention, be determined as percent (%) fat removal as described in the Examples 1-3.

Alternatively, the performance may be determined as the relative wash performance “RP (wash)”. The wash performance is enhanced when the Performance Index (PI) is greater than 1, i.e., compared to the wash performance without said booster compound at the same conditions.

Fragment: The term “fragment” means a polypeptide having one or more (e.g., several) amino acids absent from the amino and/or carboxyl terminus of a polypeptide; wherein the fragment has lipase activity. In one aspect, a fragment contains at least 50%, at least 55%, at least 60%, at least 65%, at least 70%, at least 75%, at least 80%, at least 85%, at least 90%, or at least 95% but less than 100% of the number of amino acids 1 to 269 of SEQ ID NOs: 1, 2, 3, or 4.

Parent or parent lipase: The term “parent” or “parent lipase” means a lipase to which an alteration is made to produce the enzyme variants. The parent lipase may be a naturally occurring (wild-type) polypeptide but may also be a variant and/or fragment thereof. In preferred embodiments, the parent lipase may be one shown in SEQ ID NOs: 1, 2, 3, 4 5 or 6, respectively.

SEQ ID NO: 1 is the wild-type Thermomyces lanuginosus lipase (synonym Humicola lanuginosa DSM 4109 lipase) often referred to simply as “TLL”.

SEQ ID NO: 2 is a variant of the wild-type Thermomyces lanuginosus lipase disclosed as SEQ ID NO: 2 in WO 2019/154952.

SEQ ID NO: 3 is the wild-type Absidia sp lipase disclosed as SEQ ID NO: 3 in WO 2021/001400.

SEQ ID NO: 4 is a Absidia sp. lipase variant disclosed as SEQ ID NO: 2 in WO 2021/001400.

SEQ ID NO: 5 is a variant of the wild-type Thermomyces lanuginosus lipase in SEQ ID NO: 1.

SEQ ID NO: 6 is the Geotrichum candidum lipase (referred to as “GCL 1”) also disclosed as SEQ ID NO: 1 in WO 2022/162043 (which hereby is incorporated by reference).

Sequence identity: The relatedness between two amino acid sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the −nobrief option) is used as the percent identity and is calculated as follows:

(Identical Residues×100)/(Length of Alignment−Total Number of Gaps in Alignment)

Laundry: The term “laundry” includes according to the invention textiles, clothes, linen and the like and may be made from any material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the terms fabric or garment are used it is intended to include the broader term textiles as well. In the context of the present invention, the term “laundry” also covers fabrics.

Variant: The term “variant” means a polypeptide having lipase activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash Performance: Wash performance may be tested using the well-known Terg-O-Tometer (TOM), which is a medium-scale wash assay, in which more textile swatch types can be tested. A TOM is basically a large temperature-controlled water bath with up to 16 open metal beakers submerged into it. Each beaker constitutes a small top-loader style washing machine, and during an experiment each of them will contain a solution of a specific detergent/enzyme system together with soiled and unsoiled fabrics whose performance is tested. A rotating stirring arm within each beaker is used to create mechanical stress, generally at 120 rpm.

Detergents for testing Fat Removal: For the purpose of the present invention, fat removal can be determined using for instance Model X detergent. The Model X detergent comprises a surfactant system comprising anionic and nonionic surfactants as described in Examples 1-3. The fat removal may be determined as described in Examples 1-3 comparing the % fat removal with and without booster(s) present.

Wild-type lipase: The term “wild-type” lipase means a lipase expressed by a naturally occurring microorganism, such as a bacterium, yeast, or filamentous fungus found in nature. In embodiments, the wild-type lipase may in particular be the one shown in SEQ ID NO: 1, which is derived from Thermomyces lanuginosus DSM 4109 (synonym Humicola lanuginosa DSM 4109) or the Absidia sp. lipase shown in SEQ ID NO: 3 or the lipase derived from Geotrichum candidum (GCL1) shown in SEQ ID NO: 6 herein.

### Conventions for Designation of Variants

For purposes of the present invention, the lipases disclosed as SEQ ID NO: 1 is used to determine the corresponding amino acid residue in another lipase. The amino acid sequence of another lipase is aligned with SEQ ID NO: 1, and based on the alignment, the amino acid position number corresponding to any amino acid residue in the polypeptide disclosed in SEQ ID NO: 1 is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix.

Identification of the corresponding amino acid residue in another lipase can be determined by an alignment of multiple polypeptide sequences using several computer programs including, but not limited to, MUSCLE (multiple sequence comparison by log-expectation; version 3.5 or later; Edgar, 2004, Nucleic Acids Research 32: 1792-1797), MAFFT (version 6.857 or later; Katoh and Kuma, 2002, Nucleic Acids Research 30: 3059-3066; Katoh et al., 2005, Nucleic Acids Research 33: 511-518; Katoh and Toh, 2007, Bioinformatics 23: 372-374; Katoh et al., 2009, Methods in Molecular Biology 537: 39-64; Katoh and Toh, 2010, Bioinformatics 26: 1899-1900), and EMBOSS EMMA employing ClustalW (1.83 or later; Thompson et al., 1994, Nucleic Acids Research 22: 4673-4680), using their respective default parameters.

When the other enzyme has diverged from the lipase of SEQ ID NO: 1 such that traditional sequence-based comparison fails to detect their relationship (Lindahl and Elofsson, 2000, J. Mol. Biol. 295: 613-615), other pairwise sequence comparison algorithms can be used. Greater sensitivity in sequence-based searching can be attained using search programs that utilize probabilistic representations of polypeptide families (profiles) to search databases. For example, the PSI-BLAST program generates profiles through an iterative database search process and is capable of detecting remote homologs (Atschul et al., 1997, Nucleic Acids Res. 25: 3389-3402). Even greater sensitivity can be achieved if the family or superfamily for the polypeptide has one or more representatives in the protein structure databases. Programs such as GenTHREADER (Jones, 1999, J. Mol. Biol. 287:797-815; McGuffin and Jones, 2003, Bioinformatics 19: 874-881) utilize information from a variety of sources (PSI-BLAST, secondary structure prediction, structural alignment profiles, and solvation potentials) as input to a neural network that predicts the structural fold for a query sequence. Similarly, the method of Gough et al., 2000, J. Mol. Biol. 313: 903-919, can be used to align a sequence of unknown structure with the superfamily models present in the SCOP database. These alignments can in turn be used to generate homology models for the polypeptide, and such models can be assessed for accuracy using a variety of tools developed for that purpose.

For proteins of known structure, several tools and resources are available for retrieving and generating structural alignments. For example, the SCOP superfamilies of proteins have been structurally aligned, and those alignments are accessible and downloadable. Two or more protein structures can be aligned using a variety of algorithms such as the distance alignment matrix (Holm and Sander, 1998, Proteins 33: 88-96) or combinatorial extension (Shindyalov and Bourne, 1998, Protein Engineering 11: 739-747), and implementation of these algorithms can additionally be utilized to query structure databases with a structure of interest in order to discover possible structural homologs (e.g., Holm and Park, 2000, Bioinformatics 16: 566-567).

In describing variants used in context of the invention, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine(S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly, the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple alterations. Variants comprising multiple alterations are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr, Glu” or “R170Y, E” represents a substitution of arginine at position 170 with tyrosine or glutamic acid. Thus, “Tyr167Gly, Ala+Arg170Gly, Ala” designates the following variants:
“Tyr167Gly+Arg170Gly”, “Tyr167Gly+Arg170Ala”, “Tyr167Ala+Arg170Gly”, and “Tyr167Ala+Arg170Ala”.

### DETAILED DESCRIPTION OF THE INVENTION

The present invention relates to detergent compositions capable of removing fat stains by a lipase during cleaning or washing of laundry. The invention also relates to methods of cleaning or washing laundry using a detergent composition of the invention.

### Detergent Compositions of the Invention

In the first aspect, the invention relates to detergent compositions comprising:
(a) a surfactant or surfactant system;
(b) a lipase; and
(c) one or more boosters selected from the group of:
   i) alkoxylated polyethyleneimine, in particular ethoxylated and propoxylated polyethyleneimine;
   ii) alkoxylated polyetheramine, in particular ethoxylated and propoxylated polyetheramine;
   iii) guanidine hydrochloride; and
   iv) rhamnolipid.

### Composition Components

The non-limiting list of composition components illustrated hereinafter are suitable for use in the compositions and methods of the invention and may be desirably incorporated in certain embodiments of the invention, e.g., to assist or enhance cleaning performance, for treatment of the substrate to be cleaned, or to modify the aesthetics of the composition as is the case with perfumes, colorants, dyes or the like. The levels of any such components incorporated in any compositions are in addition to any materials previously recited for incorporation. The precise nature of these additional components, and levels of incorporation thereof, will depend on the physical form of the composition and the nature of the cleaning operation for which it is to be used. Although components mentioned below are categorized by general header according to a particular functionality, this is not to be construed as a limitation, as a component may comprise additional functionalities as will be appreciated by the skilled artisan.

Unless otherwise indicated the amounts in percentage is by weight of the composition (wt %). Suitable component materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments. In addition to the disclosure below, suitable examples of such other components and levels of use are found in U.S. Pat. Nos. 5,576,282, 6,306,812, and 6,326,348 hereby incorporated by reference.

Thus, in certain embodiments the invention do not contain one or more of the following adjuncts materials: surfactants, soaps, builders, chelating agents, dye transfer inhibiting agents, dispersants, additional enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, perfume delivery systems, structure elasticizing agents, fabric softeners, carriers, hydrotropes, processing aids, solvents and/or pigments. However, when one or more components are present, such one or more components may be present as detailed below:

### Surfactant or Surfactant System

A detergent composition of the present invention comprises a surfactant or surfactant system, a lipase and one or more booster compounds. In an embodiment, the surfactant(s) can be selected from nonionic surfactants, anionic surfactants, cationic surfactants, ampholytic surfactants, zwitterionic surfactants, semi-polar nonionic surfactants and mixtures thereof.

The surfactant(s) is (are) typically present at a level of from 0.1 to 60 wt %, from 0.2 to 40 wt %, from 0.5 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 3 to 20 wt %, from 3 to 10 wt %, from 8 to 12 wt %, from 10 to 12 wt %, from 20 to 25 wt % or from 25-60%. Suitable anionic detersive surfactants include sulphate and sulphonate detersive surfactants.

Suitable sulphonate detersive surfactants include alkyl benzene sulphonate, in one aspect, C₁₀₋₁₃ alkyl benzene sulphonate. Suitable alkyl benzene sulphonate (LAS) may be obtained, by sulphonating commercially available linear alkyl benzene (LAB); suitable LAB includes low 2-phenyl LAB, such as Isochem® or Petrelab®, other suitable LAB include high 2-phenyl LAB, such as Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Suitable sulphate detersive surfactants include alkyl sulphate, in one aspect, C₈₋₁₈ alkyl sulphate, or predominantly C₁₂ alkyl sulphate.

Another suitable sulphate detersive surfactant is alkyl alkoxylated sulphate, in one aspect, alkyl ethoxylated sulphate, in one aspect, a C₈₋₁₈ alkyl alkoxylated sulphate, in another aspect, a C₈₋₁₈ alkyl ethoxylated sulphate, typically the alkyl alkoxylated sulphate has an average degree of alkoxylation of from 0.5 to 20, or from 0.5 to 10, typically the alkyl alkoxylated sulphate is a C₈₋₁₈ alkyl ethoxylated sulphate having an average degree of ethoxylation of from 0.5 to 10, from 0.5 to 7, from 0.5 to 5 or from 0.5 to 3.

The alkyl sulphate, alkyl alkoxylated sulphate and alkyl benzene sulphonates may be linear or branched, substituted or un-substituted.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, e.g. a mid-chain branched alkyl sulphate. In one aspect, the mid-chain branches are C₁₋₄ alkyl groups, typically methyl and/or ethyl groups.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS) or sodium lauryl sulfate (SLS), fatty alcohol sulfates (FAS), primary alcohol sulfates (PAS), alcohol ethersulfates (AES or AEOS or FES, also known as alcohol ethoxysulfates or fatty alcohol ether sulfates), sodium laureth sulfate (SLES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

Suitable non-ionic detersive surfactants are selected from the group consisting of: C₈-C₁₈ alkyl ethoxylates, such as, NEODOL®; C₆-C₁₂ alkyl phenol alkoxylates wherein the alkoxylate units may be ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic®; C₁₄-C₂₂ mid-chain branched alcohols; C₁₄-C₂₂ mid-chain branched alkyl alkoxylates, typically having an average degree of alkoxylation of from 1 to 30; alkylpolysaccharides, in one aspect, alkylpolyglycosides; polyhydroxy fatty acid amides; ether capped poly(oxyalkylated) alcohol surfactants; and mixtures thereof.

Suitable non-ionic detersive surfactants include alkyl polyglucoside and/or an alkyl alkoxylated alcohol.

In one aspect, non-ionic detersive surfactants include alkyl alkoxylated alcohols, in one aspect C₈₋₁₈ alkyl alkoxylated alcohol, e.g. a C₈₋₁₈ alkyl ethoxylated alcohol, the alkyl alkoxylated alcohol may have an average degree of alkoxylation of from 1 to 50, from 1 to 30, from 1 to 20, or from 1 to 10. In one aspect, the alkyl alkoxylated alcohol may be a C₈₋₁₈ alkyl ethoxylated alcohol having an average degree of ethoxylation of from 1 to 10, from 1 to 7, more from 1 to 5 or from 3 to 7. The alkyl alkoxylated alcohol can be linear or branched and substituted or un-substituted. Suitable nonionic surfactants include Lutensol®.

Non-limiting examples of nonionic surfactants include alcohol ethoxylates (AE or AEO), such as linear alcohol (C12-15) ethoxylate (LAE), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula: (R)(R₁)(R₂)(R₃)N⁺ X⁻, wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, e.g. chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

Suitable amphoteric/zwitterionic surfactants include amine oxides and betaines such as alkyldimethylbetaines, sulfobetaines, or combinations thereof. Amine-neutralized anionic surfactants-Anionic surfactants and adjunct anionic cosurfactants, may exist in an acid form, and said acid form may be neutralized to form a surfactant salt which is desirable for use in the present detergent compositions. Typical agents for neutralization include the metal counterion base such as hydroxides, eg, NaOH or KOH. Further preferred agents for neutralizing anionic surfactants of the present invention and adjunct anionic surfactants or cosurfactants in their acid forms include ammonia, amines, or alkanolamines. Alkanolamines are preferred. Suitable non-limiting examples including monoethanolamine, diethanolamine, triethanolamine, and other linear or branched alkanolamines known in the art; e.g., highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Non-limiting examples of semipolar surfactants include amine oxides (AO) such as alkyldimethylamineoxide.

Surfactant systems comprising mixtures of one or more anionic and in addition one or more nonionic surfactants optionally with an additional surfactant such as a cationic surfactant, may be preferred. Preferred weight ratios of anionic to nonionic surfactant are at least 2:1, or at least 1:1 to 1:10.

In one aspect a surfactant system may comprise a mixture of isoprenoid surfactants represented by formula A and formula B:

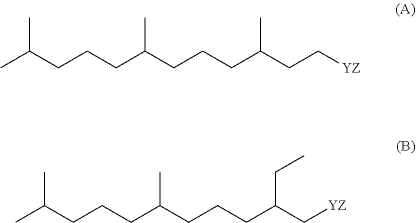

where Y is CH₂ or null, and Z may be chosen such that the resulting surfactant is selected from the following surfactants: an alkyl carboxylate surfactant, an alkyl polyalkoxy surfactant, an alkyl anionic polyalkoxy sulfate surfactant, an alkyl glycerol ester sulfonate surfactant, an alkyl dimethyl amine oxide surfactant, an alkyl polyhydroxy based surfactant, an alkyl phosphate ester surfactant, an alkyl glycerol sulfonate surfactant, an alkyl polygluconate surfactant, an alkyl polyphosphate ester surfactant, an alkyl phosphonate surfactant, an alkyl polyglycoside surfactant, an alkyl monoglycoside surfactant, an alkyl diglycoside surfactant, an alkyl sulfosuccinate surfactant, an alkyl disulfate surfactant, an alkyl disulfonate surfactant, an alkyl sulfosuccinamate surfactant, an alkyl glucamide surfactant, an alkyl taurinate surfactant, an alkyl sarcosinate surfactant, an alkyl glycinate surfactant, an alkyl isethionate surfactant, an alkyl dialkanolamide surfactant, an alkyl monoalkanolamide surfactant, an alkyl monoalkanolamide sulfate surfactant, an alkyl diglycolamide surfactant, an alkyl diglycolamide sulfate surfactant, an alkyl glycerol ester surfactant, an alkyl glycerol ester sulfate surfactant, an alkyl glycerol ether surfactant, an alkyl glycerol ether sulfate surfactant, alkyl methyl ester sulfonate surfactant, an alkyl polyglycerol ether surfactant, an alkyl polyglycerol ether sulfate surfactant, an alkyl sorbitan ester surfactant, an alkyl ammonioalkanesulfonate surfactant, an alkyl amidopropyl betaine surfactant, an alkyl allylated quat based surfactant, an alkyl monohydroxyalkyl-di-alkylated quat based surfactant, an alkyl di-hydroxyalkyl monoalkyl quat based surfactant, an alkylated quat surfactant, an alkyl trimethylammonium quat surfactant, an alkyl polyhydroxalkyl oxypropyl quat based surfactant, an alkyl glycerol ester quat surfactant, an alkyl glycol amine quat surfactant, an alkyl monomethyl dihydroxyethyl quaternary ammonium surfactant, an alkyl dimethyl monohydroxyethyl quaternary ammonium surfactant, an alkyl trimethylammonium surfactant, an alkyl imidazoline-based surfactant, an alken-2-yl-succinate surfactant, an alkyl a-sulfonated carboxylic acid surfactant, an alkyl a-sulfonated carboxylic acid alkyl ester surfactant, an alpha olefin sulfonate surfactant, an alkyl phenol ethoxylate surfactant, an alkyl benzenesulfonate surfactant, an alkyl sulfobetaine surfactant, an alkyl hydroxysulfobetaine surfactant, an alkyl ammoniocarboxylate betaine surfactant, an alkyl sucrose ester surfactant, an alkyl alkanolamide surfactant, an alkyl di(polyoxyethylene) monoalkyl ammonium surfactant, an alkyl mono(polyoxyethylene) dialkyl ammonium surfactant, an alkyl benzyl dimethylammonium surfactant, an alkyl aminopropionate surfactant, an alkyl amidopropyl dimethylamine surfactant, or a mixture thereof; and if Z is a charged moiety, Z is charge-balanced by a suitable metal or organic counter ion. Suitable counter ions include a metal counter ion, an amine, or an alkanolamine, e.g., C1-C6 alkanolammonium. More specifically, suitable counter ions include Na+, Ca+, Li+, K+, Mg+, e.g., monoethanolamine (MEA), diethanolamine (DEA), triethanolamine (TEA), 2-amino-I-propanol, 1-aminopropanol, methyldiethanolamine, dimethylethanolamine, monoisopropanolamine, triisopropanolamine, I-amino-3-propanol, or mixtures thereof. In one embodiment, the compositions contain from 5% to 97% of one or more non-isoprenoid surfactants; and one or more adjunct cleaning additives; wherein the weight ratio of surfactant of formula A to surfactant of formula B is from 50:50 to 95:5.

In an embodiment, the composition of the invention comprises one or more anionic surfactant and/or one or more nonionic surfactant.

In a preferred embodiment, the composition of the invention comprises one or more anionic surfactants, preferably from the group of linear alkylbenzenesulfonic acid (LAS), sodium lauryl sulfate (SLS) and sodium laureth sulfate (SLES).

In an embodiment the composition comprises one or more non-ionic surfactants, preferably alcohol ethoxylate (AEO), in particular linear alcohol (C12-15) ethoxylate (LAE).

In a preferred embodiment, the composition of the invention comprises the anionic surfactant linear alkylbenzenesulfonic acid (LAS) and the non-ionic surfactant alcohol ethoxylate (AEO).

In a preferred embodiment, the composition comprises the anionic surfactant linear alkylbenzenesulfonic acid (LAS) and the non-ionic surfactant C12-C14 alcohol ethoxylate with an average of 7 EO.

In an embodiment the ratio between anionic surfactant and non-ionic surfactant is in the range 20:1 to 1:1, such as 15:1 to 10:1, in particular around 15:2.

In a specific embodiment, the composition comprises the components in Model X detergent disclosed in Examples 1-3.

### Soap

The compositions of the invention may also contain soap. Without being limited by theory, it may be desirable to include soap as it acts in part as a surfactant and in part as a builder and may be useful for suppression of foam and may furthermore interact favorably with the various cationic compounds of the composition to enhance softness on textile fabrics treaded with the inventive compositions. Any soap known in the art for use in laundry detergents may be utilized. In one embodiment, the compositions contain from 0 wt % to 20 wt %, from 0.5 wt % to 20 wt %, from 4 wt % to 10 wt %, or from 4 wt % to 7 wt % of soap.

Examples of soap useful herein include oleic acid soaps, palmitic acid soaps, palm kernel fatty acid soaps, and mixtures thereof. Typical soaps are in the form of mixtures of fatty acid soaps having different chain lengths and degrees of substitution. One such mixture is topped palm kernel fatty acid.

In one embodiment, the soap is selected from free fatty acid. In a preferred embodiment the composition comprises coco fatty acid. Other suitable fatty acids are saturated and/or unsaturated and can be obtained from natural sources such a plant or animal esters (e.g., palm kernel oil, palm oil, coconut oil, babassu oil, safflower oil, tall oil, castor oil, tallow and fish oils, grease, and mixtures thereof), or synthetically prepared (e.g., via the oxidation of petroleum or by hydrogenation of carbon monoxide via the Fisher Tropsch process).

Examples of suitable saturated fatty acids for use in the compositions of this invention include captic, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated Cn fatty acid, saturated Ci₂-Ci₄ fatty acids, and saturated or unsaturated Cn to Ci₈ fatty acids, and mixtures thereof.

When present, the weight ratio of fabric softening cationic cosurfactant to fatty acid is preferably from about 1:3 to about 3:1, more preferably from about 1:1.5 to about 1.5:1, most preferably about 1:1.

Levels of soap and of nonsoap anionic surfactants herein are percentages by weight of the detergent composition, specified on an acid form basis. However, as is commonly understood in the art, anionic surfactants and soaps are in practice neutralized using sodium, potassium or alkanolammonium bases, such as sodium hydroxide or monoethanolamine.

### Hydrotropes

The compositions of the present invention may also comprise one or more hydrotropes. A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however, the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent composition of the invention may contain from 0 to 10 wt %, such as from 0 to 5 wt %, 0.5 to 5 wt %, or from 3% to 5 wt %, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders

The compositions of the present invention may also comprise one or more builders, co-builders, builder systems or a mixture thereof. When a builder is used, the cleaning composition will typically comprise from 0 to 65 wt %, at least 1 wt %, from 2 to 60 wt % or from 5 to 10 wt % builder. In a dish wash cleaning composition, the level of builder is typically 40 to 65 wt % or 50 to 65 wt %. The composition may be substantially free of builder; substantially free means “no deliberately added” zeolite and/or phosphate. Typical zeolite builders include zeolite A, zeolite P and zeolite MAP. A typical phosphate builder is sodium tri-polyphosphate.

The builder and/or co-builder may particularly be a chelating agent that forms water-soluble complexes with Ca and Mg. Any builder and/or co-builder known in the art for use in detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), iminodiethanol (DEA) and 2,2′,2″-nitrilotriethanol (TEA), and carboxymethylinulin (CMI), and combinations thereof.

The composition may include a co-builder alone, or in combination with a builder, e.g. a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetrakis(methylene)tetrakis (phosphonic acid) (EDTMPA), diethylenetriaminepentakis(methylene)pentakis (phosphonic acid) (DTPMPA), N-(2-hydroxyethyl) iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N, N-diacetic acid (SEDA), isoserine-N,N-diacetic acid (ISDA), phenylalanine-N, N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO09/102854, U.S. Pat. No. 5,977,053.

### Chelating Agents and Crystal Growth Inhibitors

The compositions of the invention may also contain a chelating agent and/or a crystal growth inhibitor. Suitable molecules include copper, iron and/or manganese chelating agents and mixtures thereof. Suitable molecules include DTPA (Diethylene triamine pentaacetic acid), HEDP (Hydroxyethane diphosphonic acid), DTPMP (Diethylene triamine penta(methylene phosphonic acid)), 1,2-Dihydroxybenzene-3,5-disulfonic acid disodium salt hydrate, ethylenediamine, diethylene triamine, ethylenediaminedisuccinic acid (EDDS), N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP), carboxymethyl inulin and 2-Phosphonobutane 1,2,4-tricarboxylic acid (Bayhibit® AM) and derivatives thereof. Typically, the composition may comprise from 0.005 to 15 wt % or from 3.0 to 10 wt % chelating agent or crystal growth inhibitor.

### Bleach Components

The composition of the invention may also comprise a bleach component. The bleach component suitable for incorporation in compositions of the invention or use in methods of the invention comprises one or a mixture of more than one bleach component. Suitable bleach components include bleaching catalysts, photobleaches, bleach activators, hydrogen peroxide, sources of hydrogen peroxide, pre-formed peracids and mixtures thereof. In general, when a bleach component is used, the compositions of the present invention may comprise from 0 to 30 wt %, from 0.00001 to 90 wt %, 0.0001 to 50 wt %, from 0.001 to 25 wt % or from 1 to 20 wt %. Examples of suitable bleach components include:

(1) Pre-formed peracids: Suitable preformed peracids include, but are not limited to, compounds selected from the group consisting of pre-formed peroxyacids or salts thereof, typically either a peroxycarboxylic acid or salt thereof, or a peroxysulphonic acid or salt thereof.

The pre-formed peroxyacid or salt thereof is preferably a peroxycarboxylic acid or salt thereof, typically having a chemical structure corresponding to the following chemical formula:

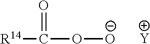

wherein: R¹⁴ is selected from alkyl, aralkyl, cycloalkyl, aryl or heterocyclic groups; the R¹⁴ group can be linear or branched, substituted or unsubstituted; and Y is any suitable counter-ion that achieves electric charge neutrality, preferably Y is selected from hydrogen, sodium or potassium. Preferably, R¹⁴ is a linear or branched, substituted or unsubstituted C₆₋₉ alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Particularly preferred peroxyacids are phthalimido-peroxy-alkanoic acids, in particular ε-phthahlimido peroxy hexanoic acid (PAP). Preferably, the peroxyacid or salt thereof has a melting point in the range of from 30° C. to 60° C.

The pre-formed peroxyacid or salt thereof can also be a peroxysulphonic acid or salt thereof, typically having a chemical structure corresponding to the following chemical formula:

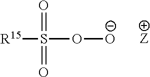

wherein: R¹⁵ is selected from alkyl, aralkyl, cycloalkyl, aryl or heterocyclic groups; the R¹⁵ group can be linear or branched, substituted or unsubstituted; and Z is any suitable counter-ion that achieves electric charge neutrality, preferably Z is selected from hydrogen, sodium or potassium. Preferably R¹⁵ is a linear or branched, substituted or unsubstituted C₆₋₉ alkyl. Preferably such bleach components may be present in the compositions of the invention in an amount from 0.01 to 50 wt % or from 0.1 to 20 wt %.

(2) Sources of hydrogen peroxide include e.g., inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts such as those selected from the group consisting of sodium salts of perborate, percarbonate and mixtures thereof. When employed, inorganic perhydrate salts are typically present in amounts of 0.05 to 40 wt % or 1 to 30 wt % of the overall composition and are typically incorporated into such compositions as a crystalline solid that may be coated. Suitable coatings include inorganic salts such as alkali metal silicate, carbonate or borate salts or mixtures thereof, or organic materials such as water-soluble or dispersible polymers, waxes, oils or fatty soaps. Preferably such bleach components may be present in the compositions of the invention in an amount of 0.01 to 50 wt % or 0.1 to 20 wt %.

(3) The term bleach activator is meant herein as a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable bleach activators are those having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or less than 4 carbon atoms; and L is leaving group. Examples of suitable leaving groups are benzoic acid and derivatives thereof-especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED), sodium 4-[(3,5,5-trimethylhexanoyl)oxy]benzene-1-sulfonate (ISONOBS), 4-(dodecanoyloxy) benzene-1-sulfonate (LOBS), 4-(decanoyloxy) benzene-1-sulfonate, 4-(decanoyloxy) benzoate (DOBS or DOBA), 4-(nonanoyloxy) benzene-1-sulfonate (NOBS), and/or those disclosed in WO98/17767. A family of bleach activators is disclosed in EP624154 and particularly preferred in that family is acetyl triethyl citrate (ATC). ATC or a short chain triglyceride like triacetin has the advantage that it is environmentally friendly. Furthermore, acetyl triethyl citrate and triacetin have good hydrolytical stability in the product upon storage and are efficient bleach activators. Finally, ATC is multifunctional, as the citrate released in the perhydrolysis reaction may function as a builder. Alternatively, the bleaching system may comprise peroxyacids of, for example, the amide, imide, or sulfone type. The bleaching system may also comprise peracids such as 6-(phthalimido) peroxyhexanoic acid (PAP). Suitable bleach activators are also disclosed in WO98/17767. While any suitable bleach activator may be employed, in one aspect of the invention the subject cleaning composition may comprise NOBS, TAED or mixtures thereof. When present, the peracid and/or bleach activator is generally present in the composition in an amount of 0.1 to 60 wt %, 0.5 to 40 wt % or 0.6 to 10 wt % based on the fabric and home care composition. One or more hydrophobic peracids or precursors thereof may be used in combination with one or more hydrophilic peracid or precursor thereof. Preferably such bleach components may be present in the compositions of the invention in an amount of 0.01 to 50 wt %, or 0.1 to 20 wt %.

The amounts of hydrogen peroxide source and peracid or bleach activator may be selected such that the molar ratio of available oxygen (from the peroxide source) to peracid is from 1:1 to 35:1, or even 2:1 to 10:1.

(4) Diacyl peroxides-preferred diacyl peroxide bleaching species include those selected from diacyl peroxides of the general formula: R¹—C(O)—OO—(O)C—R², in which R¹ represents a C₆-C₁₈ alkyl, preferably C₆-C₁₂ alkyl group containing a linear chain of at least 5 carbon atoms and optionally containing one or more substituents (e.g. —N⁺ (CH₃)₃, —COOH or —CN) and/or one or more interrupting moieties (e.g. —CONH— or —CH═CH—) interpolated between adjacent carbon atoms of the alkyl radical, and R′ represents an aliphatic group compatible with a peroxide moiety, such that R¹ and R² together contain a total of 8 to 30 carbon atoms. In one preferred aspect R¹ and R² are linear unsubstituted C₆-C₁₂ alkyl chains. Most preferably R¹ and R² are identical. Diacyl peroxides, in which both R¹ and R² are C₆-C₁₂ alkyl groups, are particularly preferred. Preferably, at least one of, most preferably only one of, the R groups (R₁ or R₂), does not contain branching or pendant rings in the alpha position, or preferably neither in the alpha nor beta positions or most preferably in none of the alpha or beta or gamma positions. In one further preferred embodiment the DAP may be asymmetric, such that preferably the hydrolysis of R1 acyl group is rapid to generate peracid, but the hydrolysis of R2 acyl group is slow.

The tetraacyl peroxide bleaching species is preferably selected from tetraacyl peroxides of the general formula: R³—C(O)—OO—C(O)—(CH₂)n-C(O)—OO—C(O)—R³, in which R³ represents a C₁-C₉ alkyl, or C₃-C₇, group and n represents an integer from 2 to 12, or 4 to 10 inclusive.

Preferably, the diacyl and/or tetraacyl peroxide bleaching species is present in an amount sufficient to provide at least 0.5 ppm, at least 10 ppm, or at least 50 ppm by weight of the wash liquor. In a preferred embodiment, the bleaching species is present in an amount sufficient to provide from 0.5 to 300 ppm, from 30 to 150 ppm by weight of the wash liquor.

Preferably the bleach component comprises a bleach catalyst (5 and 6).

(5) Preferred are organic (non-metal) bleach catalysts include bleach catalyst capable of accepting an oxygen atom from a peroxyacid and/or salt thereof and transferring the oxygen atom to an oxidizeable substrate. Suitable bleach catalysts include but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49(2), 423-38 (e.g. compound 4, p. 433); N-methyl-3,4-dihydroisoquinolinium p-toluene sulphonate, prepared as described in U.S. Pat. No. 5,360,569 (e.g. Column 11, Example 1); and N-octyl-3,4-dihydroisoquinolinium p-toluene sulphonate, prepared as described in U.S. Pat. No. 5,360,568 (e.g. Column 10, Ex. 3).

Suitable iminium zwitterions include, but are not limited to, N-(3-sulfopropyl)-3,4-dihydroisoquinolinium, inner salt, prepared as described in U.S. Pat. No. 5,576,282 (e.g. Column 31, Ex. II); N-[2-(sulphooxy) dodecyl]-3,4-dihydroisoquinolinium, inner salt, prepared as described in U.S. Pat. No. 5,817,614 (e.g. Column 32, Ex. V); 2-[3-[(2-ethylhexyl)oxy]-2-(sulphooxy) propyl]-3,4-dihydroisoquinolinium, inner salt, prepared as described in WO05/047264 (e.g. p. 18, Ex. 8), and 2-[3-[(2-butyloctyl)oxy]-2-(sulphooxy) propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy) decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society,

### Chemical Communications (1994), (22), 2569-70.

Suitable N-acyl imine oxygen transfer catalysts include, but are not limited to, [N (E)]-N-(phenylmethylene) acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Ex. 2).

Suitable perfluoroimine oxygen transfer catalysts include, but are not limited to, (Z)-2,2,3,3,4,4,4-heptafluoro-N-(nonafluorobutyl) butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Ex. 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof. In another aspect, the detergent composition comprises a bleach component having a log P_{o/w} no greater than 0, no greater than −0.5, no greater than −1.0, no greater than −1.5, no greater than −2.0, no greater than −2.5, no greater than −3.0, or no greater than −3.5. The method for determining log P_{o/w} is described in more detail below.

Typically, the bleach ingredient is capable of generating a bleaching species having a Xₛₒ of from 0.01 to 0.30, from 0.05 to 0.25, or from 0.10 to 0.20. The method for determining Xₛₒ is described in more detail below. For example, bleaching ingredients having an isoquinolinium structure are capable of generating a bleaching species that has an oxaziridinium structure. In this example, the Xₛₒ is that of the oxaziridinium bleaching species.

Preferably, the bleach catalyst has a chemical structure corresponding to the following chemical formula:

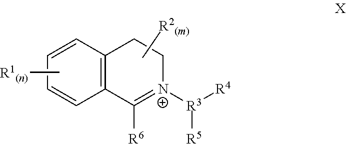

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}—[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubstituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can=0 or 1, but c must=0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

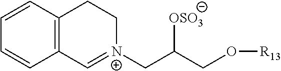

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

Preferably the bleach component comprises a source of peracid in addition to bleach catalyst, particularly organic bleach catalyst. The source of peracid may be selected from (a) pre-formed peracid; (b) percarbonate, perborate or persulfate salt (hydrogen peroxide source) preferably in combination with a bleach activator; and (c) perhydrolase enzyme and an ester for forming peracid in situ in the presence of water in a textile or hard surface treatment step.

When present, the peracid and/or bleach activator is generally present in the composition in an amount of from 0.1 to 60 wt %, from 0.5 to 40 wt % or from 0.6 to 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or 2:1 to 10:1.

(6) Metal-containing Bleach Catalysts—The bleach component may be provided by a catalytic metal complex. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243. Preferred catalysts are described in WO09/839406, U.S. Pat. No. 6,218,351 and WO00/012667. Particularly preferred are transition metal catalyst or ligands therefore that are cross-bridged polydentate N-donor ligands.

If desired, the compositions herein can be catalyzed by means of a manganese compound. Such compounds and levels of use are well known in the art and include, e.g., the manganese-based catalysts disclosed in U.S. Pat. No. 5,576,282.

Cobalt bleach catalysts useful herein are known, and are described e.g. in U.S. Pat. Nos. 5,597,936; 5,595,967. Such cobalt catalysts are readily prepared by known procedures, such as taught e.g. in U.S. Pat. Nos. 5,597,936 and 5,595,967.

Compositions herein may also suitably include a transition metal complex of ligands such as bispidones (U.S. Pat. No. 7,501,389) and/or macropolycyclic rigid ligands-abbreviated as “MRLs”. As a practical matter, and not by way of limitation, the compositions and processes herein can be adjusted to provide on the order of at least one part per hundred million of the active MRL species in the aqueous washing medium, and will typically provide from 0.005 to 25 ppm, from 0.05 to 10 ppm, or from 0.1 to 5 ppm, of the MRL in the wash liquor.

Suitable transition-metals in the instant transition-metal bleach catalyst include e.g. manganese, iron and chromium. Suitable MRLs include 5,12-diethyl-1,5,8,12-tetraazabicyclo[6.6.2]hexadecane. Suitable transition metal MRLs are readily prepared by known procedures, such as taught e.g. in U.S. Pat. No. 6,225,464 and WO00/32601.

(7) Photobleaches—suitable photobleaches include e.g. sulfonated zinc phthalocyanine sulfonated aluminium phthalocyanines, xanthene dyes and mixtures thereof. Preferred bleach components for use in the present compositions of the invention comprise a hydrogen peroxide source, bleach activator and/or organic peroxyacid, optionally generated in situ by the reaction of a hydrogen peroxide source and bleach activator, in combination with a bleach catalyst. Preferred bleach components comprise bleach catalysts, preferably organic bleach catalysts, as described above.

Particularly preferred bleach components are the bleach catalysts in particular the organic bleach catalysts.

Exemplary bleaching systems are also described, e.g. in WO2007/087258, WO2007/087244, WO2007/087259 and WO2007/087242.

### Fabric Hueing Agents

The composition of the invention may also comprise a fabric hueing agent. Suitable fabric hueing agents include dyes, dye-clay conjugates, and pigments. Suitable dyes include small molecule dyes and polymeric dyes. Suitable small molecule dyes include small molecule dyes selected from the group consisting of dyes falling into the Color Index (C.I.) classifications of Direct Blue, Direct Red, Direct Violet, Acid Blue, Acid Red, Acid Violet, Basic Blue, Basic Violet and Basic Red, or mixtures thereof.

In another aspect, suitable small molecule dyes include small molecule dyes selected from the group consisting of Color Index (Society of Dyers and Colorists, Bradford, UK) numbers Direct Violet 9, Direct Violet 35, Direct Violet 48, Direct Violet 51, Direct Violet 66, Direct Violet 99, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Red 52, Acid Violet 49, Acid Violet 50, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159 and mixtures thereof. In another aspect, suitable small molecule dyes include small molecule dyes selected from the group consisting of Color Index (Society of Dyers and Colorists, Bradford, UK) numbers Acid Violet 17, Acid Violet 43, Acid Red 52, Acid Red 73, Acid Red 88, Acid Red 150, Acid Blue 25, Acid Blue 29, Acid Blue 45, Acid Blue 113, Acid Black 1, Direct Blue 1, Direct Blue 71, Direct Violet 51 and mixtures thereof. In another aspect, suitable small molecule dyes include small molecule dyes selected from the group consisting of Color Index (Society of Dyers and Colorists, Bradford, UK) numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing conjugated chromogens (dye-polymer conjugates) and polymers with chromogens co-polymerized into the backbone of the polymer and mixtures thereof.

In another aspect, suitable polymeric dyes include polymeric dyes selected from the group consisting of fabric-substantive colorants sold under the name of Liquitint® (Milliken), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colorants, alkoxylated thiophene polymeric colorants, and mixtures thereof.

Preferred hueing dyes include the whitening agents found in WO08/87497. These whitening agents may be characterized by the following structure (I):

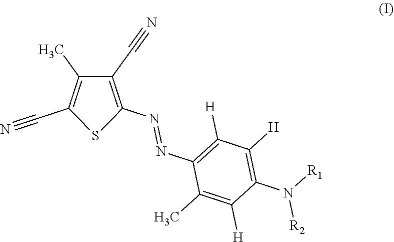

wherein R¹ and R² can independently be selected from:
   a) [(CH₂CR′HO)ₓ(CH₂CR″HO)_{y}H]
wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤5; wherein y≥1; and wherein z=0 to 5;
   b) R₁=alkyl, aryl or aryl alkyl and R₂═[(CH₂CR′HO)ₓ(CH₂CR″HO)_{y}H]
wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤10; wherein y≥1; and wherein z=0 to 5;
   c) R₁═[CH₂CH₂(OR₃)CH₂OR₄] and R₂═[CH₂CH₂(OR₃)CH₂OR₄]
wherein R³ is selected from the group consisting of H, (CH₂CH₂O)_{z}H, and mixtures thereof; and
wherein z=0 to 10;
wherein R⁴ is selected from the group consisting of (C₁-C₁₆) alkyl, aryl groups, and mixtures thereof; and
   d) wherein R1 and R2 can independently be selected from the amino addition product of styrene oxide, glycidyl methyl ether, isobutyl glycidyl ether, isopropylglycidyl ether, t-butyl glycidyl ether, 2-ethylhexylgycidyl ether, and glycidylhexadecyl ether, followed by the addition of from 1 to 10 alkylene oxide units.

A preferred whitening agent of the present invention may be characterized by the following structure (II):

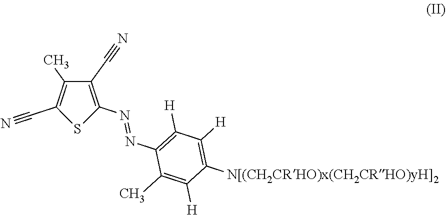

wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤5; wherein y≥1; and wherein z=0 to 5.

A further preferred whitening agent of the present invention may be characterized by the following structure (III):

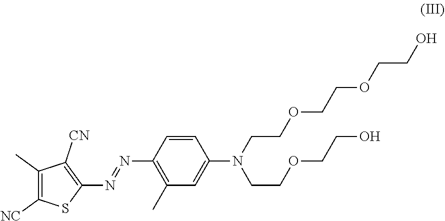 [SMILES: Cc1cc(N(CCOCCO)CCOCCOCCO)ccc1/N=N/c1sc(C#N)c(C)c1C#N]

typically comprising a mixture having a total of 5 EO groups. Suitable preferred molecules are those in Structure I having the following pendant groups in “part a” above.

TABLE 1

| | R1 | | | | R2 | | | |
|---|---|---|---|---|---|---|---|---|
| | R′ | R″ | X | y | R′ | R″ | x | y |
| A | H | H | 3 | 1 | H | H | 0 | 1 |
| B | H | H | 2 | 1 | H | H | 1 | 1 |
| c = b | H | H | 1 | 1 | H | H | 2 | 1 |
| d = a | H | H | 0 | 1 | H | H | 3 | 1 |

Further whitening agents of use include those described in US2008/34511 (Unilever). A preferred agent is “Violet 13”.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used). Suitable hueing agents are described in more detail in U.S. Pat. No. 7,208,459. Preferred levels of dye in compositions of the invention are 0.00001 to 0.5 wt %, or 0.0001 to 0.25 wt %. The concentration of dyes preferred in water for the treatment and/or cleaning step is from 1 ppb to 5 ppm, 10 ppb to 5 ppm or 20 ppb to 5 ppm. In preferred compositions, the concentration of surfactant will be from 0.2 to 3 g/l.

### Encapsulates

The composition of the invention may comprise an encapsulate comprising a core and a shell having an inner and outer surface. Said shell encapsulates said core.

In one aspect, of said encapsulate, said core may comprise a material selected from the group consisting of perfumes; brighteners; dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

In one aspect of said encapsulate, said core may comprise perfume.

In one aspect of said encapsulate, said shell may comprise melamine formaldehyde and/or cross-linked melamine formaldehyde.

In a one aspect, suitable encapsulates may comprise a core material and a shell, said shell at least partially surrounding said core material, is disclosed. At least 75%, 85% or 90% of said encapsulates may have a fracture strength of from 0.2 to 10 MPa, from 0.4 to 5 MPa, from 0.6 to 3.5 MPa, or from 0.7 to 3 MPa; and a benefit agent leakage of from 0 to 30%, from 0 to 20%, or from 0 to 5%.

In one aspect, at least 75%, 85% or 90% of said encapsulates may have a particle size from 1 to 80 microns, from 5 to 60 microns, from 10 to 50 microns, or from 15 to 40 microns. In one aspect, at least 75%, 85% or 90% of said encapsulates may have a particle wall thickness from 30 to 250 nm, from 80 to 180 nm, or from 100 to 160 nm.

In one aspect, said encapsulates' core material may comprise a material selected from the group consisting of a perfume raw material and/or optionally a material selected from the group consisting of vegetable oil, including neat and/or blended vegetable oils including castor oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof; aromatic solvents, including benzene, toluene and mixtures thereof; silicone oils; and mixtures thereof.

In one aspect, said encapsulates' wall material may comprise a suitable resin including the reaction product of an aldehyde and an amine, suitable aldehydes include, formaldehyde. Suitable amines include melamine, urea, benzoguanamine, glycoluril, and mixtures thereof. Suitable melamines include methylol melamine, methylated methylol melamine, imino melamine and mixtures thereof. Suitable ureas include dimethylol urea, methylated dimethylol urea, urea-resorcinol, and mixtures thereof.

In one aspect, suitable formaldehyde scavengers may be employed with the encapsulates e.g. in a capsule slurry and/or added to a composition before, during or after the encapsulates are added to such composition. Suitable capsules may be made by the following teaching of US2008/0305982; and/or US2009/0247449.

In a preferred aspect the composition can also comprise a deposition aid, preferably consisting of the group comprising cationic or nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or monomers selected from the group comprising acrylic acid and acrylamide.

### Perfumes

In one aspect, the composition of the invention also comprises a perfume that comprises one or more perfume raw materials selected from the group consisting of 1,1′-oxybis-2-propanol; 1,4-cyclohexanedicarboxylic acid, diethyl ester; (ethoxymethoxy) cyclododecane; 1,3-nonanediol, monoacetate; (3-methylbutoxy) acetic acid, 2-propenyl ester; beta-methyl cyclododecaneethanol; 2-methyl-3-[(1,7,7-trimethylbicyclo[2.2.1]hept-2-yl)oxy]-1-propanol; oxacyclohexadecan-2-one; alpha-methyl-benzenemethanol acetate; trans-3-ethoxy-1,1,5-trimethylcyclohexane; 4-(1,1-dimethylethyl) cyclohexanol acetate; dodecahydro-3a,6,6,9a-tetramethylnaphtho[2,1-b]furan; beta-methyl benzenepropanal; beta-methyl-3-(1-methylethyl)benzenepropanal; 4-phenyl-2-butanone; 2-methylbutanoic acid, ethyl ester; benzaldehyde; 2-methylbutanoic acid, 1-methylethyl ester; dihydro-5-pentyl-2(3H)furanone; (2E)-1-(2,6,6-trimethyl-2-cyclohexen-1-yl)-2-buten-1-one; dodecanal; undecanal; 2-ethyl-alpha, alpha-dimethylbenzenepropanal; decanal; alpha, alpha-dimethylbenzeneethanol acetate; 2-(phenylmethylene)octanal; 2-[[3-[4-(1,1-dimethylethyl)phenyl]-2-methylpropylidene]amino]benzoic acid, methyl ester; 1-(2,6,6-trimethyl-3-cyclohexen-1-yl)-2-buten-1-one; 2-pentylcyclopentanone; 3-oxo-2-pentyl cyclopentaneacetic acid, methyl ester; 4-hydroxy-3-methoxybenzaldehyde; 3-ethoxy-4-hydroxybenzaldehyde; 2-heptylcyclopentanone; 1-(4-methylphenyl)ethanone; (3E)-4-(2,6,6-trimethyl-1-cyclohexen-1-yl)-3-buten-2-one; (3E)-4-(2,6,6-trimethyl-2-cyclohexen-1-yl)-3-buten-2-one; benzeneethanol; 2H-1-benzopyran-2-one; 4-methoxybenzaldehyde; 10-undecenal; propanoic acid, phenylmethyl ester; beta-methylbenzenepentanol; 1,1-diethoxy-3,7-dimethyl-2,6-octadiene; alpha, alpha-dimethylbenzeneethanol; (2E)-1-(2,6,6-trimethyl-1-cyclohexen-1-yl)-2-buten-1-one; acetic acid, phenylmethyl ester; cyclohexanepropanoic acid, 2-propenyl ester; hexanoic acid, 2-propenyl ester; 1,2-dimethoxy-4-(2-propenyl)benzene; 1,5-dimethyl-bicyclo[3.2.1]octan-8-one oxime; 4-(4-hydroxy-4-methylpentyl)-3-cyclohexene-1-carboxaldehyde; 3-buten-2-ol; 2-[[[2,4(or 3,5)-dimethyl-3-cyclohexen-1-yl]methylene]amino]benzoic acid, methyl ester; 8-cyclohexadecen-1-one; methyl ionone; 2,6-dimethyl-7-octen-2-ol; 2-methoxy-4-(2-propenyl) phenol; (2E)-3,7-dimethyl-2,6-Octadien-1-ol; 2-hydroxy-Benzoic acid, (3Z)-3-hexenyl ester; 2-tridecenenitrile; 4-(2,2-dimethyl-6-methylenecyclohexyl)-3-methyl-3-buten-2-one; tetrahydro-4-methyl-2-(2-methyl-1-propenyl)-2H-pyran; Acetic acid, (2-methylbutoxy)-, 2-propenyl ester; Benzoic acid, 2-hydroxy, 3-methylbutyl ester; 2-Buten-1-one, 1-(2,6,6-trimethyl-1-cyclohexen-1-yl)-, (Z)-Cyclopentanecarboxylic acid, 2-hexyl-3-oxo-, methyl ester; Benzenepropanal, 4-ethyl-.alpha.,.alpha.-dimethyl-; 3-Cyclohexene-1-carboxaldehyde, 3-(4-hydroxy-4-methylpentyl)-; Ethanone, 1-(2,3,4,7,8,8a-hexahydro-3,6,8,8-tetramethyl-1H-3a,7-methanoazulen-5-yl)-, [3R-(3.alpha.,3a.beta.,7.beta.,8a.alpha.)]-; Undecanal, 2-methyl-2H-Pyran-2-one, 6-butyltetrahydro-; Benzenepropanal, 4-(1,1-dimethylethyl)-.alpha.-methyl-; 2(3H)-Furanone, 5-heptyldihydro-; Benzoic acid, 2-[(7-hydroxy-3,7-dimethyloctylidene)amino]-, methyl; Benzoic acid, 2-hydroxy-, phenylmethyl ester; Naphthalene, 2-methoxy-; 2-Cyclopenten-1-one, 2-hexyl-; 2(3H)-Furanone, 5-hexyldihydro-; Oxiranecarboxylic acid, 3-methyl-3-phenyl-, ethyl ester; 2-Oxabicyclo[2.2.2]octane, 1,3,3-trimethyl-; Benzenepentanol, .gamma.-methyl-; 3-Octanol, 3,7-dimethyl-; 3,7-dimethyl-2,6-octadienenitrile; 3,7-dimethyl-6-octen-1-ol; Terpineol acetate; 2-methyl-6-methylene-7-Octen-2-ol, dihydro derivative; 3a,4,5,6,7,7a-hexahydro-4,7-Methano-1H-inden-6-ol propanoate; 3-methyl-2-buten-1-ol acetate; (Z)-3-Hexen-1-ol acetate; 2-ethyl-4-(2,2,3-trimethyl-3-cyclopenten-1-yl)-2-buten-1-ol; 4-(octahydro-4,7-methano-5H-inden-5-ylidene)-butanal; 3-2,4-dimethyl-cyclohexene-1-carboxaldehyde; 1-(1,2,3,4,5,6,7,8-octahydro-2,3,8,8-tetramethyl-2-naphthalenyl)-ethanone; 2-hydroxy-benzoic acid, methyl ester; 2-hydroxy-benzoic acid, hexyl ester; 2-phenoxy-ethanol; 2-hydroxy-benzoic acid, pentyl ester; 2,3-heptanedione; 2-hexen-1-ol; 6-Octen-2-ol, 2,6-dimethyl-; damascone (alpha, beta, gamma or delta or mixtures thereof), 4,7-Methano-1H-inden-6-ol, 3a,4,5,6,7,7a-hexahydro-, acetate; 9-Undecenal; 8-Undecenal; Isocyclocitral; Ethanone, 1-(1,2,3,5,6,7,8,8a-octahydro-2,3,8,8-tetramethyl-2-naphthalenyl)-; 3-Cyclohexene-1-carboxaldehyde, 3,5-dimethyl-; 3-Cyclohexene-1-carboxaldehyde, 2,4-dimethyl-; 1,6-Octadien-3-ol, 3,7-dimethyl-; 1,6-Octadien-3-ol, 3,7-dimethyl-, acetate; Lilial (p-t-Bucinal), and Cyclopentanone, 2-[2-(4-methyl-3-cyclohexen-1-yl)propyl]- and 1-methyl-4-(1-methylethenyl) cyclohexene and mixtures thereof.

In one aspect, the composition may comprise an encapsulated perfume particle comprising either a water-soluble hydroxylic compound or melamine-formaldehyde or modified polyvinyl alcohol. In one aspect the encapsulate comprises (a) an at least partially water-soluble solid matrix comprising one or more water-soluble hydroxylic compounds, preferably starch; and (b) a perfume oil encapsulated by the solid matrix.

In a further aspect the perfume may be pre-complexed with a polyamine, preferably a polyethylenimine so as to form a Schiff base.

### Polymers

A composition of the invention may also comprise one or more polymers. Examples are carboxymethylcellulose, poly(vinyl-pyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The composition may comprise one or more amphiphilic cleaning polymers such as the compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

The composition may comprise amphiphilic alkoxylated grease cleaning polymers which have balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure. These may comprise alkoxylated polyalkylenimines, preferably having an inner polyethylene oxide block and an outer polypropylene oxide block.

Alkoxylated polycarboxylates such as those prepared from polyacrylates are useful herein to provide additional grease removal performance. Such materials are described in WO91/08281 and PCT90/01815. Chemically, these materials comprise polyacrylates having one ethoxy side-chain per every 7-8 acrylate units. The side-chains are of the formula —(CH₂CH₂O)ₘ (CH₂)ₙCH₃ wherein m is 2-3 and n is 6-12. The side-chains are ester-linked to the polyacrylate “backbone” to provide a “comb” polymer type structure. The molecular weight can vary, but is typically in the range of 2000 to 50,000. Such alkoxylated polycarboxylates can comprise from 0.05 wt % to 10 wt % of the compositions herein.

The isoprenoid-derived surfactants of the present invention, and their mixtures with other cosurfactants and other adjunct ingredients, are particularly suited to be used with an amphilic graft co-polymer, preferably the amphilic graft co-polymer comprises (i) polyethyelene glycol backbone; and (ii) and at least one pendant moiety selected from polyvinyl acetate, polyvinyl alcohol and mixtures thereof. A preferred amphilic graft co-polymer is Sokalan HP22, supplied from BASF. Suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is preferably 6000 and the weight ratio of the polyethylene oxide to polyvinyl acetate is 40 to 60 and no more than 1 grafting point per 50 ethylene oxide units.

### Carboxylate Polymer

The composition of the present invention may include one or more carboxylate polymers such as a maleate/acrylate random copolymer or polyacrylate homopolymer. In one aspect, the carboxylate polymer is a polyacrylate homopolymer having a molecular weight of from 4,000 to 9,000 Da, or from 6,000 to 9,000 Da.

### Soil Release Polymer

The composition of the present invention may also include one or more soil release polymers having a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)
wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

### Cellulosic Polymer

The composition of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 to 300,000 Da.

### Lipases

A composition of the invention comprises, besides a surfactant or a surfactant system and a booster also a lipase. Further, an enzyme product of the invention comprises besides a booster also a lipase.

The lipase may be any lipase. In an embodiment, the lipase is of microbial origin. In an embodiment the lipase is of bacterial origin. In a preferred embodiment, the lipase is of fungal origin, such as from a filamentous fungus or a yeast.

Examples of lipases include lipases from Thermomyces, e.g. from T. lanuginosus (previously named Humicola lanuginosa) as described in EP258068 and EP305216, cutinase from Humicola, e.g. H. insolens (WO96/13580), lipase from Absidia reflexa disclosed in US 2009/0221033 A1 (SEQ ID NO: 3), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412, WO13/033318), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

Preferred commercial lipase products include Lipolase™, Lipex™; Lipolex™, Lipoclean™, Lipex Evity 100L, Lipex Evity 105T, Lipex Evity 200L (Novozymes A/S), Lumafast (originally from Genencor), Preferenz L100 (Danisco US Inc.), and Lipomax (originally from Gist-Brocades).

Lipase of SEQ ID NO: 1-Thermomyces lanuginosus Lipase (TLL)

In a preferred embodiment, the enzyme product of the invention or detergent composition of the invention comprise a lipase derived from a strain of Thermomyces, in particular a strain of Thermomyces lanuginosus (synonym Humicola lanuginosa) or a variant thereof. In a specific embodiment, the lipase is the one shown in SEQ ID NO: 1 or a variant thereof.

In an embodiment, the lipase is:
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1;
ii) a variant of a parent lipase having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 1;
iii) a fragment of the lipase in (i) or (ii) having lipase activity,
   wherein the variant comprises substitutions at positions corresponding to T231R+N233R and at least one or more (e.g., several) of D96E, D111A, D254S, G163K, P256T, G91T and G38A of SEQ ID NO: 1.

In a specific embodiment, the lipase, used in an enzyme product or composition of the invention, is a variant of a parent lipase, wherein the variant has lipase activity, has at least 60%, in particular at least 65%, at least 70%, at least 75% at least 80%, at least 85%, at least 90%, at least 95%, at least 96%, at least 97%, at least 98%, at least 99% but less than 100% sequence identity with SEQ ID NO: 1, and comprises substitutions selected from the group of:
D96E+T231R+N233R;
N33Q+D96E+T231R+N233R;
N33Q+D111A+T231R+N233R;
N33Q+T231R+N233R+P256T;
N33Q+G38A+G91T+G163K+T231R+N233R+D254S;
N33Q+G38A+G91T+D96E+D111A+G163K+T231R+N233R+D254S+P256T;
D27R+N33Q+G38A+D96E+D111A+G163K+T231R+N233R+D254S+P256T;
D27R+N33Q+G38A+G91T+D96E+D111A+G163K+T231R+N233R+P256T;
D27R+N33Q+G38A+G91T+D96E+D111A+G163K+T231R+N233R+D254S;
D27R+G38A+G91T+D96E+D111A+G163K+T231R+N233R+D254S+P256T;
D96E+T231R+N233R+D254S;
T231R+N233R+D254S+P256T;
G163K+T231R+N233R+D254S;
D27R+N33Q+G38A+G91T+D96E+G163K+T231R+N233R+D254S+P256T;
D27R+G91T+D96E+D111A+G163K+T231R+N233R+D254S+P256T;
D96E+G163K+T231R+N233R+D254S;
D27R+G163K+T231R+N233R+D254S;
D27R+G38A+G91T+D96E+D111A+G163K+T231R+N233R+D254S;
D27R+G38A+G91T+D96E+G163K+T231R+N233R+D254S+P256T;
D27R+G38A+D96E+D111A+G163K+T231R+N233R+D254S+P256T;
D27R+D96E+G163K+T231R+N233R+D254S;
D27R+D96E+D111A+G163K+T231R+N233R+D254S+P256T;
D27R+G38A+D96E+G163K+T231R+N233R+D254S+P256T;
D111A+G163K+T231R+N233R+D254S+P256T;
D111A+T231R+N233R;
D111A+T231R+N233R+D254S+P256T;
D27R+D96E+D111A+G163K+T231R+N233R;
D27R+D96E+D111A+T231R+N233R;
D27R+N33Q+G38A+D96E+D111A+T231R+N233R+D254S+P256T;
D27R+G38A+D96E+D111A+G163K+E210Q+T231R+N233R+D254S+P256T;
D27R+T231R+N233R+D254S+P256T;
D96E+D111A+G163K+T231R+N233R;
D96E+D111A+G163K+T231R+N233R+D254S+P256T;
D96E+D111A+G163K+T231R+N233R+P256T;
D96E+D111A+T231R+N233R;
D96E+D111A+T231R+N233R+D254S;
D96E+D111A+T231R+N233R+D254S+P256T;
D96E+D111A+T231R+N233R+P256T;
D96E+G163K+T231R+N233R+D254S+P256T;
D96E+T231R+N233R+D254S+P256T;
D96E+T231R+N233R+P256T;
G38A+D96E+D111A+T231R+N233R;
G91T+D96E+D111A+G163K+T231R+N233R+D254S+P256T;
G91T+D96E+D111A+T231R+N233R;
G91T+D96E+T231R+N233R;
G91T+T231R+N233R+D254S+P256T;
N33Q+D96E+D111A+G163K+T231R+N233R+D254S+P256T;
T231R+N233R+D254S+P256T;
T231R+N233R+P256T.

In another embodiment, the lipase is a variant of a parent lipase, wherein said variant
(a) comprises a modification in at least one position corresponding to positions E1, V2, N33, F51, E56, L69, K98, V176, H198, E210, Y220, L227, and K237 of SEQ ID NO: 1; and optionally further comprises a modification in at least one position corresponding to positions D27, G38, D96, D111, G163, T231, N233, D254, and P256 of SEQ ID NO: 1;
(b) has a sequence identity of at least 60%, at least 65%, at least 70%, at least 75% at least 80%, at least 85%, at least 90%, at least 95%, at least 96%, at least 97%, at least 98%, at least 99% but less than 100% to SEQ ID NO: 1;
(c) has lipase activity.

In an embodiment, the lipase is a variant of a parent lipase, wherein the parent lipase is selected from the group consisting of:
a) a polypeptide having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1;
b) a fragment of the polypeptide of SEQ ID NO: 1.

In an embodiment, the lipase is a variant having lipase activity and having at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NO: 1.

In an embodiment, the lipase variant comprises a modification in at least one of the following positions corresponding to: E1, V2, D27, N33, G38, F51, E56, L69, D96, K98, D111, G163, V176, H198, E210, Y220, L227, T231, N233, K237, D254, and P256, wherein numbering is according to SEQ ID NO: 1. More preferably, the lipase variant comprises at least one of the following modifications corresponding to: E1C, V2Y, D27R, N33K, N33Q, G38A, F51V, E56K, L69R, D96E, D96L, K98I, K98Q, D111A, G163K, V176L, H198S, E210K, Y220F, L227G, T231R, N233R, N233C, K237C, D254S, and P256T, wherein numbering is according to SEQ ID NO: 1.

In an embodiment, the said lipase variant further comprises one of the substitutions selected from the group of: S54T, S83T, G91A, A150G, I255A, and E239C.

In a preferred embodiment, the lipase variant comprises substitutions corresponding to E1C+N233C in SEQ ID NO: 1 and optionally one or more additional substitutions.

In a specific embodiment, the variant has lipase activity, has at least 60%, at least 65%, at least 70%, at least 75% at least 80%, at least 85%, at least 90%, at least 95%, at least 96%, at least 97%, at least 98%, at least 99% but less than 100% sequence identity with SEQ ID NO: 1 and comprises or consists of substitutions corresponding to one of the following set of substitutions using SEQ ID NO: 1 for numbering:

E1C + H198L + N233C
E1C + H198G + N233C
E1C + L69V + N233C
E1C + L69T + N233C
E1C + L69S + N233C
E1C + L69H + N233C
E1C + L69F + N233C
E1C + L69C + N233C
E1C + H198Y + N233C
E1C + H198T + N233C
E1C + H198G + N233C
E1C + L227F + N233C
E1C + L227R + N233C
E1C + E210T + N233C
E1C + E210N + N233C
E1C + V176M + N233C
E1C + K98T + N233C
E1C + K98E + N233C
E1C + E56S + N233C
E1C + E56Q + N233C
E1C + E56R + N233C
E1C + F51M + N233C
E1C + D27R + F51Y + N233C
E1C + V2I + N233C
E1C + V2N + N233C
E1C + V2K + N233C
E1C + V2A + N233C
E1C + D96L + N233C
E1C + L69R + N233C
E1C + V2Y + N233C
E1C + N233C + P256T
E1C + N233C + D254S
E1C + T231R + N233C
E1C + H198S + N233C
E1C + D111A + N233C
E1C + D96E + N233C
E1C + G38A + N233C
E1C + N33Q + N233C
E1C + N33K + N233C
E1C + E210A + N233C
E1C + E210Q + N233C
E1C + E210R + N233C
E1C + H198D + N233C
E1C + K98R + N233C
E1C + K98V + N233C
E1C + F51L + N233C
E1C + F51I + N233C
E1C + K237C
E1C + L227G + N233C
E1C + E210K + N233C
E1C + V176L + N233C
E1C + K98Q + N233C
E1C + E56K + N233C
E1C + L147S + N233C + D254S
E1C + Y220F + N233C
E1C + K98I + N233C
E1C + N233C
E1C + D27R + F51I + E56R + K98E + T231R + N233C
E1C + D27R + F51I + E56R + K98E + T231R + N233C + D254S
E1C + D27R + G38A + F51L + K98I + D111A + G163S + H198S +
Y220F + T231R + N233C + P256T
E1C + D27R + G38A + F51L + D96E + K98I + D111A + G163K +
H198S + Y220F + T231R + N233C + D254S + P256T
E1C + D27R + G38R + F51L + D96E + K98I + D111A + G163K +
H198S + Y220F + T231R + N233C + D254S + P256T
E1C + D27R + F51L + D96I + K98I + D111A + G163K + H198S +
Y220F + T231R + N233C + P256T
E1C + D27R + F51L + D96E + K98I + D111A + G163S + H198S +
Y220F + T231R + N233C + P256T
E1C + D27R + F51L + D96E + K98I + D111A + G163K + H198S +
Y220F + T231R + N233C + P256T
E1C + D27R + G38A + F51I + D96E + K98I + D111A + G163K +
H198S + Y220F + T231R + N233C + D254S + P256T
E1C + D27R + G38A + F51V + D96E + K98I + D111A + G163K +
H198S + Y220F + T231R + N233C + P256T
E1C + D27R + F51V + D96E + K98I + D111A + G163K + H198S +
Y220F + T231R + N233C + P256T
E1C + D27R + F51V + D96E + K98I + D111A + G163S + H198S +
Y220F + T231R + N233C + D254S + P256T
E1C + D27R + F51V + D96I + K98I + D111A + G163K + H198S +
Y220F + T231R + N233C + D254S + P256T
E1C + D27R + F51V + K98I + D111A + G163K + H198S + Y220F +
T231R + N233C + D254S + P256T
E1C + D27R + F51V + D96E + K98I + D111A + G163K + H198S +
Y220F + T231R + N233C + D254S + P256T
E1C + D27R + G38A + F51V + D96E + K98I + D111A + G163K +
H198S + Y220F + T231R + N233C + D254S + P256T
E1C + F51V + D96E + K98I + D111A + G163S + H198S + Y220F +
T231R + N233C + P256T
E1C + F51L + D96E + K98I + D111A + G163K + H198S + Y220F +
T231R + N233C + D254S + P256T
E1C + G38A + F51V + D96E + K98I + D111A + G163K + H198S +
Y220F + T231R + N233C + P256T
E1C + F51V + D96E + K98I + D111A + G163K + H198S + Y220F +
T231R + N233C + P256T
E1C + F51V + D96I + K98I + D111A + G163K + H198S + Y220F +
T231R + N233C + D254S + P256T
E1C + F51V + K98I + D111A + G163K + H19S + Y220F + T231R +
N233C + D254S + P256T
E1C + F51I + D96E + K98I + D111A + G163K + H198S + Y220F +
T231R + N233C + D254S + P256T
E1C + D27R + F51L + D96E + K98I + D111A + G163K + H198S +
Y220F + T231R + N233C + D254S + P256T
E1C + D27R + N33K + G38A + F51V + D96E + K98I + D111A +
G163K + H198S + Y220F + T231R + N233C
E1C + G38R + F51V + D96E + K98I + D111A + G163K + H198S +
Y220F + T231R + N233C + D254S + P256T
E1C + F51V + D96E + K98I + D111A + G163K + H198S + Y220F +
T231R + N233C + D254S + P256T
E1C + G38A + F51V + D96E + K98I + D111A + G163K + H198S +
Y220F + T231R + N233C + D254S + P256T
E1C + D27R + G38R + F51V + D96E + K98I + D111A + G163K +
H198S + Y220F + T231R + N233C + D254S + P256T

In an embodiment, the lipase is a variant of a parent lipase which variant has lipase activity, has at least 60%, but less than 100% sequence identity with SEQ ID NO: 1 and comprises one or more (e.g. several) substitutions at positions corresponding to G23S, D27N, A40I, F51I, L, E56R, D57N, V60E,K, K98I, N101D, R118F, G163S, Y220F, T231R, N233R, T244E, and P256T (using SEQ ID NO: 1 for numbering). The lipase variant may comprise substitutions at positions corresponding to T231R+N233R and one or more (e.g., several) substitutions at positions corresponding to G23S, D27N, A40I, F51I, L, E56R, D57N, V60E, K, K98I, N101D, R118F, G163S, Y220F, T244E, and P256T.

In a preferred embodiment, the lipase, is a variant comprising substitutions corresponding to any of the following set of substitutions (sugin SEQ ID NO: 1 for numbering):
G23S+T231R+N233R
D27N+T231R+N233R
A40I+T231R+N233R
F51I+T231R+N233R
F51L+T231R+N233R
E56R+T231R+N233R
D57N+T231R+N233R
V60E+T231R+N233R
V60K+T231R+N233R
K98I+T231R+N233R
N101D+T231R+N233R
R118F+T231R+N233R
G163S+T231R+N233R
Y220F+T231R+N233R
T231R+N233R+T244E
T231R+N233R+P256T (using SEQ ID NO: 1 for numbering)

In an embodiment, the lipase is a lipase variant which comprises substitutions corresponding to E56R+T231R+N233R and one or more (e.g., several) substitutions at positions corresponding to G23S, D27N, A40I, F51I, L, D57N, V60E,K, K98I, N101D, R118F, G163S, Y220F, T244E, and P256T.

In an embodiment, the lipase is a lipase variant which comprises substitutions at positions corresponding to R118F+T231R+N233R and one or more (e.g., several) substitutions at positions corresponding to G23S, D27N, A40I, F51I,L, E56R, D57N, V60E,K, K98I, N101D, G163S, Y220F, T244E, and P256T.

In an embodiment, the lipase is a lipase variant which comprises substitutions at positions corresponding to E56R+R118F+T231R+N233R and one or more (e.g., several) substitutions at positions corresponding to G23S, D27N, A40I, F51I,L, D57N, V60E, K, K98I, N101D, G163S, Y220F, T244E, and P256T.

In an embodiment, the lipase is a lipase variant which comprises substitutions at positions corresponding to E56R+R118F+T231R+N233R+P256T and one or more (e.g., several) substitutions at positions corresponding to G23S, D27N, A40I, F51I,L, D57N, V60E,K, K98I, N101D, G163S, Y220F, and T244E.

In an embodiment, the lipase is a lipase variant which comprises substitutions at positions corresponding to F51I, L+E56R+R118F+T231R+N233R+P256T and one or more (e.g., several) substitutions at positions corresponding to G23S, D27N, A40I, D57N, V60E,K, K98I, N101D, G163S, Y220F, and T244E.

In an embodiment, the lipase is a lipase variant which comprises substitutions at positions corresponding to G23S+F51I, L+E56R+R118F+T231R+N233R+P256T and one or more (e.g., several) substitutions at positions corresponding to D27N, A40I, D57N, V60E,K, K98I, N101D, G163S, Y220F, and T244E.

In an embodiment, the lipase is a lipase variant which comprises substitutions at positions corresponding to D27N+F51I, L+E56R+R118F+T231R+N233R+P256T and one or more (e.g., several) substitutions at positions corresponding to G23S, A40I, D57N, V60E,K, K98I, N101D, G163S, Y220F, and T244E.

In an embodiment, the lipase is a lipase variant comprises substitutions at positions corresponding to A40I+F51I, L+E56R+R118F+T231R+N233R+P256T and one or more (e.g., several) substitutions at positions corresponding to G23S, D27N, D57N, V60E,K, K98I, N101D, G163S, Y220F, and T244E.

In an embodiment, the lipase is a lipase variant which comprises substitutions at positions corresponding to F51I, L+E56R+D57N+R118F+T231R+N233R+P256T and one or more (e.g., several) substitutions at positions corresponding to G23S, D27N, A40I, V60E,K, K98I, N101D, G163S, Y220F, and T244E.

In an embodiment, the lipase is a lipase variant which comprises substitutions at positions corresponding to F51I, L+E56R+D57N+K98I+R118F+T231R+N233R+P256T and one or more (e.g., several) substitutions at positions corresponding to G23S, D27N, A40I, V60E,K, N101D, G163S, Y220F, and T244E.

In an embodiment, the lipase is a lipase variant which comprises substitutions at positions corresponding to F51I, L+E56R+D57N+K98I+R118F+G163S+T231R+N233R+P256T and one or more (e.g., several) substitutions at positions corresponding to G23S, D27N, A40I, V60E,K, N101D, Y220F, and T244E.

In an embodiment, the lipase is a lipase variant which comprises substitutions at positions corresponding to F51I, L+E56R+D57N+K98I+R118F+G163S+T231R+N233R+T244E+P256T and one or more (e.g., several) substitutions at positions corresponding to G23S, D27N, A40I, V60E,K, N101D, and Y220F.

In an embodiment, the lipase is a lipase variant comprises substitutions at positions corresponding to F51I, L+E56R+D57N+V60E,K+K98I+R118F+T231R+N233R+P256T and one or more (e.g., several) substitutions at positions corresponding to G23S, D27N, A40I, N101D, G163S, Y220F, and T244E.

In an embodiment, the lipase is a lipase variant which comprises substitutions at positions corresponding to F51I,L+E56R+D57N+N101D+K98I+R118F+T231R+N233R+P256T and one or more (e.g., several) substitutions at positions corresponding to G23S, D27N, A40I, V60E,K, N101D, G163S, Y220F, and T244E.

In an embodiment, the lipase is a lipase variant which comprises substitutions at positions corresponding to

F51I,L+E56R+D57N+V60E,K+K98I+N101D+R118F+T231R+N233R+P256T and one or more (e.g., several) substitutions at positions corresponding to G23S, D27N, A40I, G163S, Y220F, and T244E.

In an embodiment, the lipase is a lipase variant which consists of or comprises substitutions corresponding to (using SEQ ID NO: 1 for numbering):

G23S + D27N + F51I + E56R + V60E + R118F + T231R + N233R +
P256T
G23S + D27N + A40I + F51I + E56R + K98I + N101D + R118F +
T231R + N233R + T244E + P256T
G23S + D27N + A40I + F51I + E56R + V60K + R118F + T231R +
N233R + T244E + P256T
G23S + T231R + N233R
D27N + T231R + N233R
A40I + T231R + N233R
F51I + T231R + N233R
F51L + T231R + N233R
E56R + T231R + N233R
D57N + T231R + N233R
V60E + T231R + N233R
V60K + T231R + N233R
K98I + T231R + N233R
N101D + T231R + N233R
R118F + T231R + N233R
G163S + T231R + N233R
Y220F + T231R + N233R
T231R + N233R + T244E
T231R + N233R + P256T
E56R + R118F + T231R + N233R
R118F + T231R + N233R + P256T
A40I + R118F + T231R + N233R
F51I + E56R + R118F + T231R + N233R
F51L + E56R + R118F + T231R + N233R
E56R + D57N + R118F + T231R + N233R
E56R + V60K + R118F + T231R + N233R

In an embodiment, the lipase is a variant of a parent lipase which parent lipase is selected from:
a) a polypeptide having at least 60%, at least 65%, at least 70%, at least 75%, at least 80%, at least 85%, at least 90%, at least 95% identity, at least 96%, at least 97%, at least 98%, or at least 99% or 100% sequence identity to SEQ ID NO: 1; and
b) a fragment of the polypeptide of SEQ ID NO: 1.

In an embodiment, the lipase variant has at least 60%, at least 65%, at least 70%, at least 75%, at least 80%, at least 85%, at least 90%, at least 95% identity, at least 96%, at least 97%, at least 98%, or at least 99%, but less than 100% sequence identity to SEQ ID NO: 1.

### Lipase of SEQ ID NO: 2 (TLL Variant)

In a preferred embodiment, the enzyme product of the invention or composition of the invention comprise the lipase shown in SEQ ID NO: 2 or a variant thereof.

In an embodiment, the lipase is:
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 2;
ii) a variant of a parent lipase having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 2;
iii) a fragment of the lipase in (i) or (ii) having lipase activity,
wherein the variant comprises:
(a) a substitution corresponding to:
D1E,Q; A4R; D5Q; L7Y; N8D,E,Q; K11E,Q; R24E,N,Q; N26Q; D27N,Q; A30N; N33Q; T35N; N39D,Q; A46Q; D48Q; F51I, V; L52N, E56N; N57Q; G59S; V60S,M, D62Q; D70Q; N71Q; N73S; I86F,P; N88D,Q; I90R; L93F; N94Q,R,S; D96H,I,Q,S; V98I; N101D,Q,R; S105R; R108E,Q; D111Q; D122Q; D130Q; D158Q; N162D,E; Y164S; D165Q; D167Q; A173Q; N178D; A180E; N200Q; R209Q; Q210E; F211A,N,S,T,Y; G212D,E,R; L227G, V228E,P; R231Q; R232E,Q; R233K, N,Q; T244E; N250D; I255A; A257S; L264A, V, I; and/or
(b) substitutions corresponding to:
A4E+F211V; A4E+L227G; A4E+T252A; D122N+L124S; D165N+D167S; D96N+V98S; E45N+A47S; E87K+F95Y; E87R+N94D; F211V+L227G; F211V+L264A; F211V+T252A; I238C+G246C; L227A+L264A; L227G+I269W; L264A+I269W; N250P+T252I; S105D+R108G; T123N+R125S; T252A+I269W; T252A+L264A; T252A+L264I; T252A+L264P; T252A+L264Q; T252A+L264S; T252A+L264T; T72N+K74S; V60M+L227G; and/or
(c) substitutions corresponding to:
A40N+T252A+L264A; A46N+T252A+L264A; A46N+T252A+L264A; A46R+T252A+L264A; D130H+N250P+T252I; D1A+T252A+L264A; D1C+T252A+L264A; D1F+T252A+L264A; D1G+T252A+L264A; D1H+T252A+L264A; D1L+T252A+L264A; D1M+T252A+L264A; D1G+T252A+L264A; D1R+T252A+L264A; D1W+T252A+L264A; D1Y+T252A+L264A; D5R+T252A+L264A; D62R+T252A+L264A; F10L+T252A+L264A; F10M+T252A+L264A; F211V+L264A+I269W; F211V+T252A+L264A; F51G+T252A+L264A; F51K+T252A+L264A; G106E+N250P+T252I; G65A+T252A+L264A; G65W+T252A+L264A; H198I+T252A+L264A; H198N+P256T+A257I; K74G+T252A+L264A; L12H+N250P+T252I; L227G+T252A+L264A; L75A+T252A+L264A; L75K+T252A+L264A; L75Y+T252A+L264A; L7F+T252A+L264A; N250P+T252I+I255D; N39S+T252A+L264A; N8K+T252A+L264A; N8R+T252A+L264A; N94D+T252A+L264A; Q15M+T252A+L264A; R108Q+R179E+G212E; R232N+T252A+L264A; S37H+N250P+T252I; S3R+T252A+L264A; T50H+T252A+L264A; T50L+T252A+L264A; T50M+T252A+L264A; T50W+T252A+L264A; T50Y+T252A+L264A; V228R+T252A+L264A; V63C+T252A+L264A; V63E+T252A+L264A; V63G+T252A+L264A; V63I+T252A+L264A; V63L+T252A+L264A; V63Q+T252A+L264A; V63S+T252A+L264A; A19T+T252A+L264A; A19S+T252A+L264A; K11L+T252A+L264A; A20V+T252A+L264A; A20T+T252A+L264A; S17C+T252A+L264A; 134S+T252A+L264A; T32P+T252A+L264A; N26A+T252A+L264A; N26W+T252A+L264A; N26K+T252A+L264A; S37V+T252A+L264A; S37Y+T252A+L264A; S37E+T252A+L264A; D27E+T252A+L264A; A38S+T252A+L264A; T721+T252A+L264A; T72V+T252A+L264A; V60T+T252A+L264A; L43G+T252A+L264A; N33V+T252A+L264A; N33F+T252A+L264A; N33D+T252A+L264A; P42S+T252A+L264A; A47G+T252A+L264A; A47R+T252A+L264A; G31V+T252A+L264A; A46F+T252A+L264A; A46F+T252A+L264A; A46G+T252A+L264A; A40H+T252A+L264A; A46K+T252A+L264A; D62G+T252A+L264A; D62A+T252A+L264A; F66K+T252A+L264A; A49V+T252A+L264A; T50A+T252A+L264A; F51H+T252A+L264A; A49G+T252A+L264A; V63M+T252A+L264A; F51L+T252A+L264A; T50N+T252A+L264A; V63T+T252A+L264A; F51P+T252A+L264A; A49S+T252A+L264A; A49Q+T252A+L264A; V63A+T252A+L264A; S54R+T252A+L264A; F51Y+T252A+L264A; S54D+T252A+L264A; T64S+T252A+L264A; S54C+T252A+L264A; F66N+T252A+L264A; L52W+T252A+L264A; L52T+T252A+L264A; A68V+T252A+L264A; N57S+T252A+L264A; L67Y+T252A+L264A; V69Q+T252A+L264A; S58Y+T252A+L264A; N71C+T252A+L264A; D70R+T252A+L264A; V60M+T252A+L264A; N71G+T252A+L264A; V69E+T252A+L264A; V69K+T252A+L264A; N71D+T252A+L264A; N71T+T252A+L264A; V60A+T252A+L264A; V60W+T252A+L264A; G61A+T252A+L264A; V60G+T252A+L264A; T72G+T252A+L264A; V60L+T252A+L264A; A4R+R233N+T252A; A4R+R233N+L264A; R233N+T252A+L264A; A4R+V60M+L227G; A4R+L227G+R233N; A4R+V60M+R233N; V60M+L227G+R233N; V60M+L227G+L264V; V60M+L227G+L264I; V60M+L227G+T252A; A4R+L227A+L264A; G23A+N250P+T252I; L97V+N250P+T252I; V60K+N250P+T252I; A150G+N250P+T252I; V202L+N250P+T252I; V228P+N250P+T252I; L227G+N250P+T252I; F211G+N250P+T252; V1421+N250P+T252I; V60M+L227G+V228Q; A4L+T252A+L264A; T114E+T252A+L264A; G156A+T252A+L264A; L168E+T252A+L264A; and/or
(d) substitutions corresponding to:
A4K+R231T+T252A+L264A; A4K+R232V+T252A+L264A; L227G+V228A+T252A+L264I; N250P+T252I+D254N+P256S; Q249N+N250P+N251S+T252I; L7F+L227G+T252A+L264A; T244N+G246S+N250P+T252I; T91A+N92D+D96L+V98Q; T91A+V228L+T252A+L264S; V202C+N250P+T252I+P253C; V60M+T91A+T252A+L264A; W221C+G246C+N250P+T252I; D1C+R233C+T252A+L264A; V60M+D99N+N101S+L227G; V60M+S119N+A121S+L227G; V60M+R125N+A127S+L227G; D1G+T252A+P256T+L264A; V60M+L227G+V228R+L264T; N39D+V60M+L227G+P256T; N73G+T252A+L264A; and/or
(e) substitutions corresponding to:
T91A+H198N+D254S+P256T+A257I; T91A+T252A+I255L+P256K+L264A; V60M+L227G+V228L+T252A+L264Y; V60M+L227V+V228P+T252A+L264I; V60M+T91A+L227R+T252A+L264V; N33Q+V60M+G163N+D165S+L227G; R24E+A180E+N250D+T252A+L264A; and/or V60M+T91A+L227V+T252A+L264M; and/or
(f) substitutions corresponding to:
L7F+T91A+A150G+L154V+T252A+L264A; and/or
(g) substitutions corresponding to:
D1C+V202C+R233C+I238C+G245C+T252A+P253C+L264A; and/or A4R+I90V+N94E+D96L+N101P+R233N+T252A+L264A
of the polypeptide shown as SEQ ID NO: 2.

In an embodiment the lipase variant further comprises one or more substitutions corresponding to:
A4E; A20T; P29S; A46Q; S58N; T91A; N92D; L93F,I; S105D,E,N; R179G,Q; N200R; Y220F; L227G; R231K; T244E; Q249E; T252A,S,V; N25S; A38T; R84S; N94D; V98Q; N101K; D130H; D137G; R232K; T244A,N,K; A249G,R; N250P; T252I; D254S; P256T; A257I; L264A; N94V; F95V; L97S; N101E; S105K; D129G; A134S; V187I; Q188H; R209Q; Q210D; G212S; D234R; G240D; N248D,E; Q249D,G; L264V; T267A; 1269F; A28V; V60E,I,M; V63I; E87Q; N92D; V98Q; S105G; R179K; V228L; N248K; Q249D; I255G; L264P,Y; A4Q; L7F; A46K; Y53F; V60K; E87K; Y138F; A157V; Y194F; H198I; Y213F; L227V, V228A; and/or I255L in SEQ ID NO: 2 or using SEQ ID NO: 2 for numbering.

In an embodiment, the lipase variant comprises two substitutions corresponding to: A20T+L93F; A4E+A46Q; F51I+T244E; L227G+R233N; L227G+T244E; L227G+T252A; L93I+V98I; N101D+S105D; Q210E+Q249E; R179Q+G212E; R231K+R233K; R233N+T252A; S105D+G212E; S105E+R108Q; S105N+G212D; S105N+G212E; S58N+V60S; T244E+T252A; T252A+I255A; T252S+I255A; and/or T91A+V98I in SEQ ID NO: 2 or using SEQ ID NO: 2 for numbering.

In an embodiment, the lipase comprises substitutions corresponding to:
A4R+R233N; K223Q+R232Q; Q210E+N250D; R108Q+G212E; R24Q+N250D; and/or R24Q+Q210E; in SEQ ID NO: 2 or using SEQ ID NO: 2 for numbering.

In an embodiment, the lipase variant comprises substitutions corresponding to:
A38T+D96H+D137G; A4R+T252A+L264A; D1G+T252A+L264A; D62N+T252A+L264A; D165Q+N250P+T252I; H198S+Y220F+L264A; N101K+S105N+R108E; N94Q+N250P+T252I; Q210E+T244E+Q249G; Q210E+T252A+L264A; R231K+R232K+R233K; S83T+H198S+D254S; R233N+T252A+L264A; A46Q+T252A+L264A; N39D+T252A+L264A; a+L227G; or F51I+T252A+L264A in SEQ ID NO: 2 or using SEQ ID NO: 2 for numbering.

In an embodiment, the lipase variant comprises substitutions corresponding to:
A4R+R233N+T252A+L264A; A4R+V60M+L227G+R231T; A4R+V60M+L227G+R232V; A4R+V60M+L227G+R233N; E87Q+T91A+D961+V98Q; G109R+Q210E+T244N+Q249E; L227G+R233N+T252A+L264A; L7F+Q210E+T252A+L264A; Q188H+Q210E+T252A+L264A; Q210E+L227G+T252A+L264A; Q210N+G212S+N250P+T252I; V60S+L227G+T252A+L264A; R24E+N33Q+V60M+L227G; or R24E+V228P+T252A+L264A in SEQ ID NO: 2 or using SEQ ID NO: 2 for numbering.

In an embodiment, the lipase variant comprises substitutions corresponding to:
L227G+R233N+T244E+T252A+L264A; S105N+R108Q+D129G+D137G+G212D; L7F+R24E+N39D+T252A+L264A; and/or R24E+V128A+V228E+T252A+L264A; or A20T+G163N+D165S+T252A+L264A in SEQ ID NO: 2 or using SEQ ID NO: 2 for numbering.

In an embodiment, the lipase variant comprises substitutions corresponding to:
L7F+N8K+Q210E+L227G+T252A+L264A; N8D+101K+S105G+R108Q+R179E+G212E;
N8D+R209Q+Q210E+T244N+N248K+Q249E; V60E+S83T+T91A+H198S+T252A+L264P; or V60M+T91A+Q210E+V228L+T252A+L264Y in SEQ ID NO: 2 or using SEQ ID NO: 2 for numbering.

In an embodiment, the lipase variant comprises substitutions corresponding to:
V60K+S83T+T91A+H198I+V228L+T252A+L264P; or V60M+A157V+Q210E+L227V+V228A+T252A+L264V in SEQ ID NO: 2 or using SEQ ID NO: 2 for numbering.

In an embodiment, the lipase variant comprises substitutions corresponding to:
D1E+A4Q+L7F+K11N+S37T+A46K+A133R+V142F+T170S+V202I+Q210E+L227G.

In a specific preferred embodiment, the lipase has one of the following set of substitutions corresponding to (using SEQ ID NO: 2 for numbering):

A180E
A257S
A46Q
D122Q
D130Q
D158Q
D165Q
D167Q
D1E
D1Q
D27Q
D48Q
D5Q
D70Q
F211A
F211L
F211N
F211S
F211T
186F
K11Q
L52N
N101Q
N162D
N178D
N250D
N26Q
N33Q
N39D
N39Q
N57Q
N71Q
N8D
N8E
N8Q
N94Q
N94S
Q210E
R108E
R108Q
R209Q
R233K
R24E
R24Q
T244E
V98I
Y164S
A4E + A46Q
A4E + F211V
A4E + L227G
A4E + T252A
A4R + R233N
F211V + L227G
F211V + L264A
F211V + T252A
F51I + T244E
I238C + G246C
L227A + L264A
L227G + I269W
L227G + R233N
L227G + T244E
L227G + T252A
L264A + I269W
Q210E + N250D
R233N + T252A
S105D + R108G
S105E + R108Q
S105N + G212D
S58N + V60S
T244E + T252A
T252A + I269W
T252A + L264A
T252A + L264I
T252A + L264P
T252A + L264Q
T252A + L264S
T252A + L264T
V60M + L227G
A38T + D96H + D137G
A40N + T252A + L264A
A46N + T252A + L264A
A46R + T252A + L264A
D1A + T252A + L264A
D1C + T252A + L264A
D1G + T252A + L264A
D1L + T252A + L264A
D1Q + T252A + L264A
D1Y + T252A + L264A
D5R + T252A + L264A
F10L + T252A + L264A
F10M + T252A + L264A
F211V + L264A + I269W
F211V + T252A + L264A
F211V + T252A + L264A
F211V + T252A + L264A
F51G + T252A + L264A
G65A + T252A + L264A
H198I + T252A + L264A
K74G + T252A + L264A
L75A + T252A + L264A
L75K + T252A + L264A
L75Y + T252A + L264A
L7F + T252A + L264A
L7F + T252A + L264A
N101K + S105N + R108E
N39S + T252A + L264A
N8K + T252A + L264A
N8R + T252A + L264A
N94D + T252A + L264A
Q15M + T252A + L264A
Q210E + T244E + Q249G
Q210E + T252A + L264A
Q210E + T252A + L264A
R233N + T252A + L264A
T50H + T252A + L264A
T50L + T252A + L264A
T50M + T252A + L264A
T50W + T252A + L264A
T50Y + T252A + L264A
V63C + T252A + L264A
V63E + T252A + L264A
V63L + T252A + L264A
V63S + T252A + L264A
A4K + R231T + T252A + L264A
A4K + R232V + T252A + L264A
A4R + R233N + T252A + L264A
A4R + V60M + L227G + R231T
A4R + V60M + L227G + R232V
A4R + V60M + L227G + R233N
L227G + R233N + T252A + L264A
Q188H + Q210E + T252A + L264A
Q210E + L227G + T252A + L264A
T91A + V228L + T252A + L264S
V202C + N250P + T252I + P253C
V60M + T91A + T252A + L264A
V60S + L227G + T252A + L264A
L227G + R233N + T244E + T252A + L264A
T91A + T252A + I255L + P256K + L264A
V60M + L227G + V228L + T252A + L264Y
L7F + T91A + A150G + L154V + T252A + L264A
V60K + S83T + T91A + H198I + V228L + T252A + L264P
A19S + T252A + L264A
A20V + T252A + L264A
A20T + T252A + L264A
S17C + T252A + L264A
I34S + T252A + L264A
N26A + T252A + L264A
N26K + T252A + L264A
S37V + T252A + L264A
S37Y + T252A + L264A
S37E + T252A + L264A
D27E + T252A + L264A
A38S + T252A + L264A
T72I + T252A + L264A
T72V + T252A + L264A
V60T + T252A + L264A
L43G + T252A + L264A
N33V + T252A + L264A
N33F + T252A + L264A
N33D + T252A + L264A
P42S + T252A + L264A
A47G + T252A + L264A
A47R + T252A + L264A
A46F + T252A + L264A
A46G + T252A + L264A
A46Q + T252A + L264A
A40H + T252A + L264A
A46K + T252A + L264A
N39D + T252A + L264A
D62G + T252A + L264A
V69Q + T252A + L264A
S58Y + T252A + L264A
N71C + T252A + L264A
D70R + T252A + L264A
N71G + T252A + L264A
V69E + T252A + L264A
V69K + T252A + L264A
N71D + T252A + L264A
N71T + T252A + L264A
V60M + D99N + N101S + L227G
V60M + S119N + A121S + L227G
V60M + R125N + A127S + L227G
L7F + R24E + N39D + T252A + L264A
A20T + G163N + D165S + T252A + L264A
D1G + T252A + P256T + L264A
V228P + T252A + L264A
V60M + L227G + V228R + L264T
T114E + T252A + L264A
G156A + T252A + L264A
L168E + T252A + L264A

Lipase from Absidia sp. (SEQ ID NO: 3)

In a preferred embodiment, the enzyme product of the invention or the composition of the invention comprise a lipase derived from a strain of Absidia shown in SEQ ID NO: 3 or a variant thereof. In an embodiment, the lipase is:
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 3;
ii) a variant of a parent lipase having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 3;
iii) a fragment of the lipase in i) or ii) having lipase activity; wherein the variant comprises one or more of the substitutions selected from: R131A, R131G, R131K, R131L, R131M, R131S, R131W; S152A; T176N; V247A, V247F, V247K, V247L, V247S, V247T, V247W; D255A, or D255G of SEQ ID NO: 3.

In a preferred embodiment, the lipase variant has at least 60% but less than 100% sequence identity to SEQ ID NO: 3 and comprises substitutions corresponding to the set of substitutions selected from the group consisting of:
a) N97D+T176N
b) Q49K+D255G
c) N97D+D255G
d) S152A+D255G
e) H158Q+D255G
f) S152A+H158Q+K221S
g) Q49K+T176N+D255G
h) N97D+T176N+D255G
I) S152A+T176N+D255G
j) K108A+H158Q+K221S
k) N97D+H158Q+K221S
I) N97D+R131A+D255G
m) N97D+V247A+D255G
n) T176N+K221S+V247A+D255G
o) S152A+T176N+K221S+V247G+D255G
p) S152A+T176N+V247N+D255G
q) S152A+T176N+1219N+M220D+V247P
r) N97D+S152A+T176N+V247P+D255G
s) R131A+S152A+T176N+V247P+D255G
t) N97D+S152A+T176N+V247F+D255G
u) K108A+S152A+T176N+V247F+D255G
v) R131A+S152A+T176N+V247F+D255G
w) R131A+S152A+T176N+L225V+P229S+V247F+D255G
aa) R131A+S152A+1174V+V247F+D255G
ab) K70E+R131A+S152A+T176N+V247F+D255G
ac) R131A+S152A+T176N+G206P+V247F+D255G
ad) L111S+R131A+S152A+T176N+V247F+D255G
ae) L111T+R131A+S152A+T176N+V247F+D255G
af) V101R+R131A+S152A+T176N+V247F+D255G
ag) D130R+S152A+T176N+V247F+D255G
ah) N97L+R131A+S152A+T176N+V247F+D255G
ai) R131A+S152A+T176N+V247F
aj) R131A+S152A+T176N+S223R+V247F
ak) R131A+S152A+T176N+1232E+V247F+D255G
al) R131A+S152A+T176N+1219N+V247F+D255G
am) R131A+S152A+T176N+1219E+V247F+D255G
an) N97L+V101R+R131A+S152A+T176N+V247F+D255G
ao) L111T+D130R+S152A+T176N+V247F+D255G
ap) V101R+R131A+S152A+T176N+V247F+D255G
aq) V101R+D130R+S152A+T176N+V247F+D255G
ar) R131A+S152A+T176N+A207E+V247F+D255G
as) K108V+R131A+S152A+T176N+V247F+D255G
at) K70E+D130R+R131A+S152A+T176N+A207E+V247F+D255G
au) D130R+R131A+S152A+T176N+S223R+V247F+D255G
av) V101R+R131A+S152A+T176N+S223R+L251F
aw) V101R+R131A+L144|+S152A+T176N+S223R+V247F+D255G
ba) V101R+D130R+R131A+S152A+T176N+S223R+V247F+D255G
bb) V101R+R131A+S152A+T176N+S223R+V247F+D255G
bc) V101R+R131A+S152A+T176N+G206V+S223R+V247F+D255G
bd) V101R+R131A+S152A+T176N+G206S+S223R+V247F+D255G
be) K70E+V101R+R131A+S152A+T176N+S223R+V247F+D255G
bf) D4C+V101R+R131A+S152A+T176N+S223R+N236C+V247F+D255G
bg) V101R+D130R+R131A+S152A+T176N+G206V+S223R+V247F+D255G
bh) V101R+R131A+L144|+S152A+T176N+G206V+S223R+V247F+D255G
bi) V101R+R131A+S152A+T176N+G206V+S223R+V247F+D255G
bj) V101R+R131A+S152A+T176N+G206V+S223R+L251F+D255G
bk) D4C+V101R+D130R+R131A+S152A+T176N+G206P+S223R+N236C+V247F+D255G
bl) D4C+A45V+V101R+D130R+R131A+S152A+T176N+G206V+S223R+N236C+V247F+D255G
bm) D4C+Q49V+V101R+D130R+R131A+S152A+T176N+G206V+S223R+N236C+V247F+D255G
bn) D4C+N97D+D130R+R131A+S152A+T176N+G206V+S223R+N236C+V247F+D255G
bo) D4C+V101R+R131A+S152A+T176N+G206V+S223R+N236C+V247F+D255G
bp) D4C+V101R+D130R+R131A+S152A+T176N+S223R+N236C+V247F+D255G
bq) D4C+V101R+R131A+S152A+T176N+S223R+N236C+V247F+D255G.

### Lipase of SEQ ID NO: 4

In a preferred embodiment, the enzyme product of the invention or the composition of the invention comprise a lipase of SEQ ID NO: 4.

In a preferred embodiment the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 4;

ii) a variant of a parent lipase having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 4;
iii) a fragment of the lipase in (i) or (ii) having lipase activity, wherein the variant comprises:
(a) a substitution corresponding to
D4A; I7D; K14E; T17S; G34D; R36E; R36M; R36V; R36Q; S38D; S38E; G43D; G43H; N47D; N47E; N47G; N47H; Q49T; Q49V; L57S; D60G; D60V; G681; E69M; E69T; K70D; K70H; K70Q; A89Y; V94D; V94L; N102M; G109R; Q118S; K120A; K120D; K120E; K120N; K120M; K120G; K120P; K120Q; K120S; K120V; A123E; K136G; H158E; H158Q; H161D; H161E; A162S; N163E; N163H; I174A; P177G; P177I; P177K; P177L; A178I; A178L; A178T; A178V; N181K; N181L; N181T; N181W; Y182W; V183M; 1184V; G185A; G1851; G185K; G185R; G185T; G185W; G185Y; K187G; K187L; P189A; P189L; P189M; P189N; P189Q; P189R; P189T; P189V; P189W; 1199T; 1199V; E196M; S206G; S206V; A207N; L211C; R223A; R223E; R223G; R223H; R223K; R223N; R223Q; S224T; 1232P; 232Q; T234S; D235A; 1248L; S252N; L260F; and/or
(b) substitutions corresponding to
N163E+R223N; K70E+S206G; R101V+S206V; A15E+K120Q; D130R+S206G; D130R+S206V; T2S+A15E; and/or
(c) substitutions corresponding to
R36V+V183M+R223N; N47H+K70E+S206G; N163E+R223N+S252N; N47D+K120G+R223N; G43D+N47D+K120G; K70E+H195S+S206G; K70E+L156F+S206G; A178Y+P189V+R223N; R36E+G43D+N47D; K70D+N163E+S252N; N47D+K120G+N163E; K70E+P189Q+S206G; R36T+K70E+S206G; R361+K70E+S206G; Q49T+K70E+S206G; G43D+K70E+S206G; R36K+K70E+S206G; K70E+P189M+S206G; K52A+K70E+S206G; R36M+K70E+S206G; R36E+K70E+S206G; R101V+S206V+R223S; R36V+N47D+K120G; K14A+K70E+S206G; D4C+S206G+N236C; K70E+G185L+S206G; R36Y+K70E+S206G; R36L+K70E+S206G; K70E+P189L+S206G; R36A+K70E+S206G; R101V+D130R+S206G; D4C+S206G+N236C; D4C+S206V+N236C; R36F+K70E+S206G; K70E+K120P+S206G; and/or
(d) substitutions corresponding to
N163E+G185H+R223N+S252N; N163E+N181W+R223N+S252N;
K70D+N163E+R223N+S252N; D4C+S206G+N236C+S252N; D4C+S206G+R223N+N236C; A178Y+V183M+P189V+R223N; and/or
(e) substitutions corresponding to
D4C+P189V+S206G+R223N+N236C; D4C+N163E+S206G+N236C+S252N;
D4C+N163E+S206G+R223N+N236C; D4C+A178Y+S206G+R223N+N236C;
D4C+K108A+D130R+S206V+N236C; and/or
(f) substitutions corresponding to
S1C+A8C+T17C+L225R+N230C+L254C; S1C+A8C+T17C+L225R+N230C+L254C; D4C+N97D+R101V+D130R+S206V+N236C; and/or
(g) substitutions corresponding to
S1C+A8C+T17C+|184N+L225C+N230C+L254C;
S1C+A8C+T17C+Y75F+L225C+N230C+L254C;
S1C+A8C+T17C+Q49L+L225C+N230C+L254C;
S1C+A8C+T17C+Y167F+L225C+N230C+L254C;
S1C+A8C+T17C+Y190F+L225C+N230C+L254C;
S1C+A8C+T17C+Q491+L225C+N230C+L254C;
S1C+A8C+T17C+L225C+N230C+F244N+L254C;
S1C+A8C+A15E+T17C+L225C+N230C+L254C;
S1C+A8C+T17C+A162S+L225C+N230C+L254C;
S1C+A8C+T17C+V183S+L225C+N230C+L254C;
S1C+A8C+T17C+|164L+L225C+N230C+L254C;
S1C+A8C+T17C+Y19F+L225C+N230C+L254C;
S1C+A8C+T17C+E165S+L225C+N230C+L254C;
S1C+A8C+T17C+Q49S+L225C+N230C+L254C;
S1C+A8C+T17C+K187N+L225C+N230C+L254C;
S1C+A8C+A15R+T17C+L225C+N230C+L254C; and/or
(h) substitutions corresponding to
R101V+A131R+A152S+N176T+S206G+R223S+F247V+G255D;
S1C+D4N+R6S+A8C+T17C+L225C+N230C+L254C;
R101V+A131R+A152S+N176T+S206G+R223S+F247V+G255D;
S1C+A8C+T17C+K136N+V138S+L225C+N230C+L254C;
A26C+132C+A45V+Q49K+N97D+D130R+H159K+S224R;
S1C+A8C+T17C+K70E+|184N+L225C+N230C+L254C
S1C+A8C+T17C+V76I+L225C+N230C+L254C; and/or
(i) substitutions corresponding to
S1C+A8C+T17C+H159K+H161N+N163S+L225C+N230C+L254C;
S1C+A8C+T17C+V76I+V138L+I164L+L225C+N230C+L254C; and/or
(j) substitutions corresponding to
S1C+A8C+T17C+S38T+V76I+V138L+|164L+L225C+N230C+L254C; and/or
(k) substitutions corresponding to
A8C+T17C+R36N+G43D+Q49T+K70N+K72S+K120G+S206V+R223N+L225C+L254C; and/or
(l) substitutions corresponding to
A8C+T17C+R36V+S38D+G43D+N47D+Q49N+K70N+K72S+K120G+T148V+E165S+N181W+S206V+R223H+L225C+L254C; of the polypeptide shown as SEQ ID NO: 4.
   Lipase from Geotrichum candidum (GCL 1)—SEQ ID NO: 6

In another preferred embodiment, the composition of the invention or the enzyme product of the invention comprise the lipase shown in SEQ ID NO: 6 herein (also disclosed as SEQ ID NO: 1 in WO 2022/162043, which hereby is incorporated by reference) or an analogue thereof (e.g., one disclosed in WO2022/162043).

In an embodiment, the lipase used according to the invention is:
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 6;
ii) a fragment of the lipase in i) having lipase activity.

### Other Lipases

Other lipases contemplated according to the present invention are those disclosed in the following applications: WO2019/038164, WO2019/121585, WO2019/138121, WO2019/155789, WO2019/155790, WO2019/185519, WO2019/185610, WO2019/185612, WO2019/201636, WO2019/206994, WO2019/215078, WO2019/219903, and WO2019/243312 (all hereby incorporated by reference).

### Additional Enzymes

Besides a lipase enzyme, a composition of the invention may comprise one or more additional enzymes which provide cleaning performance and/or fabric care benefits. Examples of suitable enzymes include, but are not limited to, proteases, alpha-amylases, cellulases, phospholipases, cutinases, pectinases, mannanases, pectate lyases, phosphodiesterases (PDEs), deoxyribonucleases (DNases), or mixtures thereof. A typical combination is an enzyme cocktail that may comprise e.g. a protease and lipase in conjunction with an alpha-amylase, phospholipases, cutinases, pectinases, mannanases, pectate lyases, phosphodiesterases (PDEs), deoxyribonucleases (DNases), xanthanase, dispersin, or mixtures thereof.

When present in a composition, the aforementioned additional enzymes may be present at levels from 0.00001 to 2 wt %, from 0.0001 to 1 wt % or from 0.001 to 0.5 wt % enzyme protein by weight of the composition.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

Proteases: In one aspect, a preferred additional enzyme is a protease. Suitable proteases include those of bacterial, fungal, plant, viral or animal origin e.g. vegetable or microbial origin. Proteases of microbial origin are preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V41, S9R, A15T, K27R, *36D, V68A, N76D, N87S, R, *97E, A98S, S99G,D,A, S99AD, S101G,M,R S103A, V1041, Y,N, S106A, G118V,R, H120D,N, N123S, S128L, P129Q, S130A, G160D, Y167A, R170S, A194P, G195E, V199M, V2051, L217D, N218D, M222S, A232V, K235L, Q236H, Q245R, N252K, T274A (using BPN′ numbering).

Suitable commercially available protease enzymes include those sold under the trade names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S), those sold under the tradename Maxatase®, Maxacal®, Maxapem®, Purafect®, Purafect Prime®, Preferenz™, Purafect MA®, Purafect Ox®, Purafect OxPR, Puramax®, Properase®, Effectenz™, FN2®, FN3®, FN4®, Excellase®,, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

Amylases: In one aspect, the preferred additional enzyme is an amylase. Suitable amylases may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB1296839.

Suitable amylases include amylases having SEQ ID NO: 3 in WO95/10603 or variants having 90% sequence identity to SEQ ID NO: 3 thereof. Preferred variants are described in WO94/02597, WO94/18314, WO97/43424 and SEQ ID NO: 4 of WO99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO2006/066594 and residues 36-483 of the B. licheniformis alpha-amylase shown in SEQ ID NO: 4 of WO2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO2006/066594 and residues 36-483 of SEQ ID NO: 4 are those having the substitutions:
M197T;
H156Y+A181T+N190F+A209V+Q264S; or
G48A+T49|+G107A+H156Y+A181T+N190F+I201F+A209V+Q264S.

Further amylases which are suitable are amylases having SEQ ID NO: 6 in WO99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 181 and 182 or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO08/153815, SEQ ID NO: 10 in WO01/66712 or variants thereof having 90% sequence identity to SEQ ID NO: 2 of WO08/153815 or 90% sequence identity to SEQ ID NO: 10 in WO01/66712. Preferred variants of SEQ ID NO: 10 in WO01/66712 are those having a substitution, a deletion or an insertion in one of more of the following positions: 176, 177, 178, 179, 190, 201, 207, 211 and 264.

Further suitable amylases are amylases having SEQ ID NO: 2 of WO09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:
N128C+K178L+T182G+Y305R+G475K;
N128C+K178L+T182G+F202Y+Y305R+D319T+G475K;
S125A+N128C+K178L+T182G+Y305R+G475K; or
S125A+N128C+T131I+T165I+K178L+T182G+Y305R+G475K wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Termamyl Ultra™, Fungamyl™, BAN™, Stainzyme™, Stainzyme Plus™, Amplify®, Amplify® Prime, Achieve® Choice, Achieve® Advance, Supramyl™, Natalase™, Liquozyme X and BAN™ (from Novozymes A/S), KEMZYM® AT 9000 Biozym Biotech Trading GmbH Wehlistrasse 27b A-1200 Wien Austria, and Rapidase™, Purastar™/Effectenz™, Powerase, Preferenz S100, Preferenx S110, Preferenz S210, ENZYSIZE®, OPTISIZE HT PLUS®, and PURASTAR OXAM® (Danisco/DuPont) and KAM® (Kao).

Cellulases: In one aspect, preferred enzymes include cellulases. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO89/09259.

Especially suitable cellulases are the alkaline or neutral cellulases having colour care benefits. Examples of such cellulases are cellulases described in EP0495257, EP0531372, WO96/11262, WO96/29397, WO98/08940. Other examples are cellulase variants such as those described in WO94/07998, EP0531315, U.S. Pat. Nos. 5,457,046, 5,686,593, 5,763,254, WO95/24471, WO98/12307 and PCT/DK98/00299.

Commercially available cellulases include Celluzyme™, and Carezyme™ (Novozymes A/S), Clazinase™, and Puradax HA™ (Genencor International Inc.), and KAC-500 (B)™ (Kao Corporation).

In one aspect, other preferred enzymes include microbial-derived endoglucanases exhibiting endo-beta-1,4-glucanase activity (EC3.2.1.4), including a bacterial polypeptide endogenous to a member of the genus Bacillus which has a sequence of at least 90%, 94%, 97% or 99% identity to the amino acid sequence SEQ ID NO:2 in U.S. Pat. No. 7,141,403 and mixtures thereof. Suitable endoglucanases are sold under the tradenames Celluclean® and Whitezyme® (Novozymes).

Pectate lyases, mannanases, DNases and/or PDEs: Other preferred enzymes that additionally may be comprised in the composition of the invention include pectate lyases, e.g., one sold under the tradenames Pectawash®, Pectaway®, or Xpect®; and mannanase, e.g., the one sold under the tradenames Mannaway® (Novozymes), and Purabrite® (Danisco/DuPont). Finally, the composition may also comprise a deoxyribonuclease (DNase) and/or a phosphodiesterase (PDE).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP238216.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a composition, the dye transfer inhibiting agents may be present at levels from 0.0001 to 10 wt %, from 0.01 to 5 wt % or from 0.1 to 3 wt %.

Brighteners—The compositions of the present invention can also contain additional components that may tint articles being cleaned, such as fluorescent brighteners.

The composition may comprise C.I. fluorescent brightener 260 in alpha-crystalline form having the following structure:

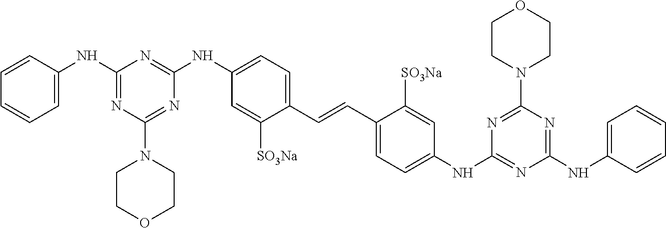

In one aspect, the brightener is a cold water soluble brightener, such as the C.I. fluorescent brightener 260 in alpha-crystalline form. In one aspect the brightener is predominantly in alpha-crystalline form, which means that typically at least 50 wt %, at least 75 wt %, at least 90 wt %, at least 99 wt %, or even substantially all, of the C.I. fluorescent brightener 260 is in alpha-crystalline form.

The brightener is typically in micronized particulate form, having a weight average primary particle size of from 3 to 30 micrometers, from 3 micrometers to 20 micrometers, or from 3 to 10 micrometers.

The composition may comprise C.I. fluorescent brightener 260 in beta-crystalline form, and the weight ratio of: (i) C.I. fluorescent brightener 260 in alpha-crystalline form, to (ii) C.I. fluorescent brightener 260 in beta-crystalline form may be at least 0.1, or at least 0.6. BE680847 relates to a process for making C.I fluorescent brightener 260 in alpha-crystalline form.

Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982). Specific nonlimiting examples of optical brighteners which are useful in the present compositions are those identified in U.S. Pat. Nos. 4,790,856 and 3,646,015.

A further suitable brightener has the structure below:

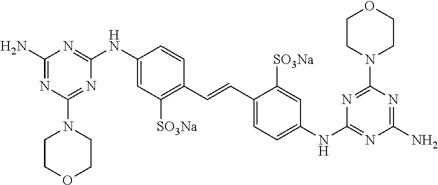

Suitable fluorescent brightener levels include lower levels of from 0.01 wt %, from 0.05 wt %, from 0.1 wt % or from 0.2 wt % to upper levels of 0.5 wt % or 0.75 wt %.

In one aspect the brightener may be loaded onto a clay to form a particle. Silicate salts—The compositions of the present invention can also contain silicate salts, such as sodium or potassium silicate. The composition may comprise of from 0 wt % to less than 10 wt % silicate salt, to 9 wt %, or to 8 wt %, or to 7 wt %, or to 6 wt %, or to 5 wt %, or to 4 wt %, or to 3 wt %, or even to 2 wt %, and from above 0 wt %, or from 0.5 wt %, or from 1 wt % silicate salt. A suitable silicate salt is sodium silicate.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzyme Stabilizers—Enzymes for use in compositions can be stabilized by various techniques. The enzymes employed herein can be stabilized by the presence of water-soluble sources of calcium and/or magnesium ions. Examples of conventional stabilizing agents are, e.g. a polyol such as propylene glycol or glycerol, a sugar or sugar alcohol, a peptide aldehyde, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708 In case of aqueous compositions comprising protease, a reversible protease inhibitor, such as a boron compound including borate, 4-formyl phenylboronic acid, phenylboronic acid and derivatives thereof, or compounds such as calcium formate, sodium formate and 1,2-propane diol can be added to further improve stability. The peptide aldehyde may be of the formula B₂—B₁—B₀—R wherein: R is hydrogen, CH₃, CX₃, CHX₂, or CH₂X, wherein X is a halogen atom; Bo is a phenylalanine residue with an OH substituent at the p-position and/or at the m-position; B₁ is a single amino acid residue; and B₂ consists of one or more amino acid residues, optionally comprising an N-terminal protection group. Preferred peptide aldehydes include but are not limited to: Z-RAY-H, Ac-GAY-H, Z-GAY-H, Z-GAL-H, Z-GAF-H, Z-GAV-H, Z-RVY-H, Z-LVY-H, AC-LGAY-H, Ac-FGAY-H, AC-YGAY-H, Ac-FGVY-H or Ac-WLVY-H, where Z is benzyloxycarbonyl and Ac is acetyl.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Structurant/Thickeners—Structured liquids can either be internally structured, whereby the structure is formed by primary ingredients (e.g. surfactant material) and/or externally structured by providing a three-dimensional matrix structure using secondary ingredients (e.g. polymers, clay and/or silicate material). The composition may comprise a structurant, from 0.01 to 5 wt %, or from 0.1 to 2.0 wt %. The structurant is typically selected from the group consisting of diglycerides and triglycerides, ethylene glycol distearate, microcrystalline cellulose, cellulose-based materials, microfiber cellulose, hydrophobically modified alkali-swellable emulsions such as Polygel W30 (3VSigma), biopolymers, xanthan gum, gellan gum, and mixtures thereof. A suitable structurant includes hydrogenated castor oil, and non-ethoxylated derivatives thereof. A suitable structurant is disclosed in U.S. Pat. No. 6,855,680. Such structurants have a thread-like structuring system having a range of aspect ratios. Other suitable structurants and the processes for making them are described in WO10/034736.

Conditioning Agents—The composition of the present invention may include a high melting point fatty compound. The high melting point fatty compound useful herein has a melting point of 25° C. or higher and is selected from the group consisting of fatty alcohols, fatty acids, fatty alcohol derivatives, fatty acid derivatives, and mixtures thereof. Such compounds of low melting point are not intended to be included in this section. Non-limiting examples of the high melting point compounds are found in International Cosmetic Ingredient Dictionary, Fifth Edition, 1993, and CTFA Cosmetic Ingredient Handbook, Second Edition, 1992.

The high melting point fatty compound is included in the composition at a level of from 0.1 to 40 wt %, from 1 to 30 wt %, from 1.5 to 16 wt %, from 1.5 to 8 wt % in view of providing improved conditioning benefits such as slippery feel during the application to wet hair, softness and moisturized feel on dry hair.

The compositions of the present invention may contain a cationic polymer. Concentrations of the cationic polymer in the composition typically range from 0.05 to 3 wt %, from 0.075 to 2.0 wt %, or from 0.1 to 1.0 wt %. Suitable cationic polymers will have cationic charge densities of at least 0.5 meq/gm, at least 0.9 meq/gm, at least 1.2 meq/gm, at least 1.5 meq/gm, or less than 7 meq/gm, and less than 5 meq/gm, at the pH of intended use of the composition, which pH will generally range from pH3 to pH9, or between pH4 and pH8. Herein, “cationic charge density” of a polymer refers to the ratio of the number of positive charges on the polymer to the molecular weight of the polymer. The average molecular weight of such suitable cationic polymers will generally be between 10,000 and 10 million, between 50,000 and 5 million, or between 100,000 and 3 million.

Suitable cationic polymers for use in the compositions of the present invention contain cationic nitrogen-containing moieties such as quaternary ammonium or cationic protonated amino moieties. Any anionic counterions can be used in association with the cationic polymers so long as the polymers remain soluble in water, in the composition, or in a coacervate phase of the composition, and so long as the counterions are physically and chemically compatible with the essential components of the composition or do not otherwise unduly impair composition performance, stability or aesthetics. Nonlimiting examples of such counterions include halides (e.g., chloride, fluoride, bromide, iodide), sulfate and methylsulfate.

Nonlimiting examples of such polymers are described in the CTFA Cosmetic Ingredient Dictionary, 3rd edition, edited by Estrin, Crosley, and Haynes, (The Cosmetic, Toiletry, and Fragrance Association, Inc., Washington, D.C. (1982)).

Other suitable cationic polymers for use in the composition include polysaccharide polymers, cationic guar gum derivatives, quaternary nitrogen-containing cellulose ethers, synthetic polymers, copolymers of etherified cellulose, guar and starch. When used, the cationic polymers herein are either soluble in the composition or are soluble in a complex coacervate phase in the composition formed by the cationic polymer and the anionic, amphoteric and/or zwitterionic surfactant component described hereinbefore. Complex coacervates of the cationic polymer can also be formed with other charged materials in the composition. Suitable cationic polymers are described in U.S. Pat. Nos. 3,962,418; 3,958,581; and US2007/0207109.

The composition of the present invention may include a nonionic polymer as a conditioning agent. Polyalkylene glycols having a molecular weight of more than 1000 are useful herein. Useful are those having the following general formula:

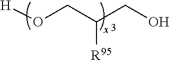

wherein R⁹⁵ is selected from the group consisting of H, methyl, and mixtures thereof. Conditioning agents, and in particular silicones, may be included in the composition. The conditioning agents useful in the compositions of the present invention typically comprise a water insoluble, water dispersible, non-volatile, liquid that forms emulsified, liquid particles. Suitable conditioning agents for use in the composition are those conditioning agents characterized generally as silicones (e.g., silicone oils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. Such conditioning agents should be physically and chemically compatible with the essential components of the composition, and should not otherwise unduly impair composition stability, aesthetics or performance.

The concentration of the conditioning agent in the composition should be sufficient to provide the desired conditioning benefits. Such concentration can vary with the conditioning agent, the conditioning performance desired, the average size of the conditioning agent particles, the type and concentration of other components, and other like factors.

The concentration of the silicone conditioning agent typically ranges from 0.01 to 10 wt %.

Non-limiting examples of suitable silicone conditioning agents, and optional suspending agents for the silicone, are described in U.S. Reissue Pat. No. 34,584; U.S. Pat. Nos. 5,104,646; 5,106,609; 4,152,416; 2,826,551; 3,964,500; 4,364,837; 6,607,717; 6,482,969; 5,807,956; 5,981,681; 6,207,782; 7,465,439; 7,041,767; 7,217,777; US2007/0286837A1; US2005/0048549A1; US2007/0041929A1; GB849433; DE10036533, which are all incorporated herein by reference; Chemistry and Technology of Silicones, New York: Academic Press (1968); General Electric Silicone Rubber Product Data Sheets SE 30, SE 33, SE 54 and SE 76; Silicon Compounds, Petrarch Systems, Inc. (1984); and in Encyclopedia of Polymer Science and Engineering, vol. 15, 2d ed., pp 204-308, John Wiley & Sons, Inc. (1989).

The compositions of the present invention may also comprise from 0.05 to 3 wt % of at least one organic conditioning oil as the conditioning agent, either alone or in combination with other conditioning agents, such as the silicones (described herein). Suitable conditioning oils include hydrocarbon oils, polyolefins, and fatty esters. Also suitable for use in the compositions herein are the conditioning agents described in U.S. Pat. Nos. 5,674,478 and 5,750,122 or in U.S. Pat. Nos. 4,529,586; 4,507,280; 4,663,158; 4,197,865; 4,217,914; 4,381,919; and 4,422,853.

Hygiene and malodour—The compositions of the present invention may also comprise one or more of thymol, quaternary ammonium salts such as Bardac® and zinc complexes thereof, silver and silver compounds, especially those designed to slowly release Ag⁺ or nano-silver dispersions.

Probiotics—The compositions may comprise probiotics such as those described in WO09/043709.

Suds Boosters—If high sudsing is desired, suds boosters such as the C₁₀-C₁₆ alkanolamides or C₁₀-C₁₄ alkyl sulphates can be incorporated into the compositions, typically at 1 to 10 wt % levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, water-soluble magnesium and/or calcium salts such as MgCl₂, MgSO₄, CaCl₂), CaSO₄ and the like, can be added at levels of, typically, 0.1 to 2 wt %, to provide additional suds and to enhance grease removal performance.

Suds Suppressors—Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574, and in front-loading-style washing machines. A wide variety of materials may be used as suds suppressors, and suds suppressors are well known to those skilled in the art. See e.g. Kirk Othmer Encyclopedia of Chemical Technology, Third Edition, Volume 7, p. 430-447 (John Wiley & Sons, Inc., 1979). Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols. Suds supressors are described in U.S. Pat. Nos. 2,954,347; 4,265,779; 4,265,779; 3,455,839; 3,933,672; 4,652,392; 4,978,471; 4,983,316; 5,288,431; 4,639,489; 4,749,740; 4,798,679; 4,075,118; EP89307851.9; EP150872; and DOS 2,124,526.

For any detergent compositions to be used in automatic laundry washing machines, suds should not form to the extent that they overflow the washing machine. Suds suppressors, when utilized, are preferably present in a “suds suppressing amount. By “suds suppressing amount” is meant that the formulator of the composition can select an amount of this suds controlling agent that will sufficiently control the suds to result in a low-sudsing laundry detergent for use in automatic laundry washing machines.

The compositions herein will generally comprise from 0 to 10 wt % of suds suppressor. When utilized as suds suppressors, monocarboxylic fatty acids, and salts therein, will be present typically in amounts up to 5 wt %. Preferably, from 0.5 to 3 wt % of fatty monocarboxylate suds suppressor is utilized. Silicone suds suppressors are typically utilized in amounts up to 2.0 wt %, although higher amounts may be used. Monostearyl phosphate suds suppressors are generally utilized in amounts ranging from 0.1 to 2 wt %. Hydrocarbon suds suppressors are typically utilized in amounts ranging from 0.01 to 5.0 wt %, although higher levels can be used. The alcohol suds suppressors are typically used at 0.2 to 3 wt %.

The compositions herein may have a cleaning activity over a broad range of pH. In certain embodiments the compositions have cleaning activity from pH4 to pH11.5. In other embodiments, the compositions are active from pH6 to pH11, from pH7 to pH11, from pH8 to pH11, from pH9 to pH11, or from pH10 to pH11.5.

The compositions herein may have cleaning activity over a wide range of temperatures, e.g., from 10° C. or lower to 90° C. Preferably the temperature will be below 50° C. or 40° C. or even 30° C. In certain embodiments, the optimum temperature range for the compositions is from 10° C. to 20° C., from 15° C. to 25° C., from 15° C. to 30° C., from 20° C. to 30° C., from 25° C. to 35° C., from 30° C. to 40° C., from 35° C. to 45° C., or from 40° C. to 50° C.

### Booster Compounds

According to the present invention the detergent composition, besides comprising a surfactant or surfactant system and a lipase, also comprises a booster.

In an embodiment according to the invention, the booster is an alkoxylated polyethyleneimine.

In a preferred embodiment the booster is an ethoxylated and propoxylated polyethyleneimine.

In a preferred embodiment, the ethoxylated and propoxylated polyethyleneimine booster has the following formula:

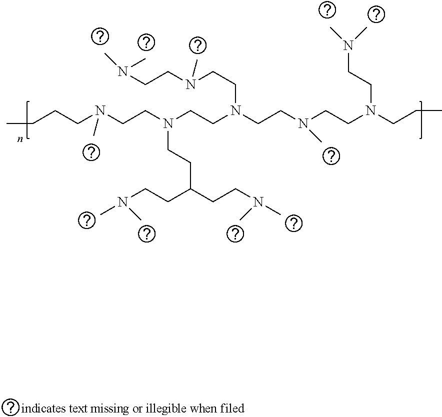

In a specific preferred embodiment, the booster is the commercial product LUPASOL PN 80 from BASF.

In another embodiment, the booster is an alkoxylated polyetheramine.

In a preferred embodiment the booster is an ethoxylated and propoxylated polyetheramine.

In another embodiment, the booster is a guanidine hydrochloride:

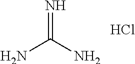

In another embodiment the booster is a rhamnolipid.

In an embodiment, the rhamnolipid has the formula:

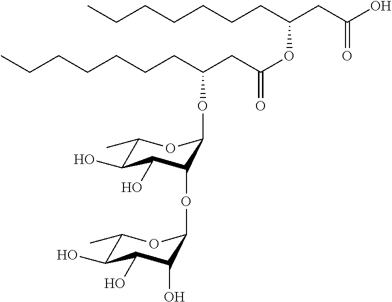

In an embodiment, the rhamnolipid may be produced by Pseudomonas aeruginosa, amongst other organisms, frequently cited as bacterial surfactants. They have a glycosyl head group, in this case a rhamnose moiety, and a 3-(hydroxyalkanoyloxy) alkanoic acid (HAA) fatty acid tail, such as 3-hydroxydecanoic acid. IUPAC Name: 3-[3-[(2R,3R,4R,5R,6S)-4,5-dihydroxy-6-methyl-3-[(2S,3R,4R,5R,6S)-3,4,5-trihydroxy-6-methyloxan-2-yl]oxyoxan-2-yl]oxydecanoyloxy]decanoic acid.

The rhamnolipids may be in the form of mono-rhamnolipid or di-rhamnolipid, which consist of one or two rhamnose groups respectively, wherein the length of the chain may vary: m,n being 4 to 8.

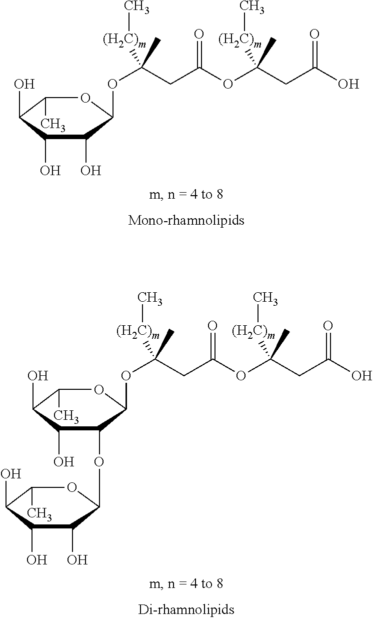

### (Appl Microbiol Biotechnol (2005) 68: 718-725).

In the context of the present invention the term “rhamnolipid” includes mono-rhamnolipid or di-rhamnolipid, mixtures thereof and varying chain length as well as salts of rhamnolipid.

### Form of the Composition

The composition of the invention is for use in laundry cleaning or washing methods. The composition of the invention is in particular a liquid detergent composition but may also be solid or powder composition.

In one aspect the invention relates to a composition, wherein the form of the composition is selected from the group consisting of a regular, compact or concentrated liquid; a gel; a paste; a soap bar; a regular or a compacted powder; a granulated solid; a homogenous or a multilayer tablet with two or more layers (same or different phases); a pouch having one or more compartments; a single or a multi-compartment unit dose form; or any combination thereof.

The form of the composition may separate the components physically from each other in compartments such as e.g. water dissolvable pouches or in different layers of tablets. Thereby negative storage interaction between components can be avoided. Different dissolution profiles of each of the compartments can also give rise to delayed dissolution of selected components in the wash solution.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water-soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (US2009/0011970 A1).

Water-Soluble Film—The compositions of the present invention may also be encapsulated within a water-soluble film. Preferred film materials are preferably polymeric materials. The film material can e.g. be obtained by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and acrylate water-soluble copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, e.g. a PVA polymer, is at least 60 wt %. The polymer can have any weight average molecular weight, preferably from about 1.000 to 1.000.000, from about 10.000 to 300.000, from about 20.000 to 150.000. Mixtures of polymers can also be used as the pouch material.

Naturally, different film material and/or films of different thickness may be employed in making the compartments of the present invention. A benefit in selecting different films is that the resulting compartments may exhibit different solubility or release characteristics.

Preferred film materials are PVA films known under the MonoSol trade reference M8630, M8900, H8779 and those described in U.S. Pat. Nos. 6,166,117 and 6,787,512 and PVA films of corresponding solubility and deformability characteristics.

The film material herein can also comprise one or more additive ingredients. For example, it can be beneficial to add plasticisers, e.g. glycerol, ethylene glycol, diethyleneglycol, propylene glycol, sorbitol and mixtures thereof. Other additives include functional detergent additives to be delivered to the wash water, e.g. organic polymeric dispersants, etc.

In a preferred embodiment, the parent lipase is a Thermomyces lanuginosus lipase (TLL), e.g., in particular the lipase shown in SEQ ID NO: 1.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen und Zellkulturen GmbH (DSMZ), Centraalbureau Voor Schimmelcultures (CBS), and Agricultural Research Service Patent Culture Collection, Northern Regional Research Center (NRRL).

The parent lipase may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding a parent may then be obtained by similarly screening a genomic DNA or cDNA library of another microorganism or mixed DNA sample. Once a polynucleotide encoding a parent has been detected with the probe(s), the polynucleotide can be isolated or cloned by utilizing techniques that are known to those of ordinary skill in the art (see, e.g., Sambrook et al., 1989, supra).

### Enzyme Product

In an aspect, the invention relates to enzyme products comprising:
(a) a lipase; and
(b) one or more boosters selected from the group of:
   i) alkoxylated polyethyleneimine, in particular ethoxylated and propoxylated polyethyleneimine;
   ii) alkoxylated polyetheramine, in particular ethoxylated and propoxylated polyetheramine;
   iii) guanidine hydrochloride; and
   iv) rhamnolipids.

An enzyme product of the invention may be incorporated in a detergent composition of the invention. The enzyme product of the invention may be formulated in any suitable way and may, in particular be in the form of a liquid or solid formation.

### Liquid Enzyme Product Formulations

The enzyme product of the invention may be formulated as a liquid enzyme formulation, which is generally a pourable composition, though it may also have a high viscosity. The physical appearance and properties of a liquid enzyme product formulation may vary a lot—for example, they may have different viscosities (gel to water-like), be colored, not colored, clear, hazy, and even with solid particles like in slurries and suspensions. The minimum ingredients are the lipase, booster and a solvent system to make it a liquid. In addition to the lipase, the liquid enzyme formulation may also comprise other enzyme activities, such as protease, amylase, lipase, cellulase, and/or nuclease (e.g., DNase, RNase) activities.

The solvent system may comprise water, polyols (such as glycerol, (mono, di, or tri) propylene glycol, (mono, di, or tri) ethylene glycol, sugar alcohol (e.g. sorbitol, mannitol, erythritol, dulcitol, inositol, xylitol or adonitol), polypropylene glycol, and/or polyethylene glycol), ethanol, sugars, and salts. Usually the solvent system also includes a preservation agent and/or other stabilizing agents.

A liquid enzyme product formulation may be prepared by mixing a solvent system and an enzyme concentrate with a desired degree of purity (or enzyme particles to obtain a slurry/suspension).

In an embodiment, the liquid enzyme product composition comprises:
(a) at least 0.01% w/w lipase,
(b) one or more boosters,
(c) at least 0.5% w/w polyol,
(d) water, and
(e) optionally a preservation agent.

The lipase in the liquid composition of the invention may be stabilized using conventional stabilizing agents. Examples of stabilizing agents include, but are not limited to, sugars like glucose, fructose, sucrose, or trehalose; addition of salt to increase the ionic strength; divalent cations (e.g., Ca2+ or Mg2+); and enzyme inhibitors, enzyme substrates, or various polymers (e.g., PVP). Selecting the optimal pH for the formulation may be very important for enzyme stability. The optimal pH depends on the specific enzyme but is typically in the range of pH 4-9. In some cases, surfactants like nonionic surfactant (e.g., alcohol ethoxylates) can improve the physical stability of the enzyme formulations.

One embodiment of the invention relates to a composition comprising an enzyme product of the invention, further comprising:
(i) a polyol, preferably selected from glycerol, (mono, di, or tri) propylene glycol, (mono, di, or tri) ethylene glycol, polyethylene glycol, sugar alcohols, sorbitol, mannitol, erythritol, dulcitol, inositol, xylitol and adonitol;
(ii) optionally an additional enzyme, preferably selected from protease and amylase,
(iii) optionally a surfactant, preferably selected from anionic and nonionic surfactants,
(iv) optionally a divalent cation, polymer, or enzyme inhibitor;
(v) optionally having a pH in the range of pH 4-9; and
(vi) water.

Slurries or dispersions of enzymes are typically prepared by dispersing small particles of enzymes (e.g., spray-dried particles) in a liquid medium in which the enzyme is sparingly soluble, e.g., a liquid nonionic surfactant or a liquid polyethylene glycol. Powder can also be added to aqueous systems in an amount so not all go into solution (above the solubility limit). Another format is crystal suspensions which can also be aqueous liquids (see for example WO2019/002356). Another way to prepare such dispersion is by preparing water-in-oil emulsions, where the enzyme is in the water phase, and evaporate the water from the droplets. Such slurries/suspension can be physically stabilized (to reduce or avoid sedimentation) by addition of rheology modifiers, such as fumed silica or xanthan gum, typically to get a shear thinning rheology.

### Solid/Granular Enzyme Formulations

The enzyme product of the invention may also be formulated as a solid/granular enzyme formulation. Non-dusting granulates may be produced, e.g. as disclosed in U.S. Pat. Nos. 4,106,991 and 4,661,452, and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The enzyme product of the invention may be formulated as a granule for example as a co-granule that combines one or more enzymes or benefit agents (such as MnTACN or other bleaching components). Examples of such additional enzymes include proteases, amylases, lipases, cellulases, and/or nucleases (e.g., DNase, RNase). Each enzyme will then be present in more granules securing a more uniform distribution of enzymes in the detergent. This also reduces the physical segregation of different enzymes due to different particle sizes. Methods for producing multi-enzyme co-granulate for the detergent industry are disclosed in the IP.com disclosure IPCOM000200739D.

An embodiment of the invention relates to an enzyme product granule/particle comprising a lipase and a booster selected from the group of i) alkoxylated polyethyleneimine, in particular ethoxylated or propoxylated polyethyleneimine; ii) alkoxylated polyetheramine, in particular ethoxylated and propoxylated polyetheramine; iii) guanidine hydrochloride; and iv) rhamnolipid.

The granule is composed of a core, and optionally one or more coatings (outer layers) surrounding the core. Typically, the granule/particle size, measured as equivalent spherical diameter (volume based average particle size), of the granule is 20-2000 μm, particularly 50-1500 μm, 100-1500 μm or 250-1200 μm.

The core may include additional materials such as fillers, fibre materials (cellulose or synthetic fibres), stabilizing agents, solubilising agents, suspension agents, viscosity regulating agents, light spheres, plasticizers, salts, lubricants and fragrances. The core may include binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating. The core may have a diameter of 20-2000 μm, particularly 50-1500 μm, 100-1500 μm or 250-1200 μm. The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation. Methods for preparing the core can be found in Handbook of Powder Technology; Particle size enlargement by C. E. Capes; Volume 1; 1980; Elsevier. These methods are well-known in the art and have also been described in international patent application WO2015/028567, pages 3-5, which is incorporated by reference.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

Such coatings are well-known in the art, and have earlier been described in, for example, WO00/01793, WO2001/025412, and WO2015/028567, which are incorporated by reference.

In one aspect, the present invention provides a granule, which comprises:
(a) a core comprising at least lipase; and
(b) optionally a (salt) coating consisting of one or more layer(s) surrounding the core.

Another aspect of the invention relates to a layered granule, comprising:
(a) a (non-enzymatic) core;
(b) a coating surrounding the core, wherein the coating comprises an enzyme; and
(c) optionally a (salt) coating consisting of one or more layer(s) surrounding the enzyme containing coating.

### Encapsulated Enzyme Formulations

The enzyme product of the invention may also be formulated as an encapsulated enzyme formulation (an ‘encapsulate’). This is particularly useful for separating the enzyme from other ingredients when the enzyme is added into, for example, a (liquid) cleaning composition, such as the detergent compositions described below.

Physical separation can be used to solve incompatibility between the enzyme(s) and other components. Incompatibility can arise if the other components are either reactive against the enzyme, or if the other components are substrates of the enzyme. Other enzymes can be substrates of proteases.

The enzyme may be encapsulated in a matrix, preferably a water-soluble or water dispersible matrix (e.g., water-soluble polymer particles), for example as described in WO 2016/023685. An example of a water-soluble polymeric matrix is a matrix composition comprising polyvinyl alcohol. Such compositions are also used for encapsulating detergent compositions in unit-dose formats.

The enzyme may also be encapsulated in core-shell microcapsules, for example as described in WO 2015/144784, or as described in the IP.com disclosure IPCOM000239419D.

Such core-shell capsules can be prepared using a number of technologies known in the art, e.g., by interfacial polymerization using either a water-in-oil or an oil-in-water emulsion, where polymers are crosslinked at the surface of the droplets in the emulsion (the interface between water and oil), thus forming a wall/membrane around each droplet/capsule.

### Purity of Enzyme in Formulations

The enzyme used in the above-mentioned enzyme product formulations may be purified to any desired degree of purity. This includes high levels of purification, as achieved for example by using methods of crystallization—but also none or low levels of purification, as achieved for example by using crude fermentation broth, as described in WO 2001/025411, or in WO 2009/152176.

The present invention is further described by the following examples that should not be construed as limiting the scope of the invention.

### The Present Invention is Described in the Following Paragraphs:

1. A detergent composition comprising:
(a) a surfactant or surfactant system;
(b) a lipase; and
(c) one or more boosters selected from the group of:
   i) alkoxylated polyethyleneimine, in particular ethoxylated and propoxylated polyethyleneimine;
   ii) alkoxylated polyetheramine, in particular ethoxylated and propoxylated polyetheramine;
   iii) guanidine hydrochloride; and
   iv) rhamnolipid.

2. The composition of paragraph 1, wherein the composition comprises lipase, an alkoxylated polyethyleneimine, such as ethoxylated and propoxylated polyethylenimine, and guanidine hydrochloride.

3. The composition of any one of paragraphs 1-2, wherein the surfactant(s) is (are) present at a level of from 0.1 to 60 wt %, from 0.2 to 40 wt %, from 0.5 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 3 to 20 wt %, from 3 to 10 wt %, from 8 to 12 wt %, from 10 to 12 wt %, from 20 to 25 wt % or from 25-60 wt %.

4. The composition of any one of paragraphs 1-3, wherein the composition comprising a surfactant or surfactant system wherein the surfactant is selected from nonionic surfactants, anionic surfactants, cationic surfactants, ampholytic surfactants, zwitterionic surfactants, semi-polar nonionic surfactants and mixtures thereof.

5. The composition of any one of paragraphs 1-4, wherein the composition comprises one or more anionic surfactant and/or one or more nonionic surfactant.

6. The composition of any one of paragraphs 1-5, wherein the composition comprises one or more anionic surfactants, preferably linear alkylbenzenesulfonic acid (LAS), alcohol ethersulfate (AEOS) and/or alkyl sulfate (AS), in particular sodium lauryl sulfate (SLS).

7. The composition of any one of paragraphs 1-6, wherein the composition comprises one or more non-ionic surfactants, preferably alcohol ethoxylate (AEO), in particular linear alcohol (C12-15) ethoxylate.

8. The composition of any one of paragraphs 1-7, wherein the composition comprises one or more anionic surfactants and one or more nonionic surfactants.

9. The composition of any one of paragraphs 1-8, wherein the composition comprises the anionic surfactants linear alkylbenzenesulfonic acid (LAS) and a nonionic surfactant alcohol ethoxylate (AEO).

10. The composition of any one of paragraphs 1-9, wherein the composition further comprises one or more components selected from the group of builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments.

11. The composition of any one of paragraphs 1-10, wherein the composition gives improved fat removal under wash compared to when no booster(s) is (are) present, such as wherein
the fat removal under wash is at least 5%, at least 10%, at least 15%, at least 20%, at least 30%, at least 40%, at least 50%, preferably at least 55%, more preferably at least 60%, even more preferably 65%, especially at least 70% of the stain when using the test described in Examples 1-3 or 4, respectively or the fat removal under wash is at least 30%, at least 40%, at least 50%, at least 55%, more preferably at least 60%, even more preferably at least 65%, especially at least 70%, such as between 30 and 70%, such as between 40% and 70%, such as between 50% and 70%, such as between 60% and 70%, such as between 30% and 60%, such as between 40% and 60%, such as 50% and 60%, such as 30% and 50%, such as 40% and 50%, of the fat stain when using the test described in Examples 1-3 (i.e., detergent comprising LAS), or
the fat removal under wash is at least 5%, at least 10%, at least 15%, at least 20%, at least 30%, at least 40%, at least 50%, such as between 5 and 50%, such as between 5% and 40%, such as between 5% and 30%, such as between 5% and 20%, such as between 5% and 10% of the fat stain when using the test described in Example 4 (i.e., detergent without LAS), or
the fat removal under wash is at least 5%, at least 10%, at least 15%, at least 20%, at least 30%, at least 40%, at least 50%, preferably at least 55%, more preferably at least 60%, even more preferably 65%, especially at least 70% of the stain when using the test in Examples 1-3 or 4, respectively.

12. The composition of any one of paragraphs 1-11, wherein the composition is formulated as a regular, compact or concentrated liquid; a gel; a paste; a soap bar; a regular or a compacted powder; a granulated solid; a homogenous or a multilayer tablet with two or more layers (same or different phases); a pouch having one or more compartments; a single or a multi-compartment unit dose form; or any combination thereof.

13. The composition of any one of paragraphs 1-12, wherein the lipase is of microbial origin, in particular of fungal or bacterial origin.

14. The composition of any one of paragraphs 1-13, wherein the composition comprises a fungal lipase derived from a strain of Thermomyces lanuginosus lipase (synonym Humicola lanuginosa), in particular SEQ ID NOs: 1, 2 and 5.

15. The composition of any of paragraphs 1-14, wherein the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1;
ii) a variant of a parent lipase having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 1;
iii) a fragment of the lipase in (i) or (ii) having lipase activity.

16. The composition of any one of paragraph 1-15, wherein the lipase is a variant comprises substitutions at positions corresponding to T231R+N233R and optionally at least one or more (e.g., several) of D96E, D111A, D254S, G163K, P256T, G91T and G38A of SEQ ID NO: 1.

17. The composition of any one of paragraphs 1-16, wherein the lipase is a variant of a parent lipase, wherein the variant has lipase activity, has at least 60%, at least 65%, at least 70%, at least 75%, at least 80%, at least 85%, at least 90%, at least 95%, at least 96%, at least 97%, at least 98%, at least 99%, but less than 100% sequence identity with SEQ ID NO: 1, and comprises substitutions at positions corresponding to T231R+N233R and at least one or more (e.g., several) of D96E, D111A, D254S, G163K, P256T, G91T and G38A of SEQ ID NO: 1 selected from the group of:
a. D96E+T231R+N233R;
b. N33Q+D96E+T231R+N233R;
c. N33Q+D111A+T231R+N233R;
d. N33Q+T231R+N233R+P256T;
e. N33Q+G38A+G91T+G163K+T231R+N233R+D254S;
f. N33Q+G38A+G91T+D96E+D111A+G163K+T231R+N233R+D254S+P256T;
g. D27R+N33Q+G38A+D96E+D111A+G163K+T231R+N233R+D254S+P256T;
h. D27R+N33Q+G38A+G91T+D96E+D111A+G163K+T231R+N233R+P256T;
i. D27R+N33Q+G38A+G91T+D96E+D111A+G163K+T231R+N233R+D254S;
j. D27R+G38A+G91T+D96E+D111A+G163K+T231R+N233R+D254S+P256T;
k. D96E+T231R+N233R+D254S;
l. T231R+N233R+D254S+P256T;
m. G163K+T231R+N233R+D254S;
n. D27R+N33Q+G38A+G91T+D96E+G163K+T231R+N233R+D254S+P256T;
o. D27R+G91T+D96E+D111A+G163K+T231R+N233R+D254S+P256T;
p. D96E+G163K+T231R+N233R+D254S;
q. D27R+G163K+T231R+N233R+D254S;
r. D27R+G38A+G91T+D96E+D111A+G163K+T231R+N233R+D254S;
S. D27R+G38A+G91T+D96E+G163K+T231R+N233R+D254S+P256T;
t. D27R+G38A+D96E+D111A+G163K+T231R+N233R+D254S+P256T;
u. D27R+D96E+G163K+T231R+N233R+D254S;
V. D27R+D96E+D111A+G163K+T231R+N233R+D254S+P256T;
w. D27R+G38A+D96E+G163K+T231R+N233R+D254S+P256T
x. D111A+G163K+T231R+N233R+D254S+P256T;
y. D111A+T231R+N233R;
z. D111A+T231R+N233R+D254S+P256T;
aa. D27R+D96E+D111A+G163K+T231R+N233R;
bb. D27R+D96E+D111A+T231R+N233R;
cc. D27R+N33Q+G38A+D96E+D111A+T231R+N233R+D254S+P256T;
dd. D27R+G38A+D96E+D111A+G163K+E210Q+T231R+N233R+D254S+P256T;
ee. D27R+T231R+N233R+D254S+P256T;
ff. D96E+D111A+G163K+T231R+N233R;
gg. D96E+D111A+G163K+T231R+N233R+D254S+P256T;
hh. D96E+D111A+G163K+T231R+N233R+P256T;
ii. D96E+D111A+T231R+N233R;
j. D96E+D111A+T231R+N233R+D254S;
kk. D96E+D111A+T231R+N233R+D254S+P256T
ll. D96E+D111A+T231R+N233R+P256T;
mm. D96E+G163K+T231R+N233R+D254S+P256T;
nn. D96E+T231R+N233R+D254S+P256T;
oo. D96E+T231R+N233R+P256T;
pp. G38A+D96E+D111A+T231R+N233R;
qq. G91T+D96E+D111A+G163K+T231R+N233R+D254S+P256T;
rr. G91T+D96E+D111A+T231R+N233R;
ss. G91T+D96E+T231R+N233R;
tt. G91T+T231R+N233R+D254S+P256T;
uu. N33Q+D96E+D111A+G163K+T231R+N233R+D254S+P256T;
vv. T231R+N233R+D254S+P256T;
ww. T231R+N233R+P256T.

18. The composition of any one of paragraphs 1-17, wherein the lipase is a variant of a parent lipase, wherein said variant
(a) comprises a modification in at least one position corresponding to positions E1, V2, N33, F51, E56, L69, K98, V176, H198, E210, Y220, L227, and K237 of SEQ ID NO: 1; and optionally further comprises a modification in at least one position corresponding to positions D27, G38, D96, D111, G163, T231, N233, D254, and P256 of SEQ ID NO: 1;
(b) has a sequence identity of at least 60% but less than 100% to SEQ ID NO: 1;
(c) has lipase activity.

19. The composition of any one of paragraphs 1-18, wherein said lipase variant comprises a modification in at least one of the following positions: E1, V2, D27, N33, G38, F51, E56, L69, D96, K98, D111, G163, V176, H198, E210, Y220, L227, T231, N233, K237, D254, and P256, wherein numbering is according to SEQ ID NO: 1.

20. The composition of any one of paragraph 18 or 19, wherein said lipase variant comprises at least one of the following modifications; E1C, V2Y, D27R, N33K, N33Q, G38A, F51V, E56K, L69R, D96E, D96L, K98I, K98Q, D111A, G163K, V176L, H198S, E210K, Y220F, L227G, T231R, N233R, N233C, K237C, D254S, and P256T, wherein numbering is according to SEQ ID NO: 1.

21. The composition of any one of paragraphs 18-20, wherein said lipase variant further comprises one of the substitutions selected from the group of: S54T, S83T, G91A, A150G, I255A, and E239C, wherein numbering is according to SEQ ID NO: 1.

22. The composition of any one of paragraphs 18-21, wherein the lipase variant comprises substitutions E1C+N233C and one or more additional substitutions, wherein numbering is according to SEQ ID NO: 1.

23. The composition of any one of paragraphs 18-22, wherein the variant has lipase activity, has at least 60%, at least 65%, at least 70%, at least 75%, at least 80%, at least 85%, at least 90%, at least 95%, at least 96%, at least 97%, at least 98%, at least 99%, but less than 100% sequence identity with SEQ ID NO: 1 and comprises or consists of substitutions corresponding to one of the following set of substitutions using SEQ ID NO: 1 for numbering:

E1C + H198L + N233C
E1C + H198G + N233C
E1C + L69V + N233C
E1C + L69T + N233C
E1C + L69S + N233C
E1C + L69H + N233C
E1C + L69F + N233C
E1C + L69C + N233C
E1C + H198Y + N233C
E1C + H198T + N233C
E1C + H198G + N233C
E1C + L227F + N233C
E1C + L227R + N233C
E1C + E210T + N233C
E1C + E210N + N233C
E1C + V176M + N233C
E1C + K98T + N233C
E1C + K98E + N233C
E1C + E56S + N233C
E1C + E5S6Q + N233C
E1C + ESSR + N233C
E1C + F51M + N233C
E1C + D27R + F51Y + N233C
E1C + V2I + N233C
E1C + V2N + N233C
E1C + V2K + N233C
E1C + V2A + N233C
E1C + D96L + N233C
E1C + L69R + N233C
E1C + V2Y + N233C
E1C + N233C + P256T
E1C + N233C + D254S
E1C + T231R + N233C
E1C + H198S + N233C
E1C + D111A + N233C
E1C + D96E + N233C
E1C + G38A + N233C
E1C + N33Q + N233C
E1C + N33K + N233C
E1C + E210A + N233C
E1C + E210Q + N233C
E1C + E210R + N233C
E1C + H198D + N233C
E1C + K98R + N233C
E1C + K98V + N233C
E1C + F51L + N233C
E1C + F51I + N233C
E1C + K237C
E1C + L227G + N233C
E1C + E210K + N233C
E1C + V176L + N233C
E1C + K98Q + N233C
E1C + E5S6K + N233C
E1C + L147S + N233C + D254S
E1C + Y220F + N233C
E1C + K98I + N233C
E1C + N233C
E1C + D27R + F51I + E56R + K98E + T231R + N233C
E1C + D27R + F51I + E56R + K98E + T231R + N233C + D254S
E1C + D27R + G38A + F5M1L + K98I + D111A + G163S + H198S +
Y220F + T231R + N233C + P256T
E1C + D27R + G38A + F51L + D96E + K98I + D111A + G163K +
DH198S + Y220F + T231R + N233C + 254S + P256T
E1C + D27R + G38R + F51L + D96E + K98I + D111A + G163K +
H198S + Y220F + T231R + N233C + D254S + P256T
E1C + D27R + F51L + D96I + K98I + D111A + G163K + H198S +
Y220F + T231R + N233C + P256T
E1C + D27R + F51L + D96E + K98I + D111A + G163S + H198S +
Y220F + T231R + N233C + P256T
E1C + D27R + F51L + D96E + K98I + D111A + G163K + H198S +
Y220F + T231R + N233C + P256T
E1C + D27R + G38A + F51I + D96E + K98I + D111A + G163K +
H198S + Y220F + T231R + N233C + D254S + P256T
E1C + D27R + G38A + F51V + D96E + K98I + D111A + G163K +
H198S + Y220F + T231R + N233C + P256T
E1C + D27R + F51V + D96E + K98I + D111A + G163K + H198S +
Y220F + T231R + N233C + P256T
E1C + D27R + F51V + D96E + K98I + D111A + G163S + H198S +
Y220F + T231R + N233C + D254S + P256T
E1C + D27R + F51V + D96I + K98I + D111A + G163K + H198S +
Y220F + T231R + N233C + D254S + P256T
E1C + D27R + F51V + K98I + D111A + G163K + H198S + Y220F +
T231R + N233C + D254S + P256T
E1C + D27R + F51V + D96E + K98I + D111A + G163K + H198S +
Y220F + T231R + N233C + D254S + P256T
E1C + D27R + G38A + F51V + D96E + K98I + D111A + G163K +
H198S + Y220F + T231R + N233C + D254S + P256T
E1C + F51V + D96E + K98I + D111A + G163S + H198S + Y220F +
T231R + N233C + P256T
E1C + F51L + D96E + K98I + D111A + G163K + H198S + Y220F +
T231R + N233C + D254S + P256T
E1C + G38A + F51V + D96E + K98I + D111A + G163K + H198S +
Y220F + T231R + N233C + P256T
E1C + F51V + D96E + K98I + D111A + G163K + H198S + Y220F +
T231R + N233C + P256T
E1C + F51V + D96I + K98I + D111A + G163K + H198S + Y220F +
T231R + N233C + D254S + P256T
E1C + F51V + K98I + D111A + G163K + H19S + Y220F + T231R +
N233C + D254S + P256T
E1C + F51I + D96E + K98I + D111A + G163K + H198S + Y220F +
T231R + N233C + D254S + P256T
E1C + D27R + F51L + D96E + K98I + D111A + G163K + H198S +
Y220F + T231R + N233C + D254S + P256T
E1C + D27R + N33K + G38A + F51V + D96E + K98I + D111A +
G163K + H198S + Y220F + T231R + N233C
E1C + G38R + F51V + D96E + K98I + D111A + G163K + H198S +
Y220F + T231R + N233C + D254S + P256T
E1C + F51V + D96E + K98I + D111A + G163K + H198S + Y220F +
T231R + N233C + D254S + P256T
E1C + G38A + F51V + D96E + K98I + D111A + G163K + H198S +
Y220F + T231R + N233C + D254S + P256T
E1C + D27R + G38R + F51V + D96E + K98I + D111A + G163K +
H198S + Y220F + T231R + N233C + D254S + P256T

24. The composition of any one of paragraphs 1-23, wherein the lipase is a lipase variant of a parent lipase having lipase activity, has at least 60%, but less than 100% sequence identity with SEQ ID NO: 1 and comprises one or more (e.g. several) substitutions at positions corresponding to G23S, D27N, A40I, F51I, L, E56R, D57N, V60E,K, K98I, N101D, R118F, G163S, Y220F, T231R, N233R, T244E, and P256T.

25. The composition of any one of paragraphs 1-24, wherein the lipase is a lipase variant comprising substitutions at positions corresponding to T231R+N233R and one or more (e.g., several) substitutions at positions corresponding to G23S, D27N, A40I, F51I,L, E56R, D57N, V60E, K, K98I, N101D, R118F, G163S, Y220F, T244E, and P256T.

26. The composition of any one of paragraphs 1-25, wherein the lipase is a lipase variant comprising substitutions corresponding to any of the following set of substitutions (using SEQ ID NO: 1 for numbering):

G23S + T231R + N233R
D27N + T231R + N233R
A40I + T231R + N233R
F51I + T231R + N233R
F51L + T231R + N233R
E56R + T231R + N233R
D57N + T231R + N233R
V60E + T231R + N233R
V60K + T231R + N233R
K98I + T231R + N233R
N101D + T231R + N233R
R118F + T231R + N233R
G163S + T231R + N233R
Y220F + T231R + N233R
T231R + N233R + T244E
T231R + N233R + P256T

27. The composition of any one of paragraphs 1-26, wherein the lipase is a lipase variant comprising substitutions corresponding to any of the following set of substitutions (using SEQ ID NO: 1 for numbering):

G23S + D27N + F51I + E56R + V60E + R118F + T231R + N233R +
P256T
G23S + D27N + A40I + F51I + E56R + K98I + N101D + R118F +
T231R + N233R + T244E + P256T
G23S + D27N + A40I + F51I + E56R + V60K + R118F + T231R +
N233R + T244E + P256T
G23S + T231R + N233R
D27N + T231R + N233R
A40I + T231R + N233R
F51I + T231R + N233R
F51L + T231R + N233R
E56R + T231R + N233R
D57N + T231R + N233R
V60E + T231R + N233R
V60K + T231R + N233R
K98I + T231R + N233R
N101D + T231R + N233R
R118F + T231R + N233R
G163S + T231R + N233R
Y220F + T231R + N233R
T231R + N233R + T244E
T231R + N233R + P256T
E56R + R118F + T231R + N233R
R118F + T231R + N233R + P256T
A40I + R118F + T231R + N233R
F51I + E56R + R118F + T231R + N233R
F51L + E56R + R118F + T231R + N233R
E56R + D57N + R118F + T231R + N233R
E56R + V60K + R118F + T231R + N233R

28. The composition of paragraphs 1-27, wherein the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1;
ii) a variant having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 1;
iii) a fragment of the lipase in (i) or (ii) having lipase activity.

29. The composition of paragraphs 1-13, wherein the lipase is a variant of SEQ ID NO: 2, wherein the variant comprises:
(a) a substitution corresponding to:
D1E,Q; A4R; D5Q; L7Y; N8D,E,Q; K11E,Q; R24E,N,Q; N26Q; D27N,Q; A30N; N33Q; T35N; N39D,Q; A46Q; D48Q; F51I, V; L52N, E56N; N57Q; G59S; V60S,M, D62Q; D70Q; N71Q; N73S; I86F,P; N88D,Q; I90R; L93F; N94Q,R,S; D96H,I,Q,S; V98I; N101D,Q,R; S105R; R108E,Q; D111Q; D122Q; D130Q; D158Q; N162D,E; Y164S; D165Q; D167Q; A173Q; N178D; A180E; N200Q; R209Q; Q210E; F211A,N,S,T,Y; G212D,E,R; L227G, V228E,P; R231Q; R232E,Q; R233K, N,Q; T244E; N250D; I255A; A257S; L264A, V, I; and/or
(b) substitutions corresponding to:
A4E+F211V; A4E+L227G; A4E+T252A; D122N+L124S; D165N+D167S; D96N+V98S; E45N+A47S; E87K+F95Y; E87R+N94D; F211V+L227G; F211V+L264A; F211V+T252A; I238C+G246C; L227A+L264A; L227G+I269W; L264A+I269W; N250P+T252I; S105D+R108G; T123N+R125S; T252A+I269W; T252A+L264A; T252A+L264I; T252A+L264P; T252A+L264Q; T252A+L264S; T252A+L264T; T72N+K74S; V60M+L227G; and/or
(c) substitutions corresponding to:
A40N+T252A+L264A; A46N+T252A+L264A; A46N+T252A+L264A; A46R+T252A+L264A; D130H+N250P+T252I; D1A+T252A+L264A; D1C+T252A+L264A; D1F+T252A+L264A; D1G+T252A+L264A; D1H+T252A+L264A; D1L+T252A+L264A; D1M+T252A+L264A; D1G+T252A+L264A; D1R+T252A+L264A; D1W+T252A+L264A; D1Y+T252A+L264A;
D5R+T252A+L264A; D62R+T252A+L264A; F10L+T252A+L264A; F10M+T252A+L264A; F211V+L264A+I269W; F211V+T252A+L264A; F51G+T252A+L264A; F51K+T252A+L264A; G106E+N250P+T252I; G65A+T252A+L264A; G65W+T252A+L264A; H198I+T252A+L264A; H198N+P256T+A257I; K74G+T252A+L264A; L12H+N250P+T252I; L227G+T252A+L264A; L75A+T252A+L264A; L75K+T252A+L264A; L75Y+T252A+L264A; L7F+T252A+L264A; N250P+T252I+I255D; N39S+T252A+L264A; N8K+T252A+L264A; N8R+T252A+L264A; N94D+T252A+L264A; Q15M+T252A+L264A; R108Q+R179E+G212E; R232N+T252A+L264A; S37H+N250P+T252I; S3R+T252A+L264A; T50H+T252A+L264A; T50L+T252A+L264A; T50M+T252A+L264A; T50W+T252A+L264A; T50Y+T252A+L264A; V228R+T252A+L264A; V63C+T252A+L264A; V63E+T252A+L264A; V63G+T252A+L264A; V63I+T252A+L264A; V63L+T252A+L264A; V63Q+T252A+L264A; V63S+T252A+L264A; A19T+T252A+L264A; A19S+T252A+L264A; K11L+T252A+L264A; A20V+T252A+L264A; A20T+T252A+L264A; S17C+T252A+L264A; 134S+T252A+L264A; T32P+T252A+L264A; N26A+T252A+L264A; N26W+T252A+L264A; N26K+T252A+L264A; S37V+T252A+L264A; S37Y+T252A+L264A; S37E+T252A+L264A; D27E+T252A+L264A; A38S+T252A+L264A; T721+T252A+L264A; T72V+T252A+L264A; V60T+T252A+L264A; L43G+T252A+L264A; N33V+T252A+L264A; N33F+T252A+L264A; N33D+T252A+L264A; P42S+T252A+L264A; A47G+T252A+L264A; A47R+T252A+L264A; G31V+T252A+L264A; A46F+T252A+L264A; A46F+T252A+L264A; A46G+T252A+L264A; A40H+T252A+L264A; A46K+T252A+L264A; D62G+T252A+L264A; D62A+T252A+L264A; F66K+T252A+L264A; A49V+T252A+L264A; T50A+T252A+L264A; F51H+T252A+L264A; A49G+T252A+L264A; V63M+T252A+L264A; F51L+T252A+L264A; T50N+T252A+L264A; V63T+T252A+L264A; F51P+T252A+L264A; A49S+T252A+L264A; A49Q+T252A+L264A; V63A+T252A+L264A; S54R+T252A+L264A; F51Y+T252A+L264A; S54D+T252A+L264A; T64S+T252A+L264A; S54C+T252A+L264A; L52W+T252A+L264A; L52T+T252A+L264A; A68V+T252A+L264A; V69Q+T252A+L264A; S58Y+T252A+L264A; N57S+T252A+L264A; L67Y+T252A+L264A; F66N+T252A+L264A; N71C+T252A+L264A; D70R+T252A+L264A; V60M+T252A+L264A; N71G+T252A+L264A; V69K+T252A+L264A; V69E+T252A+L264A; N71D+T252A+L264A; N71T+T252A+L264A; V60W+T252A+L264A; V60G+T252A+L264A; V60A+T252A+L264A; G61A+T252A+L264A; V60L+T252A+L264A; A4R+R233N+T252A; A4R+R233N+L264A; T72G+T252A+L264A; A4R+V60M+L227G; A4R+L227G+R233N; A4R+V60M+R233N; R233N+T252A+L264A; V60M+L227G+R233N; V60M+L227G+L264V; V60M+L227G+L264I; V60M+L227G+T252A; A4R+L227A+L264A; G23A+N250P+T252I; V60K+N250P+T252I; L97V+N250P+T252I; A150G+N250P+T252I; V202L+N250P+T252I; V228P+N250P+T252I; L227G+N250P+T252I; F211G+N250P+T252I; V1421+N250P+T252I; V60M+L227G+V228Q; A4L+T252A+L264A; T114E+T252A+L264A; G156A+T252A+L264A; L168E+T252A+L264A; N73G+T252A+L264A; and/or
(d) substitutions corresponding to:
A4K+R231T+T252A+L264A; A4K+R232V+T252A+L264A; L227G+V228A+T252A+L264I; L7F+L227G+T252A+L264A; N250P+T252I+D254N+P256S; Q249N+N250P+N251S+T252I; T244N+G246S+N250P+T252I; T91A+N92D+D96L+V98Q; T91A+V228L+T252A+L264S; V202C+N250P+T252I+P253C; V60M+T91A+T252A+L264A; W221C+G246C+N250P+T252I; D1C+R233C+T252A+L264A; V60M+D99N+N101S+L227G; V60M+S119N+A121S+L227G; V60M+L227G+V228R+L264T; V60M+R125N+A127S+L227G; D1G+T252A+P256T+L264A; and/or
(e) substitutions corresponding to:
T91A+H198N+D254S+P256T+A257I; T91A+T252A+I255L+P256K+L264A; V60M+L227G+V228L+T252A+L264Y; V60M+L227V+V228P+T252A+L264I; V60M+T91A+L227R+T252A+L264V; N33Q+V60M+G163N+D165S+L227G; R24E+A180E+N250D+T252A+L264A; and/or V60M+T91A+L227V+T252A+L264M; and/or
(f) substitutions corresponding to:
L7F+T91A+A150G+L154V+T252A+L264A; and/or (g) substitutions corresponding to: D1C+V202C+R233C+I238C+G245C+T252A+P253C+L264A; and/or A4R+I90V+N94E+D96L+N101P+R233N+T252A+L264A; of the polypeptide shown as SEQ ID NO: 2.

30. The composition of paragraph 29, further comprising one or more substitutions corresponding to:
A4E; A20T; P29S; A46Q; S58N; T91A; N92D; L93F,I; S105D,E,N; R179G,Q; N200R; Y220F; L227G; R231K; T244E; Q249E; T252A,S,V; N25S; A38T; R84S; N94D; V98Q; N101K; D130H; D137G; R232K; T244A,N,K; A249G,R; N250P; T252I; D254S; P256T; A257I; L264A; N94V; F95V; L97S; N101E; S105K; D129G; A134S; V187I; Q188H; R209Q; Q210D; G212S; D234R; G240D; N248D,E; Q249D,G; L264V; T267A; I269F; A28V; V60E,I,M; V63I; E87Q; N92D; V98Q; S105G; R179K; V228L; N248K; Q249D; I255G; L264P,Y; A4Q; L7F; A46K; Y53F; V60K; E87K; Y138F; A157V; Y194F; H198I; Y213F; L227V, V228A; and/or I255L (using SEQ ID NO: 2 for numbering).

31. The composition of any one of paragraphs 29 or 30, comprising substitutions corresponding to:
A20T+L93F; A4E+A46Q; F51I+T244E; L227G+R233N; L227G+T244E; L227G+T252A; L93I+V98I; N101D+S105D; Q210E+Q249E; R179Q+G212E; R231K+R233K; R233N+T252A; S105D+G212E; S105E+R108Q; S105N+G212D; S105N+G212E; S58N+V60S; T244E+T252A; T252A+I255A; T252S+I255A; and/or T91A+V98I (using SEQ ID NO: 2 for numbering).

32. The composition of any one of paragraphs 29-31, comprising substitutions corresponding to: A4R+R233N; K223Q+R232Q; Q210E+N250D; R108Q+G212E; R24Q+N250D and/or R24Q+Q210E (using SEQ ID NO: 2 for numbering).

33. The composition of any one of paragraphs 29-32, comprising substitutions corresponding to: A38T+D96H+D137G; A4R+T252A+L264A; D1G+T252A+L264A; D62N+T252A+L264A; D165Q+N250P+T252I; H198S+Y220F+L264A; N101K+S105N+R108E; N94Q+N250P+T252I; Q210E+T244E+Q249G; Q210E+T252A+L264A; R231K+R232K+R233K; S83T+H198S+D254S; R233N+T252A+L264A; A46Q+T252A+L264A; N39D+T252A+L264A; R24E+V60M+L227G; and/or F51I+T252A+L264A (using SEQ ID NO: 2 for numbering).

34. The composition of any one of paragraphs 29-33, comprising substitutions corresponding to: A4R+R233N+T252A+L264A; A4R+V60M+L227G+R231T; A4R+V60M+L227G+R232V; A4R+V60M+L227G+R233N; E87Q+T91A+D961+V98Q; G109R+Q210E+T244N+Q249E; L227G+R233N+T252A+L264A; L7F+Q210E+T252A+L264A; Q188H+Q210E+T252A+L264A; Q210E+L227G+T252A+L264A; Q210N+G212S+N250P+T252I; V60S+L227G+T252A+L264A; R24E+N33Q+V60M+L227G; and/or R24E+V228P+T252A+L264A (using SEQ ID NO: 2 for numbering).

35. The composition of any one of paragraphs 29-34, comprising substitutions corresponding to: L227G+R233N+T244E+T252A+L264A; S105N+R108Q+D129G+D137G+G212D; L7F+R24E+N39D+T252A+L264A; R24E+V128A+V228E+T252A+L264A; or A20T+G163N+D165S+T252A+L264A (using SEQ ID NO: 2 for numbering).

36. The composition of any one of paragraphs 29-35, comprising substitutions corresponding to: L7F+N8K+Q210E+L227G+T252A+L264A; 8D+101K+S105G+R108Q+R179E+G212E; N8D+R209Q+Q210E+T244N+N248K+Q249E; V60E+S83T+T91A+H198S+T252A+L264P; or V60M+T91A+Q210E+V228L+T252A+L264Y (using SEQ ID NO: 2 for numbering).

37. The composition of any one of paragraphs 29-35, comprising substitutions corresponding to: V60K+S83T+T91A+H198I+V228L+T252A+L264P; or V60M+A157V+Q210E+L227V+V228A+T252A+L264V (using SEQ ID NO: 2 for numbering).

38. The composition of any one of paragraphs 29-37, comprising substitutions corresponding to: D1E+A4Q+L7F+K11N+S37T+A46K+A133R+V142F+T170S+V202I+Q210E+L227G (using SEQ ID NO: 2 for numbering).

39. The composition of any of paragraphs 1-35, wherein the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 3;
ii) a variant having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 3;
iii) a fragment of the lipase in (i) or (ii) having lipase activity.

40. The composition of paragraph 39, wherein the composition comprises a fungal lipase derived from a strain of Absidia sp, in particular the one show in SEQ ID NO: 3.

41. The composition of paragraph 39 or 40, wherein the lipase is a variant of SEQ ID NO: 3, wherein the variant comprises one or more substitutions corresponding to: R131A, R131G, R131K, R131L, R131M, R131S, R131W; S152A; T176N; V247A, V247F, V247K, V247L, V247S, V247T, V247W; D255A, and D255G of SEQ ID NO: 3.

42. The composition of any one of paragraphs 39-41, wherein the lipase is a lipase variant having at least 60% but less than 100% sequence identity to SEQ ID NO: 3 and comprises at least one of the set of substitutions corresponding to the substitutions selected from the group of:
a) N97D+T176N
b) Q49K+D255G
c) N97D+D255G
d) S152A+D255G
e) H158Q+D255G
f) S152A+H158Q+K221S
g) Q49K+T176N+D255G
h) N97D+T176N+D255G
i) S152A+T176N+D255G
j) K108A+H158Q+K221S
k) N97D+H158Q+K221S
l) N97D+R131A+D255G
m) N97D+V247A+D255G
n) T176N+K221S+V247A+D255G
o) S152A+T176N+K221S+V247G+D255G
p) S152A+T176N+V247N+D255G
q) S152A+T176N+1219N+M220D+V247P
r) N97D+S152A+T176N+V247P+D255G
s) R131A+S152A+T176N+V247P+D255G
t) N97D+S152A+T176N+V247F+D255G
u) K108A+S152A+T176N+V247F+D255G
v) R131A+S152A+T176N+V247F+D255G
w) R131A+S152A+T176N+L225V+P229S+V247F+D255G
aa) R131A+S152A+1174V+V247F+D255G
ab) K70E+R131A+S152A+T176N+V247F+D255G
ac) R131A+S152A+T176N+G206P+V247F+D255G
ad) L111S+R131A+S152A+T176N+V247F+D255G
ae) L111T+R131A+S152A+T176N+V247F+D255G
af) V101R+R131A+S152A+T176N+V247F+D255G
ag) D130R+S152A+T176N+V247F+D255G
ah) N97L+R131A+S152A+T176N+V247F+D255G
ai) R131A+S152A+T176N+V247F
aj) R131A+S152A+T176N+S223R+V247F
ak) R131A+S152A+T176N+1232E+V247F+D255G
al) R131A+S152A+T176N+1219N+V247F+D255G
am) R131A+S152A+T176N+1219E+V247F+D255G
an) N97L+V101R+R131A+S152A+T176N+V247F+D255G
ao) L111T+D130R+S152A+T176N+V247F+D255G
ap) V101R+R131A+S152A+T176N+V247F+D255G
aq) V101R+D130R+S152A+T176N+V247F+D255G
ar) R131A+S152A+T176N+A207E+V247F+D255G
as) K108V+R131A+S152A+T176N+V247F+D255G
at) K70E+D130R+R131A+S152A+T176N+A207E+V247F+D255G
au) D130R+R131A+S152A+T176N+S223R+V247F+D255G
av) V101R+R131A+S152A+T176N+S223R+L251F
aw) V101R+R131A+L1441+S152A+T176N+S223R+V247F+D255G
ba) V101R+D130R+R131A+S152A+T176N+S223R+V247F+D255G
bb) V101R+R131A+S152A+T176N+S223R+V247F+D255G
bc) V101R+R131A+S152A+T176N+G206V+S223R+V247F+D255G
bd) V101R+R131A+S152A+T176N+G206S+S223R+V247F+D255G
be) K70E+V101R+R131A+S152A+T176N+S223R+V247F+D255G
bf) D4C+V101R+R131A+S152A+T176N+S223R+N236C+V247F+D255G
bg) V101R+D130R+R131A+S152A+T176N+G206V+S223R+V247F+D255G
bh) V101R+R131A+L144|+S152A+T176N+G206V+S223R+V247F+D255G
bi) V101R+R131A+S152A+T176N+G206V+S223R+V247F+D255G
bj) V101R+R131A+S152A+T176N+G206V+S223R+L251F+D255G
bk) D4C+V101R+D130R+R131A+S152A+T176N+G206P+S223R+N236C+V247F+D255G
bl) D4C+A45V+V101R+D130R+R131A+S152A+T176N+G206V+S223R+N236C+V247F+D255G
bm) D4C+Q49V+V101R+D130R+R131A+S152A+T176N+G206V+S223R+N236C+V247F+D255G
bn) D4C+N97D+D130R+R131A+S152A+T176N+G206V+S223R+N236C+V247F+D255G
bo) D4C+V101R+R131A+S152A+T176N+G206V+S223R+N236C+V247F+D255G
bp) D4C+V101R+D130R+R131A+S152A+T176N+S223R+N236C+V247F+D255G
bq) D4C+V101R+R131A+S152A+T176N+S223R+N236C+V247F+D255G.

43. Composition of any one of paragraphs 1-13, wherein the lipase is:
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 4;
ii) a variant having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 4;
iii) a fragment of the lipase in (i) or (ii) having lipase activity.

44. The composition of paragraph 43, wherein the lipase is a variant of SEQ ID NO: 4, wherein the variant comprises:
(a) a substitution corresponding to
D4A; I7D; K14E; T17S; G34D; R36E; R36M; R36V; R36Q; S38D; S38E; G43D; G43H; N47D; N47E; N47G; N47H; Q49T; Q49V; L57S; D60G; D60V; G681; E69M; E69T; K70D; K70H; K70Q; A89Y; V94D; V94L; N102M; G109R; Q118S; K120A; K120D; K120E; K120N; K120M; K120G; K120P; K120Q; K120S; K120V; A123E; K136G; H158E; H158Q; H161D; H161E; A162S; N163E; N163H; I174A; P177G; P177I; P177K; P177L; A178I; A178L; A178T; A178V; N181K; N181L; N181T; N181W; Y182W; V183M; 1184V; G185A; G1851; G185K; G185R; G185T; G185W; G185Y; K187G; K187L; P189A; P189L; P189M; P189N; P189Q; P189R; P189T; P189V; P189W; 1199T; 1199V; E196M; S206G; S206V; A207N; L211C; R223A; R223E; R223G; R223H; R223K; R223N; R223Q; S224T; 1232P; 232Q; T234S; D235A; 1248L; S252N; L260F; and/or
(b) substitutions corresponding to
N163E+R223N; K70E+S206G; R101V+S206V; A15E+K120Q; D130R+S206G; D130R+S206V; T2S+A15E; and/or
(c) substitutions corresponding to
R36V+V183M+R223N; N47H+K70E+S206G; N163E+R223N+S252N; N47D+K120G+R223N; G43D+N47D+K120G; K70E+H195S+S206G; K70E+L156F+S206G; A178Y+P189V+R223N; R36E+G43D+N47D; K70D+N163E+S252N; N47D+K120G+N163E; K70E+P189Q+S206G; R36T+K70E+S206G; R361+K70E+S206G; Q49T+K70E+S206G; G43D+K70E+S206G; R36K+K70E+S206G; K70E+P189M+S206G; K52A+K70E+S206G; R36M+K70E+S206G; R36E+K70E+S206G; R101V+S206V+R223S; R36V+N47D+K120G; K14A+K70E+S206G; D4C+S206G+N236C; K70E+G185L+S206G; R36Y+K70E+S206G; R36L+K70E+S206G; K70E+P189L+S206G; R36A+K70E+S206G; R101V+D130R+S206G; D4C+S206G+N236C; D4C+S206V+N236C; R36F+K70E+S206G; K70E+K120P+S206G; and/or
(d) substitutions corresponding to
N163E+G185H+R223N+S252N; N163E+N181W+R223N+S252N;
K70D+N163E+R223N+S252N; D4C+S206G+N236C+S252N; D4C+S206G+R223N+N236C; A178Y+V183M+P189V+R223N; and/or
(e) substitutions corresponding to
D4C+P189V+S206G+R223N+N236C; D4C+N163E+S206G+N236C+S252N;
D4C+N163E+S206G+R223N+N236C; D4C+A178Y+S206G+R223N+N236C;
D4C+K108A+D130R+S206V+N236C; and/or
(f) substitutions corresponding to
S1C+A8C+T17C+L225R+N230C+L254C; S1C+A8C+T17C+L225R+N230C+L254C;
D4C+N97D+R101V+D130R+S206V+N236C; and/or
(g) substitutions corresponding to
S1C+A8C+T17C+1184N+L225C+N230C+L254C;
S1C+A8C+T17C+Y75F+L225C+N230C+L254C;
S1C+A8C+T17C+Q49L+L225C+N230C+L254C;
S1C+A8C+T17C+Y167F+L225C+N230C+L254C;
S1C+A8C+T17C+Y190F+L225C+N230C+L254C;
S1C+A8C+T17C+Q49|+L225C+N230C+L254C;
S1C+A8C+T17C+L225C+N230C+F244N+L254C;
S1C+A8C+A15E+T17C+L225C+N230C+L254C;
S1C+A8C+T17C+A162S+L225C+N230C+L254C;
S1C+A8C+T17C+V183S+L225C+N230C+L254C;
S1C+A8C+T17C+|164L+L225C+N230C+L254C;
S1C+A8C+T17C+Y19F+L225C+N230C+L254C;
S1C+A8C+T17C+E165S+L225C+N230C+L254C;
S1C+A8C+T17C+Q49S+L225C+N230C+L254C;
S1C+A8C+T17C+K187N+L225C+N230C+L254C;
S1C+A8C+A15R+T17C+L225C+N230C+L254C; and/or
(h) substitutions corresponding to
R101V+A131R+A152S+N176T+S206G+R223S+F247V+G255D;
S1C+D4N+R6S+A8C+T17C+L225C+N230C+L254C;
R101V+A131R+A152S+N176T+S206G+R223S+F247V+G255D;
S1C+A8C+T17C+K136N+V138S+L225C+N230C+L254C;
A26C+132C+A45V+Q49K+N97D+D130R+H159K+S224R;
S1C+A8C+T17C+K70E+|184N+L225C+N230C+L254C
S1C+A8C+T17C+V76I+L225C+N230C+L254C; and/or
(i) substitutions corresponding to
S1C+A8C+T17C+H159K+H161N+N163S+L225C+N230C+L254C;
S1C+A8C+T17C+V76I+V138L+|164L+L225C+N230C+L254C; and/or
(j) substitutions corresponding to
S1C+A8C+T17C+S38T+V76I+V138L+|164L+L225C+N230C+L254C; and/or
(k) substitutions corresponding to
A8C+T17C+R36N+G43D+Q49T+K70N+K72S+K120G+S206V+R223N+L225C+L254C; and/or
(l) substitutions corresponding to
A8C+T17C+R36V+S38D+G43D+N47D+Q49N+K70N+K72S+K120G+T148V+E165S+N181W+S206V+R223H+L225C+L254C;
of the polypeptide shown as SEQ ID NO: 2.

45. The composition of paragraphs 1-44, wherein the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 6;
ii) a fragment of the lipase in i) having lipase activity.

46. The composition of paragraph 45, wherein the composition comprises or consists of the Geotrichum candidum lipase 1 (GCL 1) shown in SEQ ID NO: 6 herein or an analogue thereof disclosed in WO2022/162043.

47. The composition of any of paragraphs 1-46, further comprising one or more enzymes selected from: alpha-amylase, proteases, cellulases, phospholipases, cutinases, pectinases, mannanases, pectate lyases, phosphodiesterases (PDEs), deoxyribonucleases (DNases), or mixtures thereof.

48. A method for cleaning or washing of laundry comprising contacting the laundry with a composition of any one of paragraphs 1-47

49. The method of paragraph 48, wherein the laundry includes textiles, clothes, linen or the like, wherein the laundry may be made from any material including yarns, yarn intermediates, fibers, non-woven materials, natural materials, synthetic materials, and any other textile material, fabrics made of these materials and products made from fabrics (e.g., garments and other articles).

50. The method of paragraph 48 or 49, wherein the laundry is in the form of knits, wovens, denims, non-wovens, felts, yarns, and towelling.

51. The method of any one of paragraphs 48-50, wherein the laundry is cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof, or wherein the laundry is non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers, in particular wherein the blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell).

52. The method of any one of paragraphs 48-51, wherein the laundry is conventional washable laundry, such as stained household laundry.

53. The method of any of paragraphs 48-52, wherein the lipase is dosed at a concentration of 0.001-5 ppm, in particular 0.01-10 ppm.

54. The method of paragraphs 48-53, wherein the alkoxylated polyethyleneimine, in particular ethoxylated and propoxylated polythyleneimine, and/or alkoxylated polyetheramine, in particular ethoxylated and propoxylated polyetheramine, is dosed at a concentration of 0.001-100 ppm, in particular 0.01-50 ppm.

55. The method of paragraphs 48-54, wherein guanidine hydrochloride is dosed at a concertation of 0.001-100 mM/L wash water, such as around 0.01-05 mM/L wash water.

56. The method of any one of paragraphs 48-55, wherein the ratio between lipase and booster is between 1:50 and 1:1, such as between 1:40 and 1:2, such as between 1:30 and 1:3.

57. An enzyme product comprising:
(a) a lipase; and
(b) one or more boosters selected from the group of:
   i) alkoxylated polyethyleneimine in particular ethoxylated and propoxylated polyethyleneimine;
   ii) alkoxylated polyetheramine, in particular ethoxylated and propoxylated polyetheramine;
   iii) guanidine hydrochloride; and
   iv) rhamnolipid.

58. The enzyme product of paragraph 57, wherein the product is formulated as a liquid enzyme formulation.

59. The enzyme product of paragraph 57 or 58, wherein the product further comprises a solvent system to make it a liquid.

60. The enzyme product of any one of paragraphs 57-59, wherein the enzyme product comprises a solvent selected from the group of: water, polyols (such as glycerol, (mono, di, or tri) propylene glycol, (mono, di, or tri) ethylene glycol, sugar alcohol (e.g. sorbitol, mannitol, erythritol, dulcitol, inositol, xylitol or adonitol), polypropylene glycol, and/or polyethylene glycol), ethanol, sugars, and salts.

61. The enzyme product of any one of paragraphs 57-60, wherein the enzyme product comprises a preservation agent and/or other stabilizing agents, such as sugars including glucose, fructose, sucrose, or trehalose; salt to increase the ionic strength; divalent cations (e.g., Ca2+ or Mg2+); and enzyme inhibitors, enzyme substrates, or polymers (e.g., PVP).

62. The enzyme product of any one of paragraphs 57-61, wherein then product further comprises other enzyme activities, such as protease, amylase, cellulase, and/or nuclease (e.g., DNase, RNase) activities.

63. The enzyme product of any one of paragraphs 57-62, comprising:
(a) at least 0.01% w/w lipase,
(b) one or more boosters as defined in paragraph 57,
(c) at least 0.5% w/w polyol,
(d) water, and
(e) optionally a preservation agent.

64. The enzyme product of any one of paragraphs 57-63, wherein the pH for the is in the range of pH 4-9.

65. The enzyme product of any one of paragraphs 57-64, wherein the enzyme product further comprises:
(i) a polyol, preferably selected from glycerol, (mono, di, or tri) propylene glycol, (mono, di, or tri) ethylene glycol, polyethylene glycol, sugar alcohols, sorbitol, mannitol, erythritol, dulcitol, inositol, xylitol and adonitol;
(ii) optionally an additional enzyme, preferably selected from protease, and/or amylase;
(iii) optionally a surfactant, preferably selected from anionic and nonionic surfactants;
(iv) optionally a divalent cation, polymer, or enzyme inhibitor;
(v) optionally having a pH in the range of pH 4-9; and
(vi) water.

66. The enzyme product of any one of paragraphs 57-65, wherein the product is formulated as a solid/granular enzyme formulation.

67. The enzyme product of any one of paragraphs 57-66, wherein the product is comprises a waxy coating material, such as poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids.

68. The enzyme product of any one of paragraphs 57-67, wherein the enzyme product is formulated as a granule, such as a co-granule that combines one or more enzymes or benefit agents (such as MnTACN or other bleaching components).

69. The enzyme product of any one of paragraphs 57-68, wherein the enzyme product further comprises enzymes from the group comprising proteases, amylases, cellulases, and/or nucleases (e.g., DNase, RNase). 70. The enzyme product of any one of paragraphs 57-69, wherein the granule is composed of a core, and optionally one or more coatings (outer layers) surrounding the core. 71. The enzyme product of any one of paragraphs 57-70, wherein the granule/particle size, measured as equivalent spherical diameter (volume based average particle size), of the granule is 20-2000 μm, particularly 50-1500 μm, 100-1500 μm or 250-1200 μm.

72. The enzyme product of any one of paragraphs 57-71, wherein the core includes additional materials such as fillers, fibre materials (cellulose or synthetic fibres), stabilizing agents, solubilising agents, suspension agents, viscosity regulating agents, light spheres, plasticizers, salts, lubricants and fragrances.

73. The enzyme product of any one of paragraphs 57-72, wherein the core includes binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating.

74. The enzyme product of any one of paragraphs 57-73, wherein the core has a diameter of 20-2000 μm, particularly 50-1500 μm, 100-1500 μm or 250-1200 μm.

75. The enzyme product of any one of paragraphs 57-74, wherein the core is surrounded by at least one coating, e.g., a salt coating, or other suitable coating materials, such as polyethylene glycol (PEG), methyl hydroxy-propyl cellulose (MHPC) and polyvinyl alcohol (PVA).

76. The enzyme product of any one of paragraphs 57-75, wherein the product comprises a granule, which comprises:
(a) a core comprising at least a lipase and a booster as defined in paragraph 57; and
(b) optionally a (salt) coating consisting of one or more layer(s) surrounding the core.

77. The enzyme product of any one of paragraphs 57-76, wherein the product is a layered granule, comprising:
(a) a (non-enzymatic) core;
(b) a coating surrounding the core, wherein the coating comprises a lipase and a booster; and
(c) optionally a (salt) coating consisting of one or more layer(s) surrounding the enzyme containing coating.

78. The enzyme product of any one of paragraphs 57-77, wherein the product is formulated as an encapsulated enzyme formulation (an ‘encapsulate’).

### Materials & Methods

Lipase 1: Thermomyces lanuginosus lipase (TLL) shown in SEQ ID NO: 1 with the following substitutions: D27R+G38A+D96E+D111A+G163K+T231R+N233R+D254S+P256T (available from Novozymes A/S, Denmark);
Lipase 2: Thermomyces lanuginosus lipase (TLL) shown in SEQ ID NO: 1 with the following substitutions: E1C+D27R+G38A+F51V+D96E+K98I+D111A+G163K+H198S+Y220F+T231R+N233C+D254S+P256T (available from Novozymes A/S, Denmark);
Lipase 1180: Absidia lipase in SEQ ID NO: 4 with the following mutations in the mature sequence: N47D+V101R+K120G+R131A+S152A+T176N+G206S+S223N+V247F+D255G,
Lipase 899: Absidia lipase variant in SEQ ID NO: 4 with the following mutations in the mature sequence: N47D+V101R+R131A+S152A+T176N+G206S+S223R+V247F+D255G
GCL1: Lipase from Geotrichum candidum lipase 1 (GCL 1) disclosed in SEQ ID NO: 6 herein or SEQ ID NO: 1 in WO 2022/162043-hereby incorporated by reference.
Polymer A: Ethoxylated and propoxylated polyethyleneimine (Lupasol PN 80 (BASF))
Polymer B: Ethoxylated and propoxylated polyethyleneimine (Lupasol G100 (BASF))
Guanidine hydrochloride: GuaHCl purchased from Sigma.
   Lipase Activity Determined by p-nitrophenyl (pNP) Assay

The hydrolytic activity of lipases may be determined by a kinetic assay using p-nitrophenyl acyl esters as substrate. A 100 mM stock solution in DMSO for each of the substrates p-nitrophenyl butyrate (C4), p-nitrophenyl caproate (C6), p-nitrophenyl caprate (C10), p-nitrophenyl laurate (C12) and p-nitrophenyl palmitate (C16) (all from Sigma-Aldrich Danmark A/S, Kirkebjerg Allé 84, 2605 Brøndby; Cat. no.: C3: N-9876, C6: N-0502, C10: N-0252, C12: N-2002, C16: N-2752) is diluted to a final concentration of 1 mM 25 mM in the assay buffer (50 mM Tris; pH 7.7; 0.4% Triton X-100). The lipase in 50 mM Hepes; pH 8.0; 10 ppm Triton X-100; +/−20 mM CaCl₂) are added to the substrate solution in the following final protein concentrations: 0.01 mg/ml; 5×10⁻³ mg/ml; 2.5×10⁻⁴ mg/ml; and 1.25×10⁻⁴ mg/ml in 96-well NUNC plates (Cat. No. 260836, Kamstrupvej 90, DK-4000, Roskilde). Release of p-nitrophenol by hydrolysis of a p-nitrophenyl acyl may be monitored at 405 nm for 5 minutes in 10 second intervals on a Spectra max 190 (Molecular Devices GmbH, Bismarckring 39, 88400 Biberach an der Riss, GERMANY).

### Construction of Variants by Site-Directed Mutagenesis

Site-directed variants are constructed by traditional cloning of DNA fragments (Sambrook et al., Molecular Cloning: A Laboratory Manual, 2nd Ed., Cold Spring Harbor, 1989) using PCR together with properly designed mutagenic oligonucleotides that introduced the desired mutations in the resulting sequence.

Mutagenic oligos are designed corresponding to the DNA sequence flanking the desired site(s) of mutation, separated by the DNA base pairs defining the insertions/deletions/substitutions, and purchased from an oligo vendor such as Life Technologies. In order to test the variants, the mutated DNA encoding a variant is integrated into a competent A. oryzae strain by homologous recombination, fermented using standard protocols (yeast extract based media, 3-4 days, 30° C.), and purified by chromatography.

### EXAMPLES

### Example 1

### Enhanced Cleaning by Lipase and Polymer a Booster in Powder Detergent

Model detergent X wash liquor was prepared by dissolving 1.75 g/l of Model detergent X containing 16.5% LAS, 2% AEO, 20% sodium carbonate, 12% Sodium disilicate, 15% Zeolite A, 1% PCA, 33.5% Sodium Sulfate (all percentages are w/w) in water with hardness 6° dH.

Lard swatches were prepared by melting lard and adding 100 uL to a 5×5 cm piece of WFK80A textile (CFT). Swatches were heated at 100° C. for 20 minutes and cooled before measuring weight with a precision balance (Mettler Toledo).

Lipase 899 and Polymer A were added according to below table in combination or separately followed by adding four of the ready lard swatches to the liquor mix together with 2 CS-10 swatches (CFT). The lipase addition was followed by continuous agitation at 120 rpm for 25 minutes at 20° C. Rinse was performed in a beaker under the tap applying cold water for 5 minutes. Dried on filter paper. Lard swatches to be weighed were treated by heating first at 100° C. for 20 minutes, and cooling for 1-2 hours before weighing.

Enhanced cleaning by Lipase and Polymer A booster in powder detergent

| | | Polymer A | Fat removal | +/− |
|---|---|---|---|---|
| | Lipase 899 | booster | under wash | Standard |
| Detergent | (0.15 ppm) | (7 ppm) | (% of stain) | Error |
| Model | + | + | 61.8 | 1.1 |
| detergent | − | + | 33.6 | 1.2 |
| X | + | − | 40.2 | 0.6 |
| | − | − | 31.6 | 0.8 |

### Example 2

### Enhanced Cleaning by Lipase and Polymer B Booster or Rhamnolipids Booster in Powder Detergent

Model detergent X wash liquor was prepared by dissolving 1.75 g/l of Model detergent X containing 16.5% LAS, 2% AEO, 20% sodium carbonate, 12% Sodium disilicate, 15% Zeolite A, 1% PCA, 33.5% Sodium Sulfate (all percentages are w/w) in water with hardness 6° dH.

Lard swatches were prepared by melting lard and adding 100 μL to a 5×5 cm piece of WFK80A textile (CFT). Swatches were heated at 100° C. for 20 minutes and cooled before measuring weight with a precision balance (Mettler Toledo).

Lipase 899 and Polymer B (BASF) or Rhamnolipids (R90, 90% pure) were added according to below table in combination or separately followed by adding four of the ready lard swatches to the liquor mix together with 2 CS-10 swatches (CFT). The enzyme addition was followed by continuous agitation at 120 rpm for 25 minutes at 20° C. Rinse was performed in a beaker under the tap applying cold water for 5 minutes. Dried on filter paper. Lard swatches to be weighed were treated by heating first at 100° C. for 20 minutes, and cooling for 1-2 hours before weighing.

Enhanced cleaning by lipase and Polymer B Booster and
Rhamnolipid Booster

| | | Polymer B | Rhamnolipid | Fat removal | +/− |
|---|---|---|---|---|---|
| | Lipase 899 | Booster | Booster | under wash | Standard |
| Detergent | (0.15 ppm) | 10 ppm | 30 ppm | (% of stain) | Error |
| Model | + | + | − | 57.1 | 0.4 |
| detergent | − | + | − | 39.4 | 0.5 |
| X | + | − | + | 60.5 | 0.5 |
| | − | − | + | 45.2 | 0.3 |
| | + | − | − | 55.5 | 0.8 |
| | − | − | − | 45.4 | 0.2 |

### Example 3

Enhanced Cleaning by Lipase and Guanidinium HCl Booster and/or Polymer A Booster in Powder Detergent

Model detergent X wash liquor was prepared by dissolving 1.75 g/l of Model detergent X containing 16.5% LAS, 2% AEO, 20% sodium carbonate, 12% Sodium disilicate, 15% Zeolite A, 1% PCA, 33.5% Sodium Sulfate (all percentages are w/w) in water with hardness 6°dH.

Lard swatches were prepared by melting lard and adding 100 μL to a 5×5 cm piece of WFK80A textile (CFT). Swatches were heated at 100° C. for 20 minutes and cooled before measuring weight with a precision balance (Mettler Toledo).

Lipase 899 and Guanidinium Hydrochloride (GuaHCl; Sigma) and/and Polymer A was added according to below table in combination or separately followed by adding four of the ready lard swatches to the liquor mix together with two CS-10 swatches (CFT). The enzyme addition was followed by continuous agitation at 120 rpm for 25 minutes at 20° C. Rinse was performed in a beaker under the tap applying cold water for 5 minutes. Dried on filter paper. Lard swatches to be weighed were treated by heating first at 100° C. for 20 minutes, and cooling for 1-2 hours before weighing.

Enhanced cleaning by lipase and booster

| | | GuaHCl | Polymer A | Fat removal | +/− |
|---|---|---|---|---|---|
| | Lipase 899 | Booster | Booster | under wash | Standard |
| Detergent | 0.1 ppm | 2 mM | 1 ppm | (% of stain) | Error |
| Model | + | + | − | 66.6 | 0.4 |
| detergent | − | + | − | 60.6 | 0.8 |
| X | + | − | + | 57.9 | 0.5 |
| | − | − | + | 47.1 | 0.4 |
| | + | + | + | 73.9 | 0.1 |
| | − | + | + | 48.7 | 0.4 |
| | − | − | − | 44.8 | 0.5 |

### Example 4

### Enhanced Cleaning by Lipase GCL 1 and Polymer A Booster in Liquid Detergent

### Swatches

Fat swatches was prepared by adding 25 μL pure coconut oil to a round piece of blue WFK80A textile with the diameter of 2 cm and dried before measuring weight with a balance and used for calculation of fat removal.

Wash liquor was prepared by dissolving 0.93 g Model detergent I in 1L of water with hardness 6°dH. 40 mL of the wash liquor was added to a 50 mL test tube.

Lipase GCL1 and Polymer A were added to the wash liquor according to the table below followed by adding ten steel balls (diameter 5 mm) per test tube and four swatches and six ballast swatches (WFK80A from CFT) to the detergent.

The swatch addition was followed by continuous agitation at 40 rpm for 25 minutes at 20° C. Rinse was performed in a beaker under the tap applying cold water for 5 minutes.

After wash the swatches were dried on filter paper.

### Fat Removal

The swatches were dried for 16 hours before weighing. Fat removal was calculated by subtracting weight of swatches after wash from weight before wash.

### Model Detergent I

| Compound | Content of compound (% w/w) |
|---|---|
| Sodium lauryl sulfate (SLS) | 2.5 |
| Sodium lauryl ether sulfate (SLES) | 8.5 |
| Coco soap | 4.3 |
| Alcohol ethoxylate (AEO, plant derived | 17 |
| H₂O, 6° dH | Add 100 |

Cleaning using lipase and Polymer A Booster in liquid detergent

| | | Polymer A | Fat removal | +/− |
|---|---|---|---|---|
| | GCL1 | Booster | under wash | Standard |
| Detergent | (5 ppm) | (7 ppm) | (% of stain) | Error |
| Model detergent I | + | + | 6.6 | 1.1 |
| | − | + | 4.1 | 0.5 |
| | + | − | 4.6 | 1.1 |
| | − | − | 4.2 | 1.0 |

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1. A detergent composition comprising:
(a) a surfactant or surfactant system;
(b) a lipase; and
(c) one or more boosters selected from the group of:
i) alkoxylated polyethyleneimine, in particular ethoxylated and propoxylated polyethyleneimine;
ii) alkoxylated polyetheramine, in particular ethoxylated and propoxylated polyetheramine;
iii) guanidine hydrochloride; and
iv) rhamnolipid.

2. The composition of claim 1, wherein the composition comprises lipase, an alkoxylated polyethyleneimine such as ethoxylated and propoxylated polyethylenimine, and guanidine hydrochloride.

3. The composition of claim 1, wherein the composition gives improved fat removal under wash compared to when no booster is present, in particular wherein the fat removal under wash is at least 5%, at least 10%, at least 15%, at least 20%, at least 30%, at least 40%, at least 50%, at least 55%, at least 60%, at least 65%, or at least 70% of the stain.

4. The composition of claim 1, wherein the lipase is
i) a lipase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1, 2, 3, 4, 5, or 6;
ii) a variant having lipase activity having at least 60%, at least 70%, at least 80%, at least 90%, at least 91%, at least 92%, at least 93%, at least 94%, at least 95%, at least 96%, at least 97%, at least 98%, or at least 99%, but less than 100% sequence identity to the lipase shown as SEQ ID NO: 1, 2, 3, 4, 5, or 6;
iii) a fragment of the lipase in (i) or (ii) having lipase activity.

5. The composition of claim 1, further comprising one or more enzymes selected from: alpha-amylase, proteases, cellulases, phospholipases, cutinases, pectinases, mannanases, pectate lyases, phosphodiesterases (PDEs), deoxyribonucleases (DNases), or mixtures thereof.

6. A method for cleaning or washing of laundry comprising contacting the laundry with a composition of claim 1.

7. An enzyme product comprising:
(a) a lipase; and
(b) one or more boosters selected from the group of:
i) alkoxylated polyethyleneimine in particular ethoxylated and propoxylated polyethyleneimine;
ii) alkoxylated polyetheramine, in particular ethoxylated and propoxylated polyetheramine;
iii) guanidine hydrochloride; and
iv) rhamnolipid.
